(19) United States
(12) Patent Application Publication
(10) Pub. No.: US 2023/0325996 A1
(43) Pub. Date: Oct. 12, 2023

(54) GENERATING COMPOSITE IMAGES USING USER INTERFACE FEATURES FOR AUTO-COMPOSITING AND COMPOSITE-AWARE SEARCH

(71) Applicant: Adobe Inc., San Jose, CA (US)

(72) Inventors: Zhifei Zhang, San Jose, CA (US); Jianming Zhang, Campbell, CA (US); Scott Cohen, Sunnyvale, CA (US); Zhe Lin, Fremont, CA (US)

(21) Appl. No.: 18/167,690

(22) Filed: Feb. 10, 2023

Related U.S. Application Data
(63) Continuation-in-part of application No. 17/658,770, filed on Apr. 11, 2022.

(51) Int. Cl. G06T 5/50; G06T 3/40; G06V 10/60; G06F 3/04842

(52) U.S. Cl. CPC G06T 5/50; G06T 3/40; G06V 10/60; G06F 3/04842; G06T 2207/20101; G06T 2207/20104; G06T 2207/20221

(57) ABSTRACT

The present disclosure relates to systems, methods, and non-transitory computer readable media that generates composite images via auto-compositing features. For example, in one or more embodiments, the disclosed systems determine a background image and a foreground object image for use in generating a composite image. The disclosed systems further provide, for display within a graphical user interface of a client device, at least one selectable option for executing an auto-composite model for the composite image, the auto-composite model comprising at least one of a scale prediction model, a harmonization model, or a shadow generation model. The disclosed systems detect, via the graphical user interface, a user selection of the at least one selectable option and generate, in response to detecting the user selection, the composite image by executing the auto-composite model using the background image and the foreground object image.

### CROSS-REFERENCE TO RELATED APPLICATIONS

The present application is a continuation-in-part of U.S. application Ser. No. 17/658,770, filed on Apr. 11, 2022. The aforementioned application is hereby incorporated by reference in its entirety.

### BACKGROUND

Recent years have seen significant advancement in hardware and software platforms for image composition. In particular, systems often implement various techniques that improve the aesthetic of a composite images, such as by modifying one or more of its visual elements to provide a realistic appearance of the foreground object against the background. Despite these advancements, conventional image composition systems typically operate via tedious workflows that require a significant amount of user interaction and are prone to manual errors, resulting in composite images that appear inaccurate and unrealistic.

### SUMMARY

One or more embodiments described herein provide benefits and/or solve one or more of the foregoing or other problems in the art with systems, methods, and non-transitory computer-readable media that flexibly generate realistic composite images via intelligent, auto-compositing techniques. In particular, in one or more embodiments, the disclosed systems implement an artificial-intelligence-based compositing pipeline that automatically predicts object scale and location for compositing, harmonizes object tone, estimates lighting conditions, and/or synthesizes object shadow conditioned on object and scene appearance. The disclosed systems provide options for executing the pipeline via a graphical user interface of a client device and generates a composite image in accordance with one or more selections from the options. In some cases, the disclosed systems further utilize compositing-aware search technology to discover objects that are suitable for compositing. In this manner, the disclosed systems offer flexible search and composite features for efficiently generating realistic composite images based on a reduced set of user interactions.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an object recommendation system operates in accordance with one or more embodiments;

FIG. 2A illustrates an overview diagram of the object recommendation system recommending a foreground object image to use to generate a composite image in accordance with one or more embodiments;

FIG. 2B illustrates graphical representations comparing recommendations of the object recommendation system and recommendations of a conventional system in accordance with one or more embodiments;

FIG. 3A illustrates generating a background image and a foreground image object in accordance with one or more embodiments;

FIG. 3B illustrates utilizing a background image and a foreground object image to update parameters of a geometry-lighting-aware neural network in accordance with one or more embodiments;

FIG. 4A illustrates generating transformed foreground object images in accordance with one or more embodiments;

FIG. 4B illustrates utilizing a transformed foreground object image to update parameters of a geometry-lighting-aware neural network in accordance with one or more embodiments;

FIG. 5A illustrates a diagram for generating a foreground object image and a background image utilizing augmented masks in accordance with one or more embodiments;

FIG. 5B illustrates utilizing an alternating update process to update parameters of a geometry-lighting-aware neural network in accordance with one or more embodiments;

FIG. 5C illustrates a table reflecting experimental results regarding the effectiveness of the object recommendation system in accordance with one or more embodiments;

FIG. 6A illustrates determining a location and/or scale for a foreground object image within a background image in accordance with one or more embodiments;

FIG. 6B illustrates graphical representations reflecting experimental results regarding the effectiveness of the object recommendation system in determining a recommended location for a foreground object image in accordance with one or more embodiments;

FIG. 6C illustrates composite images generated utilizing recommended locations and/or recommended scales for foreground object images within a background image in accordance with one or more embodiments;

FIGS. 7A-7J illustrate a graphical user interface used by the object recommendation system for implementing a workflow for providing foreground object image recommendations and composite images in accordance with one or more embodiments;

FIG. 8 illustrates graphical representations reflecting experimental results regarding the effectiveness of the object recommendation system in accordance with one or more embodiments;

FIG. 9 illustrates graphical representations reflecting additional experimental results regarding the effectiveness of the object recommendation system in accordance with one or more embodiments;

FIGS. 10A-10C illustrate tables reflecting further experimental results regarding the effectiveness of the object recommendation system in accordance with one or more embodiments;

FIGS. 11A-11C illustrate tables reflecting yet further experimental results regarding the effectiveness of the object recommendation system in accordance with one or more embodiments;

FIG. 12 illustrates an overview diagram of the object recommendation system implementing a pipeline for generating composite images in accordance with one or more embodiments;

FIG. 13 illustrates a graphical user interface utilized by the object recommendation system to facilitate the generation of composite images based on user interactions in accordance with one or more embodiments;

FIG. 14 illustrates a block diagram of architectural components of the object recommendation system in accordance with one or more embodiments;

FIGS. 15A-15B illustrate a graphical user interface used by the object recommendation system to generate a composite image utilizing a foreground object image retrieved via a composite-aware search in accordance with one or more embodiments;

FIGS. 16A-16B illustrate another graphical user interface used by the object recommendation system to generate a composite image utilizing a foreground object image retrieved via a composite-aware search in accordance with one or more embodiments;

FIGS. 17A-17B illustrate yet another graphical user interface used by the object recommendation system to generate a composite image utilizing a foreground object image retrieved via a composite-aware search in accordance with one or more embodiments;

FIGS. 18A-18D illustrate a graphical user interface used by the object recommendation system to generate a composite image by executing an auto-composite model in accordance with one or more embodiments;

FIG. 19 illustrates a graphical user interface used by the object recommendation system to generate a composite image utilizing a foreground object image retrieved via a sketch-based search in accordance with one or more embodiments;

FIGS. 20A-20C illustrate the object recommendation system generating a composite image utilizing a previously generated composite image in accordance with one or more embodiments;

FIG. 21 illustrates an example schematic diagram of an object recommendation system in accordance with one or more embodiments;

FIG. 22 illustrates a flowchart of a series of acts for generating a composite image using an auto-composite model selected via a graphical user interface in accordance with one or more embodiments; and

FIG. 23 illustrates a block diagram of an exemplary computing device in accordance with one or more embodiments.

### DETAILED DESCRIPTION

One or more embodiments described herein include an object recommendation system that utilizes an efficient graphical user interface and flexible searching methods for realistic image composition. Indeed, in one or more embodiments, the object recommendation system implements front-end searching and editing interactions and back-end search engines and image editing techniques to generate composite images. For instance, in some cases, the object recommendation system utilizes one or more search engines to recommend foreground objects for composition based on their compatibility with a background. Further, in some embodiments, the object recommendation system generates the composite image in accordance with a one-click compositing experience provided via a graphical user interface. To illustrate, in some implementations, the object recommendation system modifies the background and/or the foreground object of the composite image based on user selections via the graphical user interface to match lighting or scale or to provide a realistic positioning or shadow.

To illustrate, in one or more embodiments, the object recommendation system determines a background image and a foreground object image for use in generating a composite image. Further, the object recommendation system provides, for display within a graphical user interface of a client device, at least one selectable option for executing an auto-composite model for the composite image, the auto-composite model comprising at least one of a scale prediction model, a harmonization model, or a shadow generation model. The object recommendation system detects, via the graphical user interface, a user selection of the at least one selectable option and generates, in response, the composite image by executing the auto-composite model using the background image and the foreground object image.

As just mentioned, in one or more embodiments, the object recommendation system determines a foreground object image for use in generating a composite image with a background image. In some embodiments, the object recommendation system receives the foreground object image from a client device. For instance, in some cases, the object recommendation system receives a foreground object image that was stored locally on the client device. In some implementations, however, the object recommendation system determines the foreground object image to use using one or more search engines. Indeed, in some cases, the object recommendation system uses the one or more search engines to recommend a foreground object image for use within a composite image.

To illustrate, in some cases, the object recommendation system uses at least one search engine to search through a database and identify at least one foreground object image for use in compositing with a background image. For instance, in some embodiments, the object recommendation system utilizes a compositing-aware search engine, a text search engine, or an image search engine. Indeed, in some instances, the object recommendation system utilizes the one or more search engines to identify the foreground object image based on a compatibility with the background image (e.g., a compatibility with the geometry of the background image). In some cases, the object recommendation system utilizes the search engine that corresponds to search input provided via a graphical user interface, such as text input, spot input, bounding box input, and/or sketch input.

As further mentioned, in one or more embodiments, the object recommendation system provides, for display within a graphical user interface, one or more selectable options for executing an auto-composite model in generating the composite image. For instance, in some cases, the object recommendation system provides selectable options for executing a scale prediction model, a harmonization model, and/or a shadow generation model. Upon detecting a selection of one or more of the selectable options, the object recommendation system executes the corresponding model(s). Thus, in some instances, the object recommendation system utilizes a selectable option displayed within the graphical user interface as a one-click trigger for executing a corresponding model—which, in some cases, executes a series of actions to provide an output.

As mentioned, in one or more embodiments, the object recommendation system generates a composite image utilizing the foreground object image and the background image. In particular, the object recommendation system generates the composite image by executing the auto-composite model in accordance with the selection(s) received via the graphical user interface. For instance, in some cases, the object recommendation system utilizes the auto-composite model to modify the foreground object image and/or the background image within the composite image in accordance with the received selections(s).

In some implementations, the object recommendation system generates the composite image by positioning and or scaling the foreground object image in accordance with additional user selections received via the graphical user interface. Indeed, in some cases, the object recommendation system receives a user interaction indicating a positioning and or a scaling for the foreground object image within the composite image. In some embodiments, however, the object recommendation system determines and recommends a location and/or a scale for the foreground object image. Thus, in some cases, where explicit instructions have not been received, the object recommendation system automatically generates the composite image using a recommended scale and/or a recommended location for the foreground object image.

As mentioned above, conventional image composition systems suffer from several technological shortcomings that result in inflexible, inefficient, and inaccurate operation. In particular, many conventional systems are inflexible in that they employ models that rigidly search for and recommend foreground object images based on a limited set of features. For instance, conventional systems often employ models that retrieve foreground object images based on a semantic search but fail to consider aspects of compatibility with a background image that affects the resulting image composition. Additionally, many conventional systems rigidly require parameter inputs, such as a query bounding box, to guide the object search and retrieval.

Further, conventional image composition systems often suffer from inefficiencies. In particular, conventional systems typically require a significant number of user interactions for generating a compositing result. For example, in many cases, after combining a foreground object image and a background image, conventional systems require tedious workflows of user interactions to blend the two components together. Indeed, a conventional system may require a series of user interactions to execute a single modification, such as by adjusting the location, size, lighting, or orientation of the foreground object image within the composite image. This problem is exacerbated where the foreground object image is largely incompatible with the background image, and additional modifications are needed to accommodate for that incompatibility.

In addition to inflexibility and inefficiency problems, conventional image composition systems can also operate inaccurately. In particular, conventional systems often generate composite images that appear unrealistic. For instance, by employing models that suggest foreground object images that are semantically compatible with a background image but may be incompatible in other respects, conventional systems often generate composite images where the foreground object image appears unnatural against the background image. While many systems allow for additional modification after combining the components, these modifications typically involve workflows of user interactions, and thus are prone to suffering from user errors that fail to rectify aesthetic deficiencies in the composite image.

The object recommendation system provides several advantages over conventional systems. For example, the object recommendation system improves the flexibility of implementing computing devices when compared to conventional systems. To illustrate, by implementing a compositing-aware search engine, the object recommendation system flexibly recommends foreground object images based on various aspects of compatibility that are not considered by conventional systems. Indeed, in some instances, the object recommendation system utilizes the compositing-aware search engine to determine compatibility based on factors, such as geometry, of foreground object images and background images.

Additionally, the object recommendation system improves the efficiency of implementing computing devices when compared to conventional systems. For instance, by executing an auto-composite model based on a selection of one or more options provided via a graphical user interface, the object recommendation system reduces the number of user interactions required to generate a composite image or implement corresponding modifications to a composite image. Indeed, rather than requiring a series of user interactions per modification, the object recommendation system triggers a backend workflow in response to a single click. Thus, the object recommendation system implements a graphical user interface that facilitates various modifications to a composite image based on relatively few user interactions.

Further, the object recommendation system improves the accuracy of implementing computing devices when compared to conventional systems. In particular, the object recommendation system generates comparatively more realistic composite images. For instance, by suggesting foreground object images that are more compatible with a background image and/or utilizing a computer-implemented auto-composite model in generating/modifying a composite image, the object recommendation system provides compositing results having a more aesthetically natural appearance. For example, by implementing an auto-composite model, the object recommendation system avoids error-prone user interactions that are typically used under conventional systems.

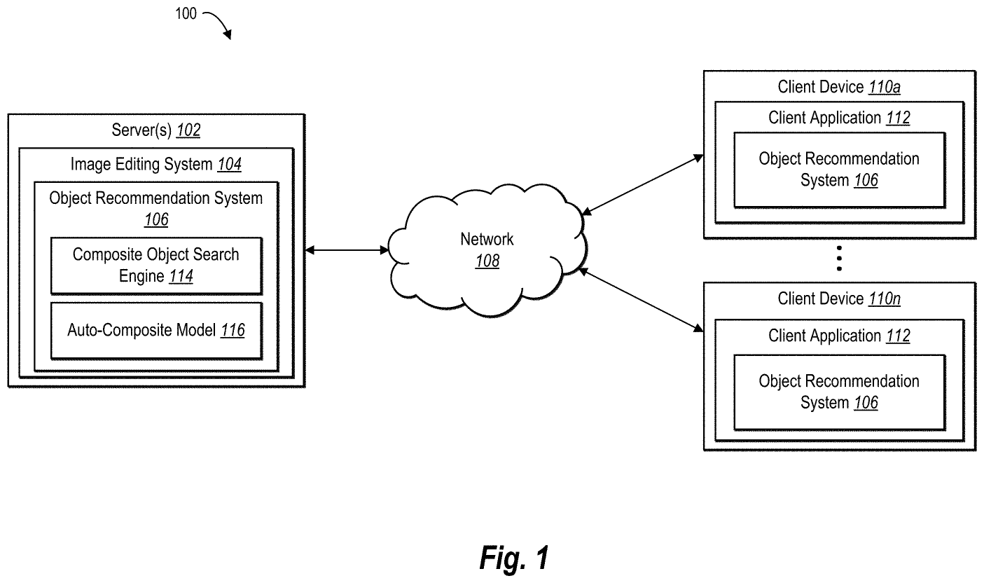

Additional details regarding the object recommendation system will now be provided with reference to the figures. For example, FIG. 1 illustrates a schematic diagram of an exemplary system environment (“environment”) 100 in which an object recommendation system 106 operates. As illustrated in FIG. 1, the environment 100 includes a server(s) 102, a network 108, and client devices 110a-110n.

Although the environment 100 of FIG. 1 is depicted as having a particular number of components, the environment 100 is capable of having any number of additional or alternative components (e.g., any number of servers, client devices, or other components in communication with the object recommendation system 106 via the network 108). Similarly, although FIG. 1 illustrates a particular arrangement of the server(s) 102, the network 108, and the client devices 110a-110n, various additional arrangements are possible.

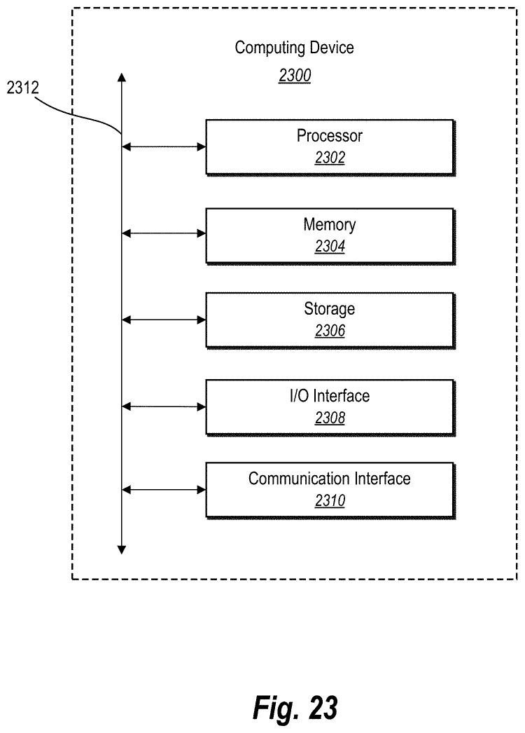

The server(s) 102, the network 108, and the client devices 110a-110n are communicatively coupled with each other either directly or indirectly (e.g., through the network 108 discussed in greater detail below in relation to FIG. 23). Moreover, the server(s) 102 and the client devices 110a-110n include one of a variety of computing devices (including one or more computing devices as discussed in greater detail with relation to FIG. 23).

As mentioned above, the environment 100 includes the server(s) 102. In one or more embodiments, the server(s) 102 generates, stores, receives, and/or transmits data including search engines, an auto-composite model, digital images, composite images, and/or recommendations for foreground object images. In one or more embodiments, the server(s) 102 comprises a data server. In some implementations, the server(s) 102 comprises a communication server or a web-hosting server.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server(s) 102 via the network 108. The image editing system 104 then provides many options that the client device may use to edit the digital image, store the digital image, and subsequently search for, access, and view the digital image. For instance, in some cases, the image editing system 104 provides one or more options that the client device may use to create a composite image using the digital image.

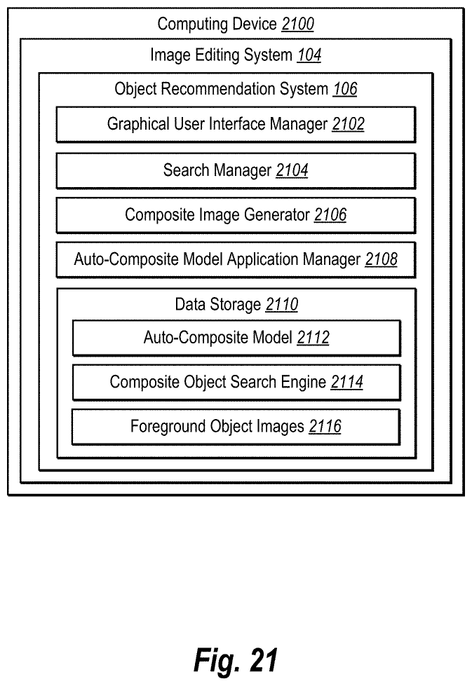

Additionally, the server(s) 102 includes the object recommendation system 106. In one or more embodiments, via the server(s) 102, the object recommendation system 106 identifies and recommends foreground object images that are compatible with background images for generating composite images. For instance, in some cases, the object recommendation system 106, via the server(s) 102, builds and implements a composite object search engine 114 to identify and recommend foreground object images. In some cases, via the server(s) 102, the object recommendation system 106 further executes an auto-composite model 116 in generating composite images, such as by using recommended foreground object images. Example components of the object recommendation system 106 will be described below with regard to FIG. 21.

In one or more embodiments, the client devices 110a-110n include computing devices that can access, edit, modify, store, and/or provide, for display, digital images, including composite images. For example, the client devices 110a-110n include smartphones, tablets, desktop computers, laptop computers, head-mounted-display devices, or other electronic devices. The client devices 110a-110n include one or more applications (e.g., the client application 112) that can access, edit, modify, store, and/or provide, for display, digital images, including composite images. For example, in some embodiments, the client application 112 includes a software application installed on the client devices 110a-110n. In other cases, however, the client application 112 includes a web browser or other application that accesses a software application hosted on the server(s) 102.

The object recommendation system 106 can be implemented in whole, or in part, by the individual elements of the environment 100. Indeed, as shown in FIG. 1, the object recommendation system 106 can be implemented with regard to the server(s) 102 and/or at the client devices 110a-110n. In particular embodiments, the object recommendation system 106 on the client devices 110a-110n comprises a web application, a native application installed on the client devices 110a-110n (e.g., a mobile application, a desktop application, a plug-in application, etc.), or a cloud-based application where part of the functionality is performed by the server(s) 102.

In additional or alternative embodiments, the object recommendation system 106 on the client devices 110a-110n represents and/or provides the same or similar functionality as described herein in connection with the object recommendation system 106 on the server(s) 102. In some implementations, the object recommendation system 106 on the server(s) 102 supports the object recommendation system 106 on the client devices 110a-110n.

For example, in some embodiments, the object recommendation system 106 on the server(s) 102 builds one or more search engines described herein (e.g., the composite object search engine 114) and/or trains one or more compositing models described herein (e.g., the auto-composite model). The object recommendation system 106 on the server(s) 102 provides the one or more search engines and/or the one or more compositing models to the object recommendation system 106 on the client devices 110a-110n for implementation. Accordingly, although not illustrated, in one or more embodiments the client devices 110a-110n utilize the one or more search engines to generate recommend foreground object images for image composition and/or utilizes the one or more compositing models to generate composite images.

In some embodiments, the object recommendation system 106 includes a web hosting application that allows the client devices 110a-110n to interact with content and services hosted on the server(s) 102. To illustrate, in one or more implementations, the client devices 110a-110n accesses a web page or computing application supported by the server(s) 102. The client devices 110a-110n provide input to the server(s) 102 (e.g., a background image). In response, the object recommendation system 106 on the server(s) 102 utilizes the one or more search engines to generate a recommendation for utilizing a foreground object image with the background image in generating a composite image. The server(s) 102 then provides the recommendation to the client devices 110a-110n. In some instances, the server(s) 102 further implements the one or more compositing models to generate a compositing result and provides the compositing result to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server(s) 102, bypassing the network 108. As another example, the environment 100 includes a third-party server comprising a content server and/or a data collection server.

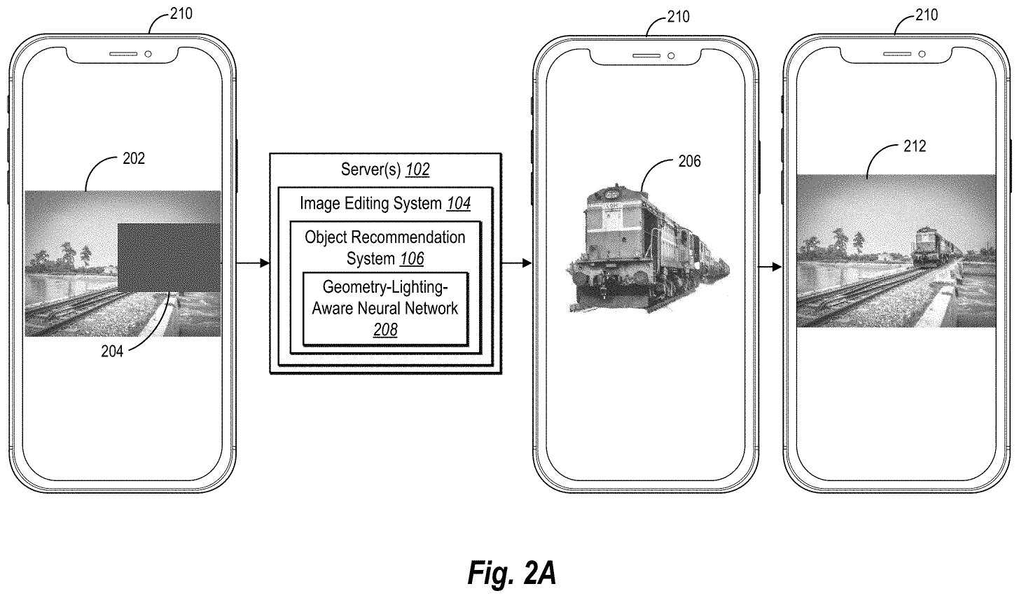

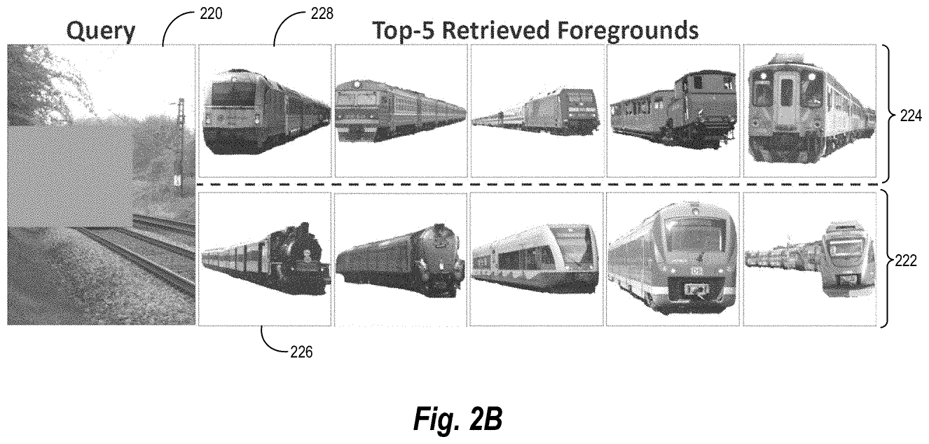

As mentioned above, the object recommendation system 106 generates recommendations for using foreground object images in creating a composite image. FIG. 2A illustrates an overview diagram of the object recommendation system 106 recommending a foreground object image to use to generate a composite image in accordance with one or more embodiments.

In one or more embodiments, a foreground object image includes a digital image portraying a foreground object. In particular, in some embodiments, a foreground object image includes a digital image usable for providing a foreground object for a composite image. For example, in some implementations, a foreground object image includes a digital image portraying a person or other object that is used to generate a composite image having the same portrayal of the person or object. In some implementations, a foreground object image includes a portrayal of the foreground object against a solid background or a cutout of the foreground object (e.g., without a background). Accordingly, in some instances, the following disclosure utilizes the terms foreground object image and foreground object interchangeably.

In some embodiments, the object recommendation system 106 recommends a foreground object image based on a background image to be used in generating a composite image. Indeed, as shown in FIG. 2A, the object recommendation system 106 receives, from a client device 210, a background image 202 for use in generating a composite image.

In one or more embodiments, a background image includes a digital image portraying a scene. In particular, in some embodiments, a background image includes a digital image that portrays a scene that is usable as a background within a composite image. For instance, in some cases, a background image portrays a scene that is used to generate a composite image portraying the same scene as a background.

As further shown in FIG. 2A, the object recommendation system 106 also receives a query bounding box 204 within the background image 202. In one or more embodiments, a query bounding box includes a bounding box that provides parameters for searching for a foreground object. In particular, in some implementations, a query bounding box includes a user-defined bounding box that indicates user-selected parameters for searching for a foreground object image. To illustrate, in some cases, a query bounding box indicates a scale parameter (e.g., a maximum scale) for use in searching for a foreground object. In some instances, a query bounding box indicates a location parameter for use in searching for a foreground object. For instance, in some embodiments, a query bounding box indicates a location within a background image to add a foreground object in generating a composite image. Accordingly, in some embodiments, the object recommendation system 106 searches for, retrieves, and recommends a foreground object image that is compatible with the portion of the background image covered by the query bounding box. A query bounding box is not limited to a particular shape. For example, a query bounding box can be implemented as a box, oval, circle, polygon, or irregular shape.

Indeed, as shown in FIG. 2A, the object recommendation system 106 retrieves a foreground object image 206 that is compatible with the background image 202 for use in generating a composite image. In particular, in some cases, the object recommendation system 106 retrieves the foreground object image 206 based on determining that the foreground object image 206 is compatible with the portion of the background image 202 that corresponds to the query bounding box 204.

As illustrated by FIG. 2A, the object recommendation system 106 utilizes a geometry-lighting-aware neural network 208 to retrieve the foreground object image 206 for the recommendation. For instance, in some cases, the object recommendation system 106 utilizes the geometry-lighting-aware neural network 208 to analyze the background image 202 and the query bounding box 204 and retrieve the foreground object image 206 based on the analysis.

In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, or a multi-layer perceptron. In some embodiments, a neural network includes a combination of neural networks or neural network components.

In some embodiments, a geometry-lighting-aware neural network includes a computer-implemented neural network that identifies foreground objects (e.g., foreground object images) that are compatible with background images for use in generating composite images. In particular, in some embodiments, a geometry-lighting-aware neural network includes a computer-implemented neural network that analyzes a background image and determines, from a set of foreground objects, one or more foreground objects that are compatible with the background image based on the analysis. For instance, in some cases, a geometry-lighting-aware neural network determines compatibility by considering similarities of a variety of image characteristics, such as lighting, geometry, and semantics.

In one or more embodiments, the object recommendation system 106 generates a recommendation using the foreground object image 206. For example, as shown in FIG. 2A, the object recommendation system 106 provides the foreground object image 206 to the client device 210 to recommend using the foreground object image 206 in generating a composite image. In some cases, the object recommendation system 106 includes additional information as part of the recommendation, such as a score indicating the compatibility between the background image 202 and the foreground object image 206.

As further shown in FIG. 2A, the object recommendation system 106 generates a composite image 212 from the background image 202 and the foreground object image 206. In some cases, the object recommendation system 106 generates the composite image 212 upon receiving a user acceptance of the foreground object image 206. In some implementations, the object recommendation system 106 generates the composite image 212 upon retrieving the foreground object image 206 and provides the composite image 212 to the client device 210 as part of the recommendation (e.g., as a preview of the resulting composition).

By utilizing a geometry-lighting-aware neural network, the object recommendation system 106 recommends foreground object images that are more similar to background images in terms of lighting and geometry (as well as semantics) when compared to conventional systems. FIG. 2B illustrates graphical representations comparing recommendations of the object recommendation system 106 and recommendations of a conventional system in accordance with one or more embodiments.

Indeed, FIG. 2B illustrates a plurality of recommendations provided in response to a query 220 that includes a background image and a query bounding box. In particular, FIG. 2B illustrates the top foreground object images recommended by an embodiment of the object recommendation system 106 in the first row 222. The foreground object images shown in the second row 224 represent the top recommendations provided by a conventional system that does not explicitly model lighting and geometry, such as the unconstrained foreground object (UFO) search model described by Yinan Zhao et al., Unconstrained Foreground Object Search, IEEE/CVF International Conference on Computer Vision, pages 2030-2039, 2019, or the teacher student framework described by Zongze Wu et al., Fine-grained Foreground Retrieval via Teacher-student Learning, Proceedings of the IEEE/VCF Winter Conference on Applications of Computer Vision, pages 3646-3654, 2021.

As shown in FIG. 2B, foreground object images recommended by both systems appear to match the semantics of the background image of the query 220 (e.g., the foreground object images include trains that match with the train tracks of the background image). The foreground object images recommended by the object recommendation system 106, however, are more compatible in terms of lighting and geometry. For instance, the top recommendation 226 provided by the object recommendation system 106 includes a foreground object image that is geometrically compatible with the background image (e.g., the train is going the same way as the train tracks). In contrast, the top recommendation 228 of the conventional system includes a foreground object image that is geometrically incompatible (e.g., the train is going the wrong direction). Moreover, as indicated by FIG. 2B, the object recommendation system 106 retrieves foreground object images that are compatible with the background image with greater consistency.

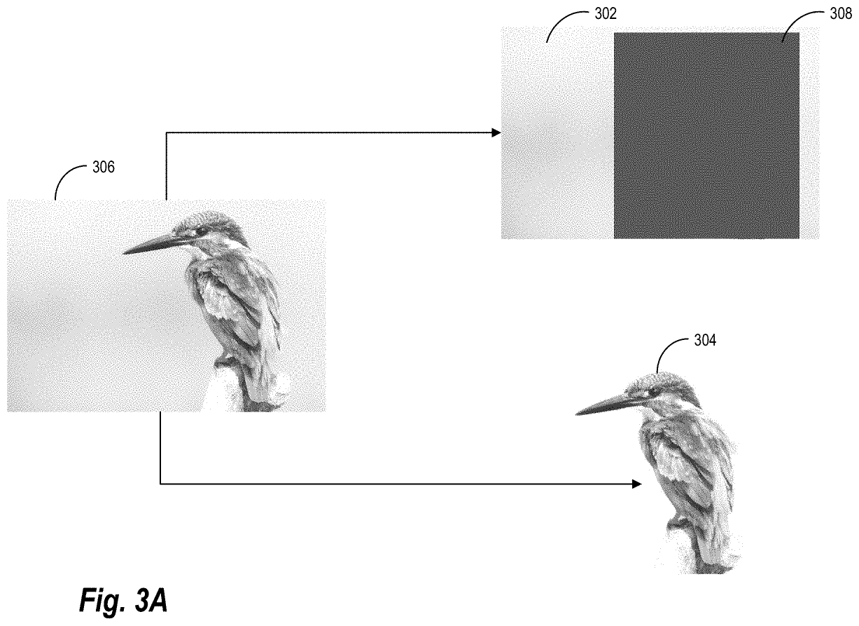

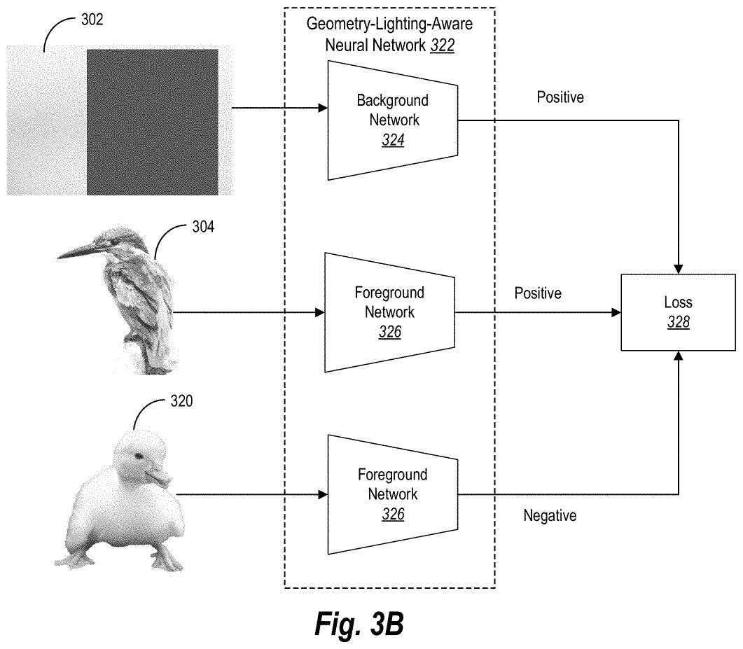

As previously indicated, in one or more embodiments, the object recommendation system 106 recommends foreground object images that are compatible with background images in terms of geometry and lighting by building and implementing a geometry-lighting-aware neural network that is sensitive to such image features. Indeed, in one or more embodiments, the object recommendation system 106 builds a geometry-lighting-aware neural network by learning network parameters that facilitate the detection of similarities between background images and foreground objects in terms of geometry and lighting. FIGS. 3A-5B illustrate diagrams for learning network parameters for a geometry-lighting-aware neural network in accordance with one or more embodiments.

FIG. 3A illustrates generating a background image and a foreground image object for use in learning network parameters for a geometry-lighting-aware neural network in accordance with one or more embodiments. Indeed, as shown in FIG. 3A, the object recommendation system 106 generates a background image 302 and a foreground object image 304 from a digital image 306. For instance, in one or more embodiments, the object recommendation system 106 generates the foreground object image 304 from the digital image 306 by extracting the foreground object from the digital image 306 utilizing the corresponding segmentation mask.

In one or more embodiments, a segmentation mask includes an identification of pixels in an image that represent an object. In particular, in some embodiments, a segmentation mask includes an image filter useful for partitioning a digital image into separate portions. For example, in some cases, a segmentation mask includes a filter that corresponds to a digital image (e.g., a foreground image) that identifies a portion of the digital image (i.e., pixels of the digital image) belonging to a foreground object and a portion of the digital image belonging to a background. For example, in some implementations, a segmentation map includes a map of the digital image that has an indication for each pixel of whether the pixel is part of an object (e.g., foreground object) or not. In such implementations, the indication can comprise a binary indication (a 1 for pixels belonging to the object and a zero for pixels not belonging to the object). In alternative implementations, the indication can comprise a probability (e.g., a number between 1 and 0) that indicates the likelihood that a pixel belongs to the object. In such implementations, the closer the value is to 1, the more likely the pixel belongs to the foreground or object and vice versa.

As further shown in FIG. 3A, the object recommendation system 106 generates the background image 302 by placing a mask 308 over the portion of the background image 302 that corresponds to the extracted foreground object. In one or more embodiments, a mask generally includes a visual element that covers a corresponding area of pixels or a filter that filters out a corresponding area of pixels. For example, in some implementations, where a segmentation mask targets a component of a digital image for segmentation, a mask more generally blocks or filters out pixels of a digital image. For instance, in some cases, a mask blocks or filters out pixels without consideration of the image component to which they belong. Indeed, as shown in FIG. 3A, the mask 308 covers a rectangular area of the background image 302 and does not outline any particular component of the digital image 306. It should be understood, however, that a mask can more closely follow the contours of an image component in some cases (or use a variety of different shapes).

FIG. 3B illustrates utilizing a background image and a foreground object image to update parameters of a geometry-lighting-aware neural network in accordance with one or more embodiments. Indeed, as shown in FIG. 3B, the object recommendation system 106 utilizes the background image 302 and the foreground object image 304 as positive samples to one another for learning the network parameters. Further, as illustrated, the object recommendation system 106 obtains an additional foreground object image 320. In particular, FIG. 3B shows, the additional foreground object image 320 does not correspond to the background image 302 or the foreground object image 304. Accordingly, in some implementations, the object recommendation system 106 utilizes the additional foreground object image 320 as a negative sample with respect to the background image 302 and the foreground object image 304.

As shown in FIG. 3B, the object recommendation system 106 utilizes the geometry-lighting-aware neural network 322 to analyze the background image 302, the foreground object image 304, and the additional foreground object image 320. In particular, the object recommendation system 106 utilizes a background network 324 of the geometry-lighting-aware neural network 322 to analyze the background image 302. The object recommendation system 106 further utilizes a foreground network 326 of the geometry-lighting-aware neural network 322 to analyze the foreground object image 304 and the additional foreground object image 320.

In one or more embodiments, a background network includes a neural network or neural network component that analyzes background images. Similarly, in one or more embodiments, a foreground network includes a neural network or neural network component that analyzes foreground object images. In some cases, a background network and/or a foreground network includes a neural network encoder that generates one or more embeddings based on an analysis of a background image or a foreground image, respectively. For example, in some cases, a background network and/or a foreground network include a convolutional neural network (CNN) or CNN component for generating embeddings from background or foreground image features.

In particular, in one or more embodiments, the object recommendation system 106 utilizes the background network 324 and the foreground network 326 to generate predicted embeddings from the background image 302, the foreground object image 304, and the additional foreground object image 320 within a geometry-lighting-sensitive embedding space.

Generally, in one or more embodiments, an embedding space includes a space in which digital data is embedded. In particular, in some embodiments, an embedding space includes a space (e.g., a mathematical or numerical space) in which some representation of digital data (referred to as an embedding) exists. For example, in some implementations, an embedding space includes a vector space where an embedding located therein represents patent and/or latent features of the corresponding digital data. In some cases, an embedding space includes a dimensionality associated with a representation of digital data, including the number of dimensions associated with the representation and/or the types of dimensions. In one or more embodiments, a geometry-lighting-aware embedding space includes an embedding space for embeddings that encode the lighting and/or geometry features of corresponding digital data (e.g., background images or foreground object images).

As shown in FIG. 3B, the object recommendation system 106 compares the outputs of the background network 324 and the foreground network 326 (e.g., the predicted embeddings) to determine a loss 328. For example, the object recommendation system 106 compares a background embedding corresponding to the background image 302 and a foreground embedding corresponding to the foreground object image 304 and determine a measure of loss based on the comparison. In particular, the object recommendation system 106 penalizes (e.g., determines a larger measure of loss) for greater distances between the background embedding and the foreground embedding. In this manner, the object recommendation system 106 teaches the background network 324 and the foreground network 326 to move background embeddings close to matching (e.g., ground truth) foreground objects within the geometry-lighting-sensitive embedding space.

Similarly, the object recommendation system 106 compares a background embedding corresponding to the background image 302 and an additional foreground embedding corresponding to the additional foreground object image 320 and determine a measure of loss based on the comparison. In particular, the object recommendation system 106 penalizes (e.g., determines a larger measure of loss) for smaller distances between the background embedding and the additional foreground embedding. In this manner, the object recommendation system 106 teaches the background network 324 and the foreground network 326 to move background embeddings further away from negative (non-ground-truth) foreground objects within the geometry-lighting-sensitive embedding space.

In one or more embodiments, the object recommendation system 106 determines the loss 328 by determining a triplet loss utilizing the following:

[symbol]

ₜ=[S(N_{b}(I_{b}), N_{f}(I_{f}⁻))−S(N_{b}(I_{b}), N_{f}(I_{f}⁺))+m]₊ (1)

In equation 1, S represents the cosine similarity and [·]₊ represents the hinge function. Additionally, N_{b} and N_{f} represent the background network 324 and the foreground network 326, respectively. Further, I_{b} represents a background image (e.g., the background image 302), I_{f}⁺ represents a positive foreground object image with respect to the background image (e.g., the foreground object image 304), and I_{f}⁻ represents the negative foreground object image with respect to the background image (e.g., the additional foreground object image 320). Also, in equation 1, m represents a margin for triplet loss. Though equation 1 shows use of the cosine similarity, the object recommendation system 106 utilizes various measures of similarity in various embodiments. For instance, in some cases, the object recommendation system 106 utilizes Euclidean distance as the measure of the similarity in determining the loss 328.

In one or more embodiments, the object recommendation system 106 utilizes the loss 328 to update the parameters of the geometry-lighting-aware neural network 322. For instance, in some cases, the object recommendation system 106 updates the parameters to optimize the geometry-lighting-aware neural network 322 by reducing the errors of its outputs. Accordingly, in some cases, the object recommendation system 106 utilizes the loss 328 in accordance with the optimization formulation arg min_{N}_{_{b,}}_{N}_{_{f}} [symbol] ₜ. For example, in some instances, by updating the parameters, the object recommendation system 106 decreases the distance between positive samples and increases the distance between negative samples within the geometry-lighting-sensitive embedding space. Thus, at inference time, the object recommendation system 106 utilizes the geometry-lighting-aware neural network 322 to identify compatible foreground object images based on the distance between their embeddings and the embedding of the given background image.

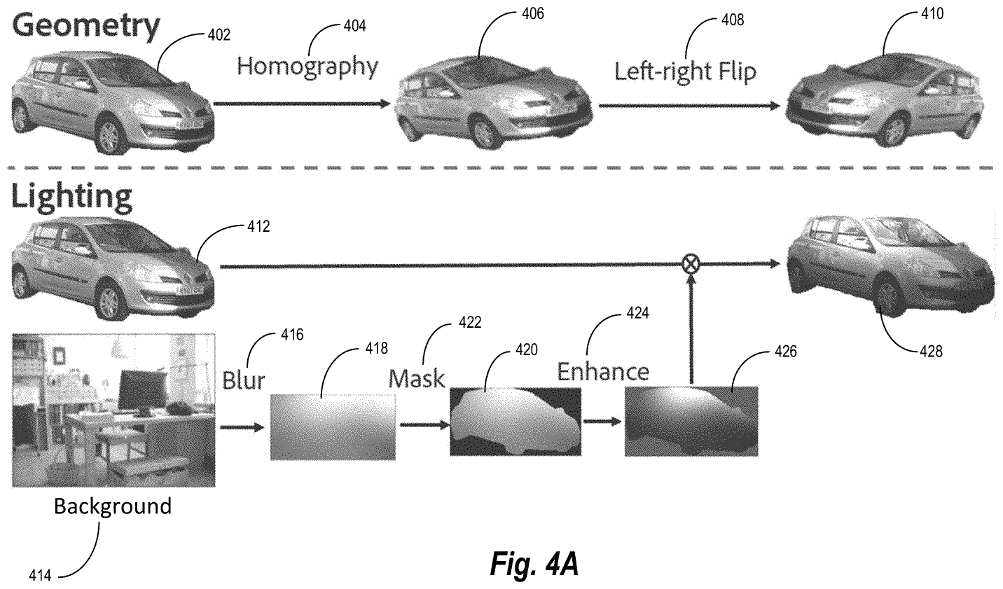

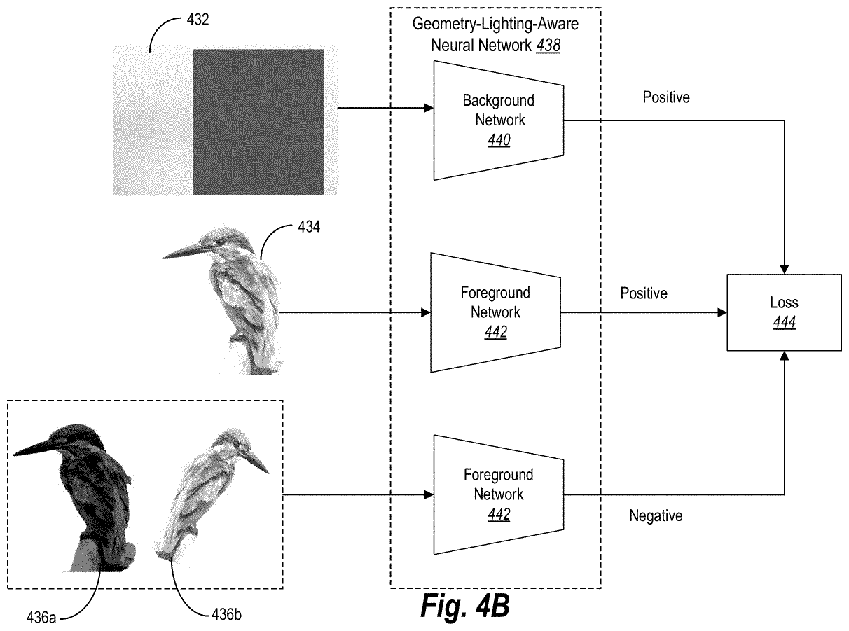

As previously mentioned, in some cases, the object recommendation system 106 learns parameters for a geometry-lighting-aware neural network using one or more transformed foreground object images. FIGS. 4A-4B illustrate using transformed foreground object images to learn parameters for a geometry-lighting-aware neural network in accordance with one or more embodiments.

FIG. 4A illustrates generating transformed foreground object images in accordance with one or more embodiments. Indeed, as illustrated by FIG. 4A, the object recommendation system 106 generates a transformed foreground object image utilizing at least one of a geometry transformation or a lighting transformation.

In one or more embodiments, a geometry transformation includes a modification to a foreground object image that changes the geometry of the foreground object image. In particular, in some embodiments, a geometry transformation includes a modification to one or more geometric properties of a foreground object image. For instance, in some implementations, a geometry transformation includes, but is not limited to, a modification to the shape, orientation, perspective, or size of a foreground object image. Indeed, in some cases, a geometry transformation modifies one or more patent geometric features of a foreground object image. In some embodiments, however, a geometry transformation additionally or alternatively modifies one or more latent geometric features.

In one or more embodiments, a lighting transformation includes a modification to a foreground object image that changes the lighting of the foreground object image. In particular, in some embodiments, a lighting transformation includes a modification to one or more lighting properties of a foreground object image. For instance, in some cases, a lighting transformation includes, but is not limited to, a modification to a brightness, hue, or saturation of a foreground object image, a light source of a foreground object image, or shadows or reflections portrayed by the foreground object image. Indeed, in some cases, a lighting transformation modifies one or more patent lighting features of a foreground object image. In some embodiments, however, a lighting transformation additionally or alternatively modifies one or more latent lighting features.

As shown in FIG. 4A, the object recommendation system 106 transforms a foreground object image 402 using a geometry transformation by applying one or more homography transformations 404 to the foreground object image 402. For instance, in some cases, the object recommendation system 106 utilizes one or more random or semi-random homography transformations. Additionally, as shown, the object recommendation system 106 further transforms the modified foreground object image 406 resulting from the one or more homography transformations 404. In particular, the object recommendation system 106 transforms the modified foreground object image 406 utilizing a flipping transformation 408. For instance, in some cases, the object recommendation system 106 utilizes a left-right flip with a fifty percent probability.

Thus, the object recommendation system 106 generates a transformed foreground object image 410. Though FIG. 4A illustrates a particular set of transformations being applied in a particular sequence, it should be understood that the object recommendation system 106 can utilize geometry transformations having various sets of transformations in various sequences in different embodiments.

As further shown in FIG. 4A, the object recommendation system 106 transforms a foreground object image 412 via a lighting transformation using a digital image 414 portraying a background. For instance, in some cases, the object recommendation system 106 randomly or semi-randomly selects the digital image 414 so that the portrayed background is unassociated with with the foreground object image 412.

As illustrated in FIG. 4A, the object recommendation system 106 modifies the digital image 414 using a blur 416. For instance, in some cases, the object recommendation system 106 utilizes a Gaussian blur. In one or more embodiments, the object recommendation system 106 further resizes the modified digital image 418 (e.g., lighting map) resulting from application of the blur 416 to the size of the foreground object image 412. For instance, in some embodiments, the object recommendation system 106 resizes the modified digital image 418 via interpolation.

As further shown in FIG. 4A, the object recommendation system 106 extracts a portion 420 of the modified digital image 418 (e.g., the resized modified digital image) that corresponds to the foreground object image 412. For instance, as indicated, the object recommendation system 106 extracts the portion 420 from the modified digital image 418 utilizing a segmentation mask 422 that corresponds to the foreground object image 412.

Additionally, as shown, the object recommendation system 106 utilizes one or more enhancements 424 to further transform the portion 420 extracted from the modified digital image 418. In some cases, the object recommendation system 106 further transforms the portion 420 by enhancing the variance of the portion 420. For instance, in some implementations, the object recommendation system 106 enhances the variance using an exponential function. Thus, the object recommendation system 106 generates an enhanced lighting map 426 from the digital image 414.

As further shown, the object recommendation system 106 utilizes the enhanced lighting map 426 to generate a transformed foreground object image 428 from the foreground object image 412. For instance, in some embodiments, the object recommendation system 106 multiplies the foreground object image 412 by the enhanced lighting map 426 to generate the transformed foreground object image 428. Thus, in some cases, the object recommendation system 106 utilizes the enhanced lighting map 426 to change the lighting of the foreground object image 412, such as by highlighting some region of the foreground object image 412.

As previously stated with regard to geometry transformations, FIG. 4A illustrates a particular set of transformations being applied in a particular sequence, but the object recommendation system 106 can utilize lighting transformations having various sets of transformations in various sequences in different embodiments.

Further, FIG. 4A illustrates utilizing one of a geometry transformation or a lighting transformation to generate a transformed foreground object image; however, the object recommendation system 106 can utilize both in generating a transformed foreground object image in some implementations.

FIG. 4B illustrates utilizing a transformed foreground object image to update parameters of a geometry-lighting-aware neural network in accordance with one or more embodiments. Indeed, as shown in FIG. 4B, the object recommendation system 106 utilizes a background image 432 and a foreground object image 434 as positive samples to one another for learning network parameters. Further, as illustrated, the object recommendation system 106 utilizes one of the transformed foreground object images 436a-436b as a negative sample with respect to the background image 432 and the foreground object image 434.

As shown in FIG. 4B, the object recommendation system 106 utilizes the geometry-lighting-aware neural network 438 to analyze the background image 432, the foreground object image 434, and one of the transformed foreground object images 436a-436b. In particular, the object recommendation system 106 utilizes the background network 440 of the geometry-lighting-aware neural network 438 to analyze the background image 432. The object recommendation system 106 further utilizes the foreground network 442 of the geometry-lighting-aware neural network 438 to analyze the foreground object image 434 and one of the transformed foreground object images 436a-436b.

In particular, in one or more embodiments, the object recommendation system 106 utilizes the background network 440 and the foreground network 442 to generate predicted embeddings from the background image 432, the foreground object image 434, and one of the transformed foreground object images 436a-436b within a geometry-lighting-sensitive embedding space. As shown in FIG. 4B, the object recommendation system 106 compares the predicted embeddings (e.g., the outputs of the background network 440 and the foreground network 442) to determine a loss 444. In one or more embodiments, the object recommendation system 106 determines the loss 444 by determining a triplet loss utilizing the following:

[symbol]

_{c}=[S(N_{b}(I_{b}), N_{f}(I_{f}⁻))−S(N_{b}(I_{b}), N_{f}(I_{f}⁺))+m]₊ (2)

In equation 2, I_{f}^{t} represents a transformed foreground object image (e.g., one of the transformed foreground object images 436a-436b). Though equation 2 (like equation 1) shows use of the cosine similarity, the object recommendation system 106 utilizes various measures of similarity in various embodiments. For instance, in some cases, the object recommendation system 106 utilizes Euclidean distance as the measure of the similarity in determining the loss 444.

In one or more embodiments, the object recommendation system 106 utilizes the loss 444 to update the parameters of the geometry-lighting-aware neural network 438. For instance, in some cases, the object recommendation system 106 updates the parameters to optimize the geometry-lighting-aware neural network 438 by reducing the errors of its outputs. For example, in some instances, by updating the parameters, the object recommendation system 106 decreases the distance between positive samples and increases the distance between negative samples within the geometry-lighting-sensitive embedding space even where those negative samples merely differ in terms of lighting and/or geometry. Thus, at inference time, the object recommendation system 106 utilizes the geometry-lighting-aware neural network 438 to identify compatible foreground object images based on the distance between their embeddings and the embedding of the given background image.

By updating parameters of the geometry-lighting-aware neural network 438 utilizing transformed foreground object images, the object recommendation system 106 improves the accuracy with which the geometry-lighting-aware neural network 438 identifies foreground object images that are compatible with background images for image composition. In particular, the object recommendation system 106 enables the geometry-lighting-aware neural network 438 to identify foreground object images that are similar to background images in terms of lighting and/or geometry (as well as semantics).

In some implementations, the object recommendation system 106 combines the triplet loss of equation 1 and the triplet loss of equation 2 to determine a loss (e.g., a combined loss) for the geometry-lighting-aware neural network 438. For instance, in some implementations, the object recommendation system 106 generates predicted embeddings for a background image, a foreground object image corresponding to the background image, a transformed foreground object image generated from the foreground object image, and an additional foreground object image. The object recommendation system 106 further determines the triplet loss of equation 1 and the triplet loss of equation 2 utilizing the respective predicted embeddings and updates the parameters of the geometry-lighting-aware neural network 438 utilizing a combination of the triplet losses. For instance, in some cases, the object recommendation system 106 combines the triplet loss of equation 1 and the triplet loss of equation 2 as follows:

[symbol]

= [symbol] ₜ+ [symbol] _{c} (3)

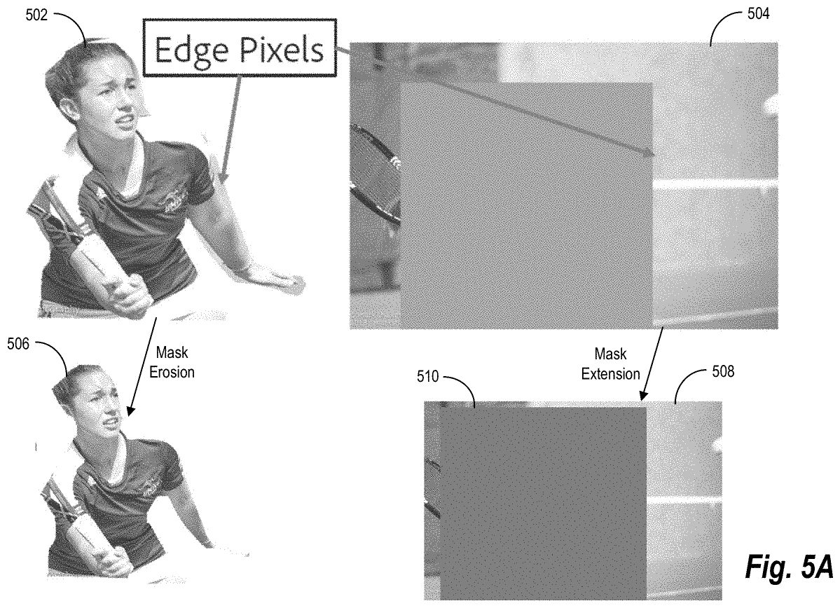

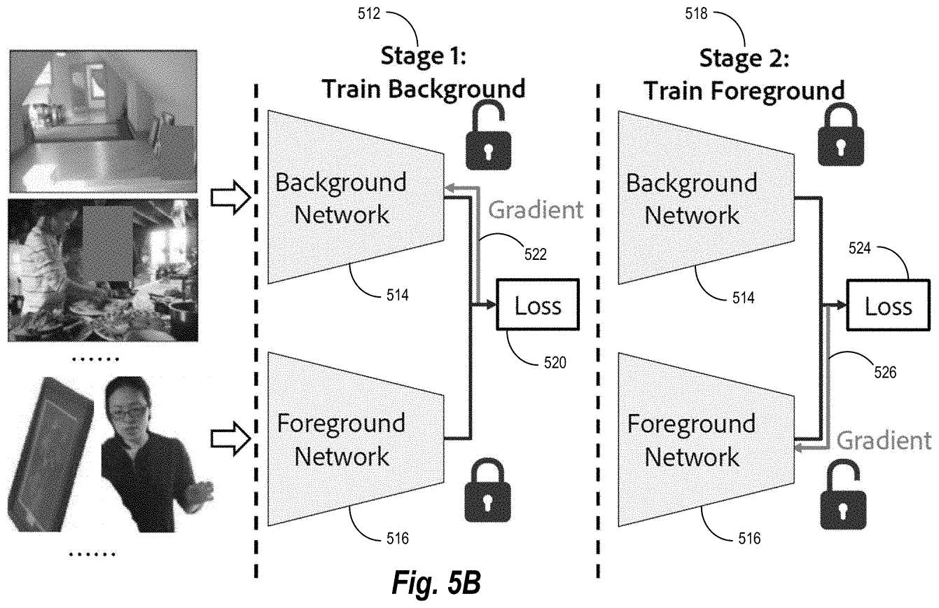

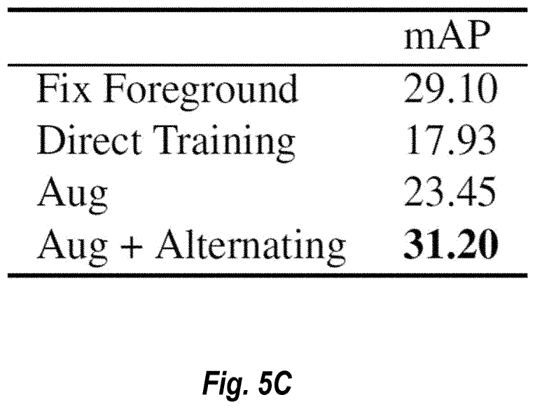

In some implementations, the object recommendation system 106 employs additional methods for building a geometry-lighting-aware neural network. Indeed, in some cases, the object recommendation system 106 implements one or more additional methods during that facilitate the learning of network parameters that improve operation at inference time. FIGS. 5A-5C illustrate diagrams associated with one or more additional methods for building a geometry-lighting-aware neural network in accordance with one or more embodiments.

In particular, FIG. 5A illustrates a diagram for generating a foreground object image and a background image utilizing augmented masks in accordance with one or more embodiments. For example, in one or more embodiments, the object recommendation system 106 utilizes modified masks to improve the ability of a geometry-lighting-aware neural network in determining similarities between background images and foreground object images. For instance, in some cases where an imperfect segmentation mask is used, some pixels of the resulting foreground object image are background pixels, which are likely to be the same as other background pixels. Indeed, as shown in FIG. 5A, the foreground object image 502 includes a portion of pixels from the background (e.g., at the edge of the portrayed foreground object) that are similar to pixels in the background image 504. The inclusion of background pixels within foreground object images can provide a strong cue of similarity. The use of foreground object images that include background pixels potentially results in a model that learns to detect similarities based on matching edge pixels rather than detect similarities based on other features, such as semantics, lighting, and geometry.

Accordingly, as shown in FIG. 5A, the object recommendation system 106 generates a foreground object image 506 via mask erosion. In particular, in some embodiments, the object recommendation system 106 extracts the foreground object image 506 from a digital image as described above with reference to FIG. 3A but using an eroded segmentation mask.

In one or more embodiments, an eroded segmentation mask includes a segmentation mask that has been modified so that the number of pixels of a digital image that are attributed to a foreground object is reduced. Indeed, in some embodiments, an eroded segmentation mask includes a segmentation mask that has been modified so that the resulting foreground object image includes less pixels than would be included from using the unmodified segmentation mask. For example, in one or more embodiments, the object recommendation system 106 generates an eroded segmentation mask by randomly or semi-randomly eroding a number of pixels of the segmentation mask at the edge between the foreground and the background (e.g., changing the affiliation of the pixels from the foreground object to the background).

Accordingly, in some cases using an eroded segmentation mask results in a foreground object image that includes relatively fewer background edge pixels. Thus, as shown in FIG. 5A, the foreground object image 506 generated via a corresponding eroded segmentation mask includes less background pixels when compared to the foreground object image 502. In some implementations, use of an eroded segmentation mask results in a foreground object image that includes relatively fewer foreground edge pixels as well. Indeed, in some cases, by utilizing an eroded segmentation mask, the object recommendation system 106 ensures that the similarity cue provided by background pixels is random or semi-random.

Further, as shown in FIG. 5A, the object recommendation system 106 generates a background image 508 using an extended mask 510. In particular, in some embodiments, the object recommendation system 106 generates the background image 508 from a digital image as described above with reference to FIG. 3A but using an extended mask. In one or more embodiments, an extended mask includes a mask that has been enlarged. Indeed, in some embodiments, an extended mask includes a mask that has been increased in size to cover or filter out a larger area of pixels. For instance, in some cases, the object recommendation system 106 generates an extended mask by randomly or semi-randomly extending a corresponding mask by a number of pixels in at least one direction.

By utilizing foreground object images extracted from digital images using eroded segmentation masks and background images generated from the digital images using extended masks, the object recommendation system 106 improves the parameter-learning for the geometry-lighting-aware neural network. Indeed, the object recommendation system 106 avoids learning network parameters that rely on edge pixels as cues for determining similarities. Thus, at inference time, the geometry-lighting-aware neural network can more accurately identify foreground object images that are compatible in terms of other features, such as semantics, geometry, and/or lighting.

FIG. 5B illustrates utilizing an alternating update process to update parameters of a geometry-lighting-aware neural network in accordance with one or more embodiments. Indeed, as shown in FIG. 5B, the object recommendation system 106 updates the parameters of a geometry-lighting-aware neural network in two stages. In particular, as shown, in a first stage 512, the object recommendation system 106 updates the parameters of the background network 514 while maintaining the parameters of the foreground network 516 (e.g., preventing the parameters of the foreground network 516 from changing). Further, in a second stage 518, the object recommendation system 106 updates the parameters of the foreground network 516 while maintaining the parameters of the background network 514. In one or more embodiments, the object recommendation system 106 performs the first stage 512 and/or the second stage 518 utilizing multiple iterations.

To illustrate, in one or more embodiments, in the first stage 512, the object recommendation system 106 utilizes the background network 514 and the foreground network 516 of the geometry-lighting-aware neural network to generate predicted embeddings from a background image, a foreground object image, a transformed foreground object image (as a negative sample), and/or an additional foreground object image (as a negative sample). The object recommendation system 106 further determines a loss 520 from the predicted embeddings, such as by using the triplet loss of equation 1, the triplet loss of equation 2, or the combined loss of equation 3. The object recommendation system 106 back propagates the loss 520 (as shown by the line 522) and updates the parameters of the background network 514 accordingly while maintaining the parameters of the foreground network 516. As mentioned, in some implementations, the object recommendation system 106 repeats the process through various iterations using further positive and negative samples.

Similarly, in one or more embodiments, the object recommendation system 106 updates the foreground network 516 of the geometry-lighting-aware neural network in the second stage 518. The object recommendation system 106 can utilize the same (or different) positive and negative samples as used in the first stage 512 or use different samples. Like with the first stage 512, the object recommendation system 106 utilizes the background network 514 and the foreground network 516 to generate predicted embeddings, determines a loss 524 from the predicted embeddings, and back propagates the loss 524 (as shown by the line 526) to update the parameters of the foreground network 516. As mentioned, in some implementations, the object recommendation system 106 repeats the process through various iterations using further positive and negative samples.

In one or more embodiments, the object recommendation system 106 performs each of the first stage 512 and the second stage 518 multiple times. In some cases, however, the object recommendation system 106 performs each of the first stage 512 and the second stage 518 once.

In one or more embodiments, by modifying the parameters of the foreground network 516, the object recommendation system 106 enables the foreground network 516 to flexibly learn from various data samples, which is not available under many conventional systems that utilize frozen, pre-trained parameters for the foreground network. Further, by learning parameters for the background network 514 and the foreground network 516 in separate stages, the object recommendation system 106 prevents the embedded features of the geometry-lighting-aware neural network from drifting significantly, which can be seen from training these components together. In particular, the object recommendation system 106 improves the accuracy of the geometry-lighting-aware neural network by enabling it to maintain semantic features while allowing the foreground network 516 to flexibly learn from the data for other features (e.g., lighting and geometry), further improving performance at inference time.

Indeed, FIG. 5C illustrates a table reflecting experimental results regarding the effectiveness of the object recommendation system 106 in accordance with one or more embodiments. In particular, the table of FIG. 5C compares the performance of various embodiments of the geometry-lighting-aware neural network that have undergone different training strategies. The table of FIG. 5C utilizes the mean average precision (mAP) metric in comparing the performance.

In the table, “Fixed Foreground” refers to an embodiment of the geometry-lighting-aware neural network where the foreground network was pre-trained and its parameters were frozen during the learning process. “Direct Training” refers to an embodiment of the geometry-lighting-aware neural network where the parameters of the foreground network and background network were learned simultaneously. “Aug” refers to an embodiment of the geometry-lighting-aware neural network where the parameters were learned using one or more augmented masks, such as eroded segmentation masks for the foreground object images and/or extended masks for the background images. “Aug+Alternating” refers to an embodiment of the geometry-lighting-aware neural network that learned parameters via augmented masks and an alternating update strategy. The table of FIG. 5C compares the performance of the embodiments on the compositing-aware image search (CAIS) database described by Hengshuang Zhao et al., Compositing-aware Image Search, Proceedings of the European Conference on Computer Visions (ECCV), pages, 502-516, 2018.

As shown by the table of FIG. 5C, the “Aug+Alternating” embodiment of the geometry-lighting-aware neural network greatly outperforms the other embodiments. Indeed, as shown, the “Direct Training” and “Aug” embodiments perform more poorly when compared to the “Fixed Foreground” implementation that mimics the parameter learning of many conventional systems. By further including the alternating update process, however, the geometry-lighting-aware neural network improves upon the conventional approach.

Thus, the object recommendation system 106 builds a geometry-lighting-aware neural network by learning network parameters via one or more of the processes described above with reference to FIGS. 3A-5C. In one or more embodiments, at inference time, the object recommendation system 106 utilizes the geometry-lighting-aware neural network having the learned network parameters to identify foreground object images that are compatible with background images in terms of semantics, lighting, and/or geometry. For instance, in some implementations, the object recommendation system 106 utilizes the geometry-lighting-aware neural network to generate an embedding for a given background image within the learned geometry-lighting-sensitive embedding space and identifies one or more compatible foreground object images based on the embedding. For instance, in some cases, the object recommendation system 106 determines similarity scores (e.g., using cosine similarity, Euclidean distance, or some other measure of proximity within the embedding space) between the embedding for the background image and embeddings for background object images. The object recommendation system 106 further selects one or more foreground object images based on the similarity scores, such as by selecting the one or more foreground object images corresponding to the highest similarity score(s). Thus, in some implementations, the object recommendation system 106 recommends the one or more selected foreground object images for use in generating a composite image with the given background image.

As indicated above, in some cases, the object recommendation system 106 receives a query bounding box with a background image for guiding the object search and retrieval. In some cases, the object recommendation system 106 utilizes the geometry-aware-lighting neural network with the learned parameters to generate an embedding for the portion of the background image that corresponds to the query bounding box. Thus, the object recommendation system 106 utilizes the geometry-lighting-aware neural network in identifying and recommending foreground object images that are specifically compatible with that portion of the background image. Indeed, in some cases, the object recommendation system 106 utilizes the size and/or location of the query bounding box as parameters for object retrieval.

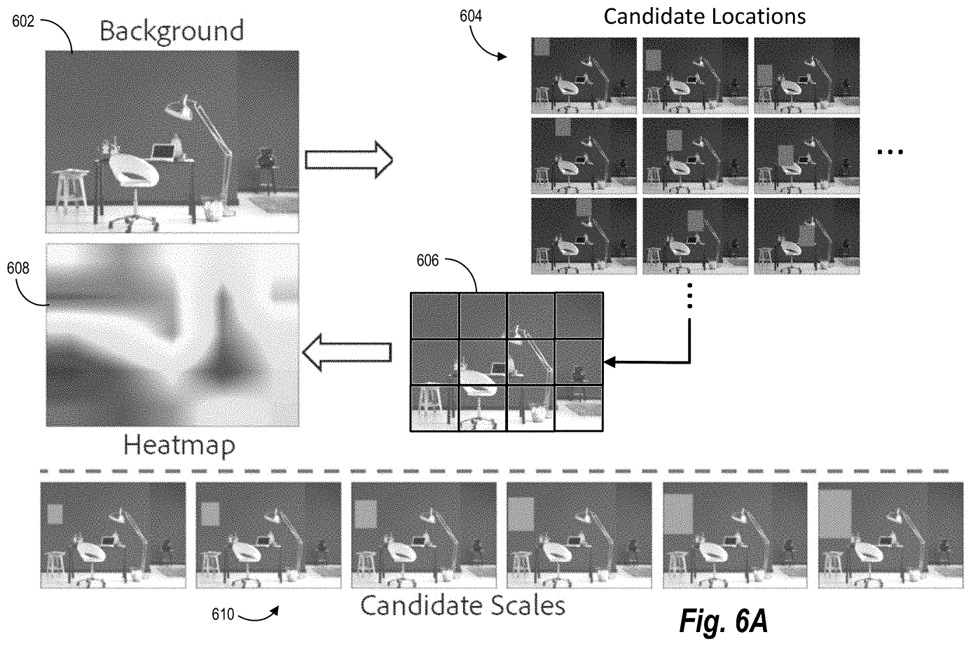

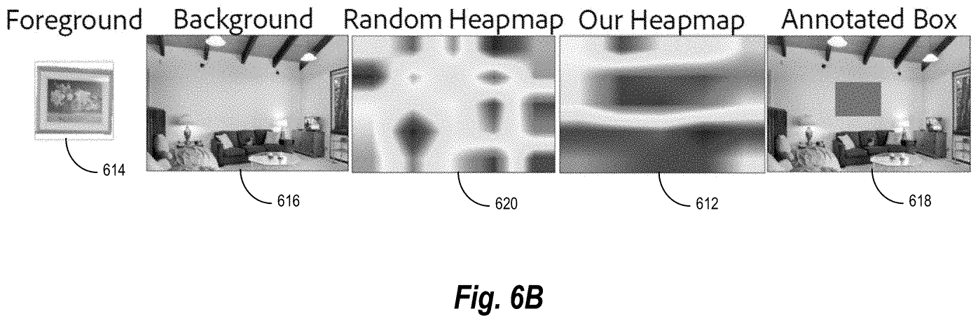

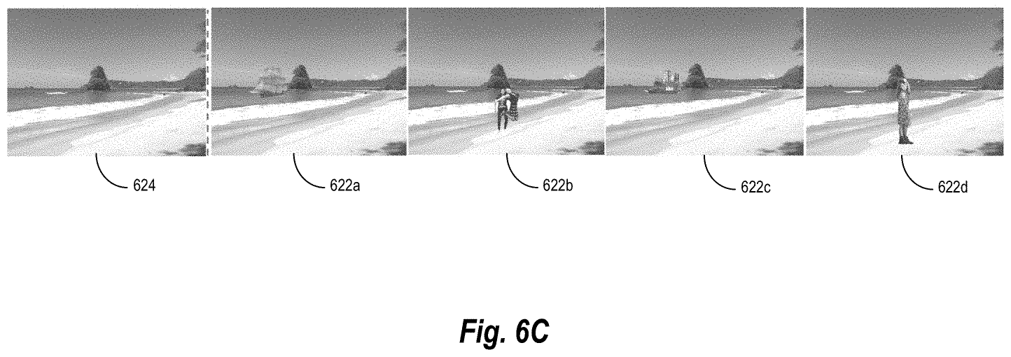

In one or more embodiments, however, the object recommendation system 106 receives a background image without receiving a query bounding box. In some cases, the object recommendation system 106 still operates to identify and recommend foreground object images that are compatible with the background image in terms of semantics, lighting, and/or geometry. For example, in some cases, the object recommendation system 106 determines a location and/or scale for a foreground object image within the background image for use in generating a composite image. Accordingly, in some implementations, the object recommendation system 106 recommends a foreground object image by further recommending a location and/or a scale for the foreground object image within the given background image. FIG. 6A illustrates determining a location and/or scale for a foreground object image within a background image in accordance with one or more embodiments.

As shown in FIG. 6A, the object recommendation system 106 determines a recommended location for a foreground object image within a background image 602 by determining a plurality of candidate locations 604. In particular, the object recommendation system 106 generates a plurality of bounding boxes for a plurality of locations within the background image 602. In one or more embodiments, the object recommendation system 106 generates the plurality of bounding boxes using one or more aspect ratios. In some cases, the object recommendation system 106 generates the plurality of bounding boxes using one or more scales.

In one or more embodiments, the object recommendation system 106 retrieves foreground image objects based on the plurality of bounding boxes. For instance, in some cases, the object recommendation system 106 retrieves one or more foreground object images for a bounding box upon determining that the foreground object image(s) is compatible with a portion of the background image 602 associated with the bounding box. Indeed, in some implementations, the object recommendation system 106 utilizes a neural network to generate an embedding for the portion of the background image 602 associated with the bounding box. Further, the object recommendation system 106 determines similarity scores (e.g., using cosine similarity, Euclidean distance, or some other measure of proximity within the embedding space) for the embedding and the embeddings of foreground object images. Accordingly, the object recommendation system 106 selects the one or more foreground object images based on the similarity scores (e.g., by selecting the one or more foreground object images having the highest similarity scores). In one or more embodiments, the object recommendation system 106 utilizes a geometry-lighting-aware neural network to generate the embeddings within a geometry-lighting-sensitive embedding space to facilitate the retrieval of foreground object images that are compatible in terms of geometry and/or lighting (as well as semantics).

In one or more embodiments, the object recommendation system 106 determines a ranking for the retrieved foreground object images based on their similarity scores. Further, the object recommendation system 106 selects a foreground object image based on the ranking, such as by selecting the foreground object image having the highest similarity score. In some embodiments, the object recommendation system 106 further associates the selected foreground object image with a bounding box, such as by generating a bounding box having the same aspect ratio of the foreground object image (or using the bounding box for which the foreground object image was retrieved). In some implementations, the object recommendation system 106 further generates the bounding box for the foreground object image to include a scale that is a fraction of the scale of the background image 602.

As shown in FIG. 6A, the object recommendation system 106 further generates a grid 606 of locations (e.g., a k×k grid) for the background image 602 using the bounding box associated with the selected foreground object image. For instance, in some embodiments, the object recommendation system 106 generates the grid 606 of locations to cover the background image 602 in a sliding window manner. In one or more embodiments, the object recommendation system 106 determines similarity scores for the selected foreground object image and the locations for the background image 602 from the grid 606. To illustrate, in some embodiments, the object recommendation system 106 utilizes a neural network to generate an embedding for each of the locations of the background image 602 from the grid 606 and determines a similarity score for the location based on its embedding and the embedding for the foreground object image. In one or more embodiments, the object recommendation system 106 utilizes a geometry-lighting-aware neural network to generate the embeddings so that the similarity scores are determined in terms of lighting and/or geometry as well as semantics.

Accordingly, the object recommendation system 106 determines a location for the selected foreground object image within the background image 602 using the similarity scores (e.g., by selecting the location associated with the highest similarity score). In one or more embodiments, the object recommendation system 106 generates a recommendation that recommends using the foreground object image at the determined location within the background image 602 for generating a composite image.

As shown in FIG. 6A, the object recommendation system 106 further generates a location heatmap 608 using the locations of the grid 606. In particular, the object recommendation system 106 generates the location heatmap 608 using the similarity scores determined for the locations of the grid 606.

In one or more embodiments, a location heatmap includes presentation of location compatibility. In particular, in some embodiments, a location heatmap includes a heatmap that indicates the compatibility of a foreground object image with various locations withing a background image. For instance, in some cases, a location heatmap includes a heatmap having a range of values (e.g., color values) where a particular value from the range indicates a degree of compatibility between a location within a background image and a foreground object image. In one or more embodiments, a location heatmap provides indications for the entirety of the background image. In other words, a location heatmap provides an indication of compatibility (e.g., a value) for each location of a background image.

In one or more embodiments, the object recommendation system 106 generates the location heatmap 608 by interpolating the similarity scores determined for the locations of the grid 606 across the background image 602 (e.g., via bilinear interpolation). In some embodiments, the object recommendation system 106 further normalizes the interpolated values. Thus, in some cases, the object recommendation system 106 utilizes the similarity scores for those locations to determine compatibility of a selected foreground object image with all locations of the background image 602. In one or more embodiments, dimensions of the grid 606 are configurable. In particular, in some instances, the object recommendation system 106 changes the dimensions of the grid 606 (e.g., the stride of moving the foreground object image across the background image 602) in response to input from a client device, allowing for a change to the level of refinement with which the object recommendation system 106 determines the recommendation location.

In one or more embodiments, the object recommendation system 106 provides the location heatmap 608 as part of the recommendation. For instance, in some embodiments, the object recommendation system 106 provides the location heatmap 608 for display on a client device as a visualization of the location of the background image 602 that is recommended for the foreground object image. Further, in some cases, by providing the location heatmap 608, the object recommendation system 106 also shows other compatible or non-compatible locations for the foreground object image.

As further shown in FIG. 6A, the object recommendation system 106 determines a scale for the selected foreground object image within the background image 602 by determining a plurality of candidate scales 610. For instance, in one or more embodiments, the object recommendation system 106 applies a range of scales on the bounding box associated with the selected foreground object image at the determined location and selects a scale accordingly. In one or more embodiments, the object recommendation system 106 provides the scale as part of the recommendation. For instance, as will be shown below, in some implementations, the object recommendation system 106 generates a composite image using the selected foreground object image with the recommended scale and at the recommended location within the background image 602 and provides the composite image as part of the recommendation.

In some implementations, the object recommendation system 106 determines a recommended location and a recommended scale for a foreground object image utilizing one of various other methods than described above. For instance, in some implementations, the object recommendation system 106 recommends a global optimum scale-location pair for the foreground object image. To illustrate, in one or more embodiments, the object recommendation system 106 generates a plurality of bounding boxes with different scales at a plurality of locations of the background image. For instance, in some implementations, the object recommendation system 106 generates a plurality of grids for the background image where each grid is associated with a different scale than the other grids. In some cases, the object recommendation system 106 analyzes the plurality of bounding boxes with the various scales at the different locations to determine a bounding box associated with a global optimum scale-location pair. For instance, the object recommendation system can determine that a bounding box is associated with a global optimum scale-location pair if it provides the highest similarity score when compared to the other bounding boxes. Thus, in some cases, the object recommendation system recommends utilizing the foreground object image with the scale and location of the bounding box associated with the global optimum scale-location pair.

FIG. 6B illustrates graphical representations reflecting experimental results regarding the effectiveness of the object recommendation system 106 in determining a recommended location for a foreground object image in accordance with one or more embodiments. Indeed, FIG. 6B illustrates a location heatmap 612 generated by the object recommendation system 106 indicating a recommended location for a foreground object image 614 within a background image 616. FIG. 6B compares the location heatmap 612 generated by the object recommendation system 106 with a ground truth annotated location 618 and another heatmap 620 generated using a randomized strategy. As shown in FIG. 6B, the location heatmap 612 generated by the object recommendation system 106 more accurately recommends a compatible location for the foreground object image 614 when compared to the heatmap 620 of produced by the randomized strategy.

FIG. 6C illustrates composite images 622a-622d generated utilizing recommended locations and/or recommended scales for foreground object images within a background image 624 in accordance with one or more embodiments. In particular, the composite images 622a-622c include the top foreground object images retrieved by the object recommendation system 106. As can be seen from FIG. 6C, the object recommendation system 106 can recommend foreground object images and corresponding locations and sizes that are compatible with the background image 624. Accordingly, the composite images 622a-622d generated using these recommendations have a realistic appearance.

By recommending locations and/or scales for foreground object images within a background image, the object recommendation system 106 operates more flexibly when compared to conventional systems. Indeed, where many conventional systems require a query bounding box to be provided in order to guide the object search and retrieval process, the object recommendation system 106 can flexibly identify compatible foreground object images when a query bounding box is not provided. Further, the object recommendation system 106 can flexibly determine a location and/or scale for the foreground object image that optimizes the compatibility of the foreground object image with the background image so that the resulting composite image has a realistic appearance. Additionally, by recommending locations and/or scales, the object recommendation system 106 operates more efficiently, as it reduces the amount of user input required in order to generate a recommendation.

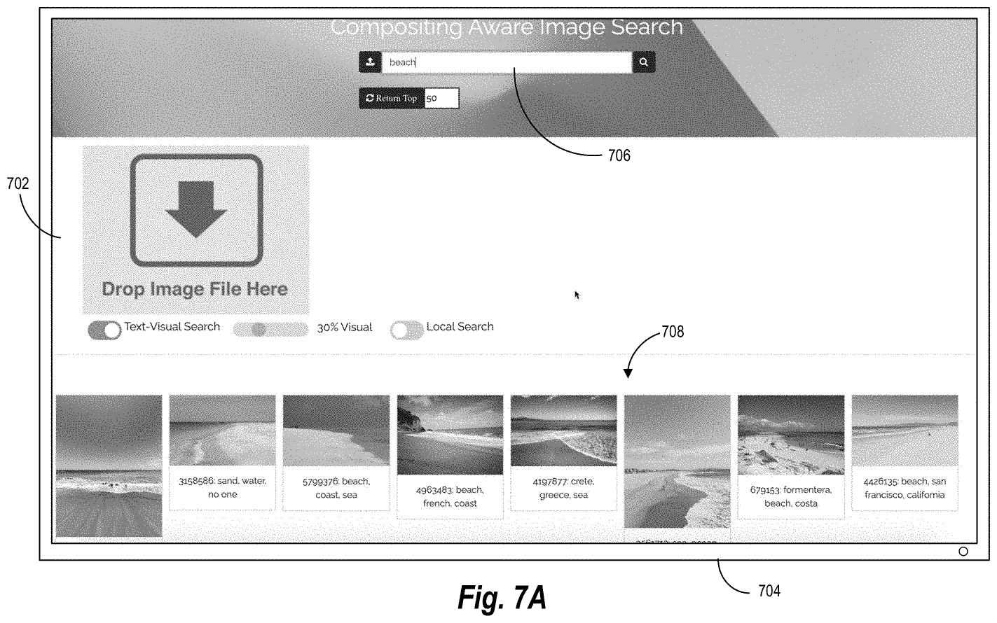

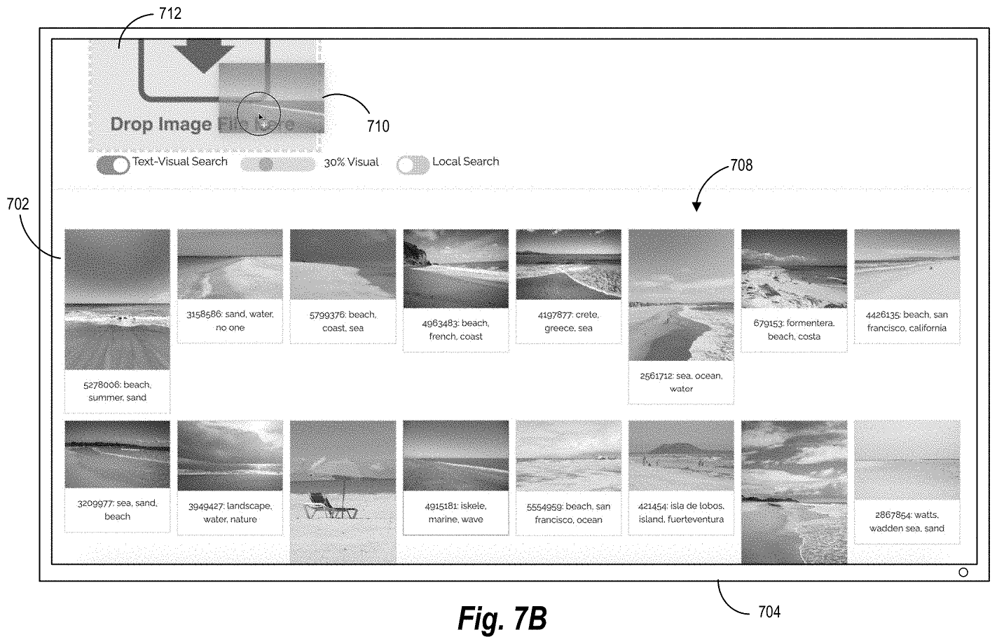

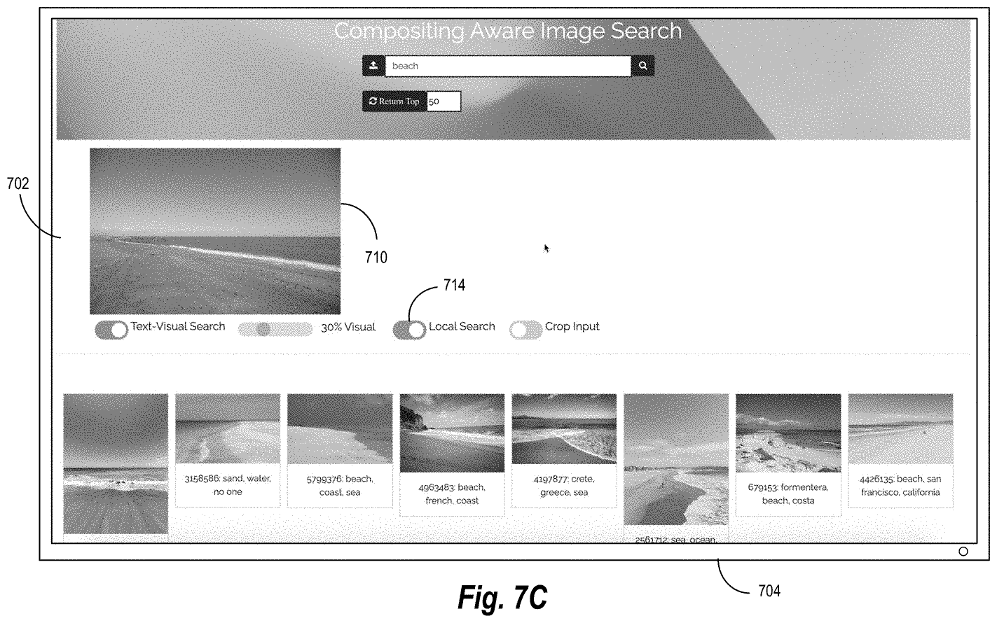

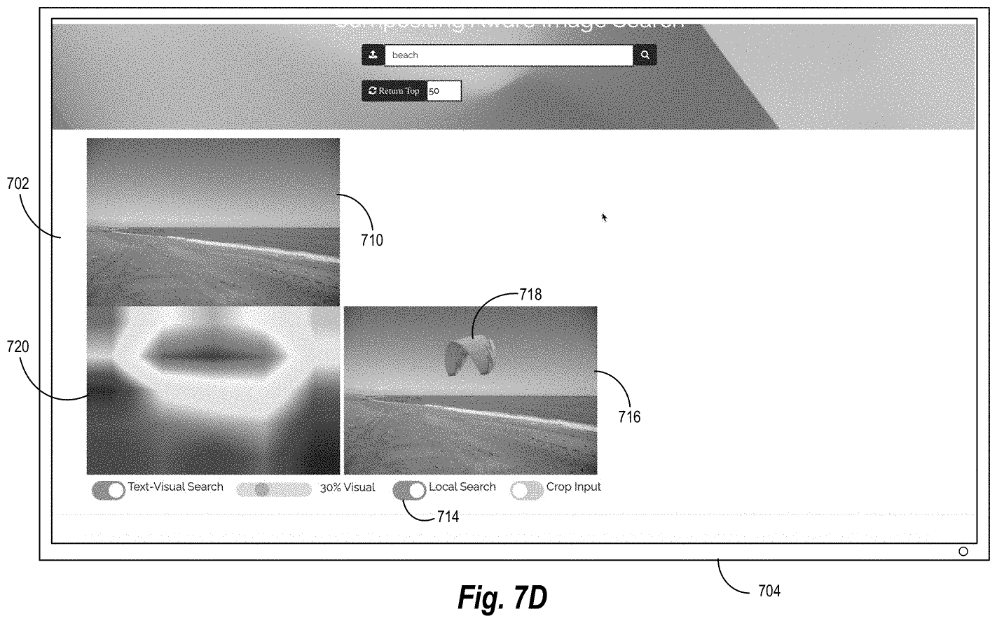

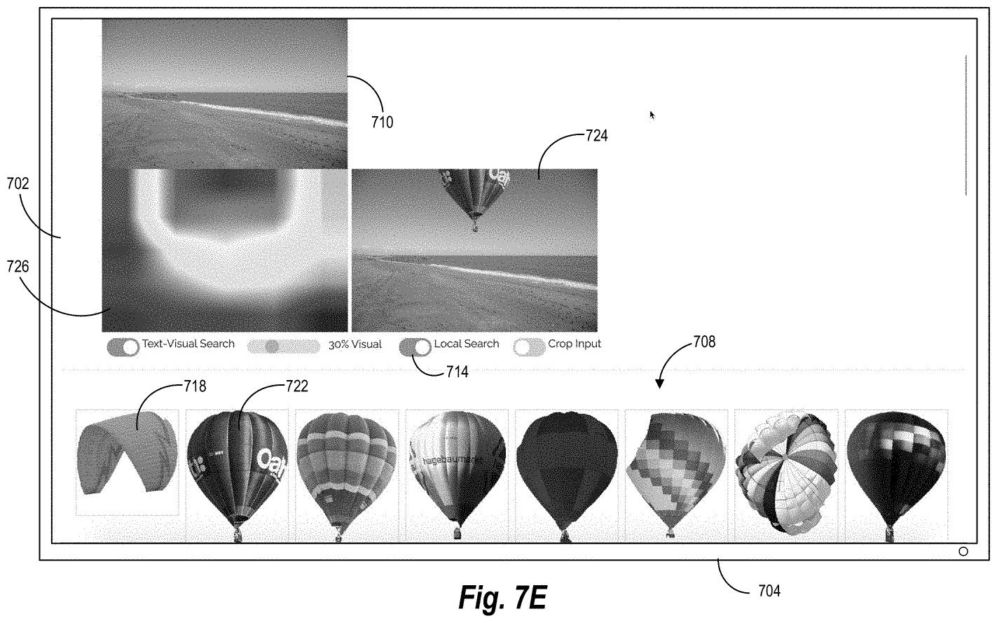

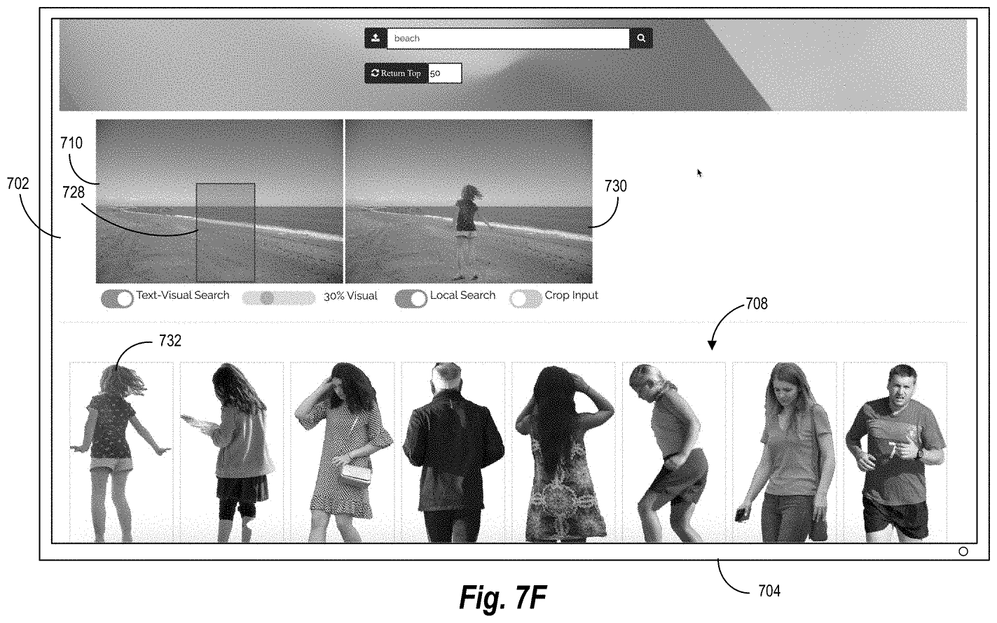

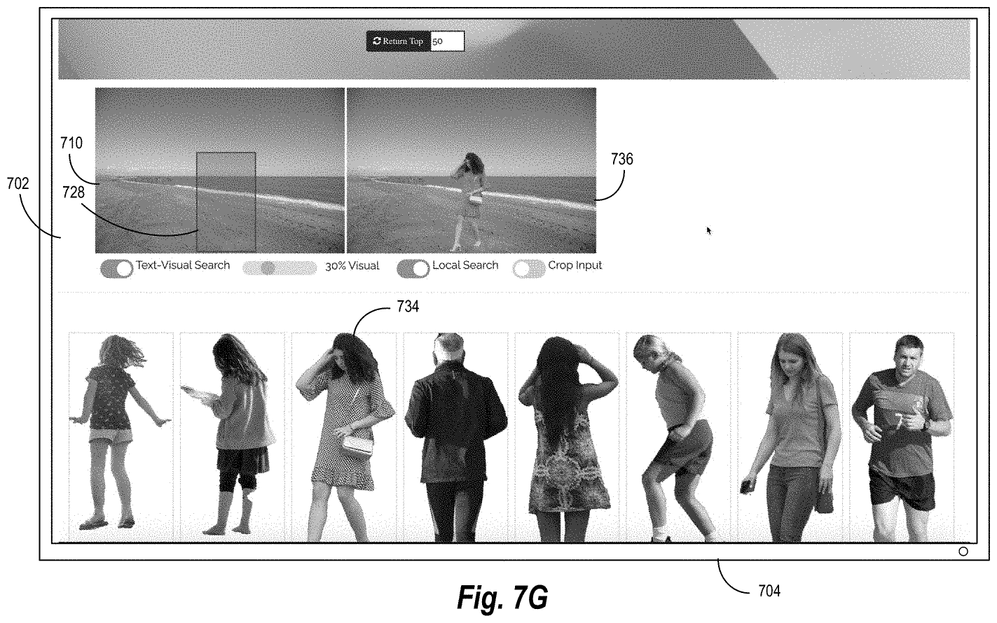

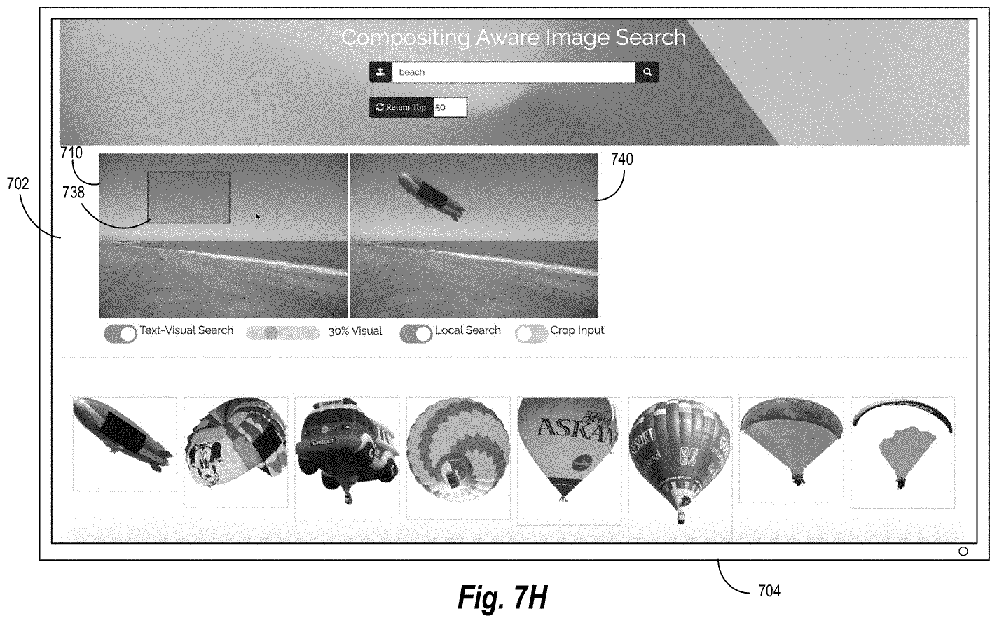

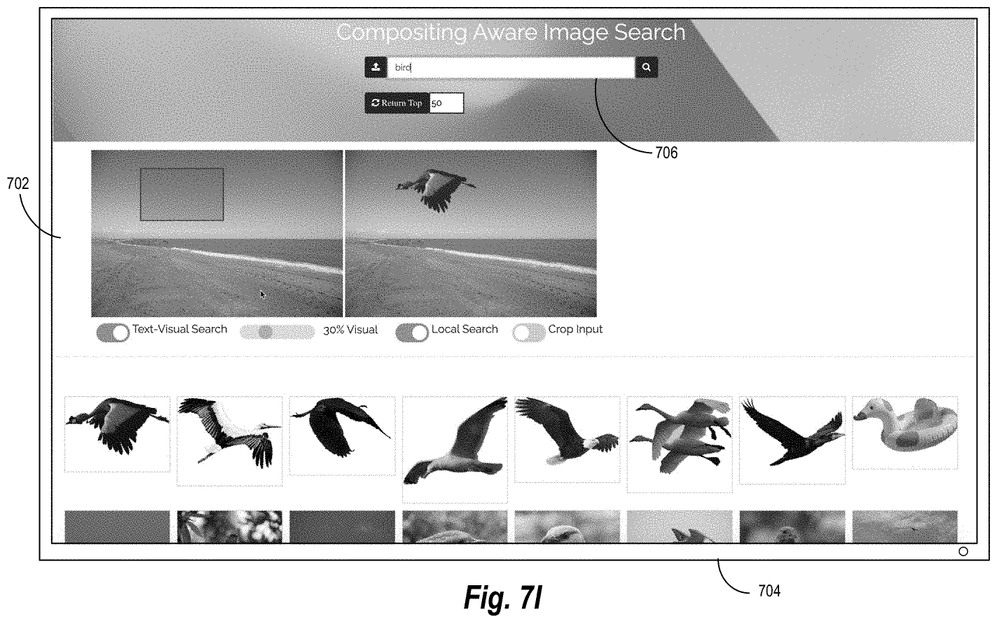

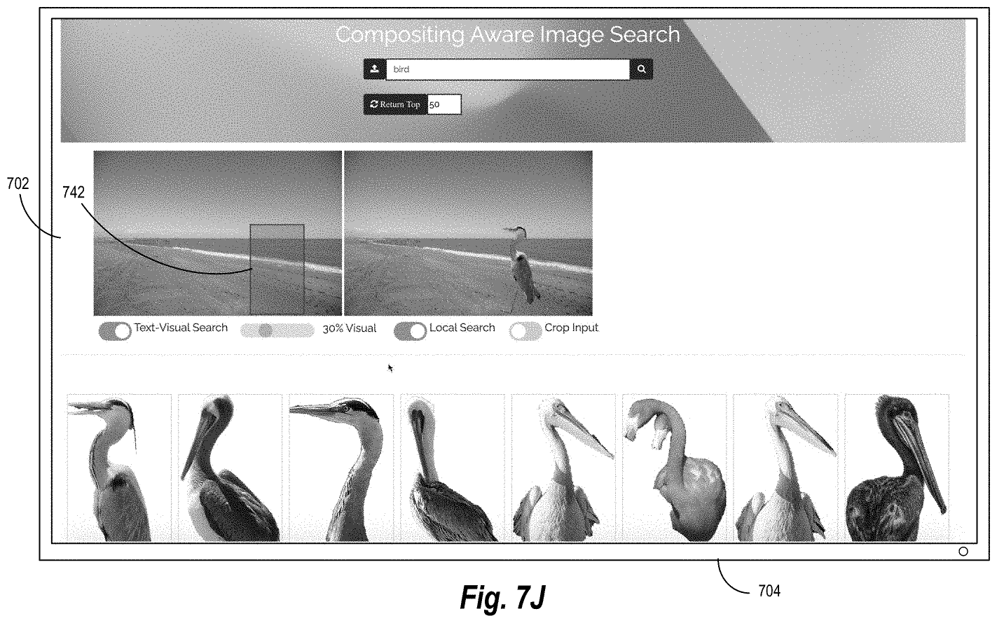

As mentioned above, in some embodiments, the object recommendation system 106 implements a graphical user interface to facilitate object retrieval and recommendation. In particular, in some cases, the object recommendation system 106 utilizes the graphical user interface to implement a workflow for providing foreground object image recommendations and composite images. FIGS. 7A-7J illustrate a graphical user interface used by the object recommendation system 106 for implementing a workflow for providing foreground object image recommendations and composite images in accordance with one or more embodiments.

For example, as shown in FIG. 7A, the object recommendation system 106 provides a graphical user interface 702 for display on a client device 704. As further, shown, the object recommendation system 106 provides a search field 706 for display within the graphical user interface 702. In one or more embodiments, the object recommendation system 106 provides the search field 706 to receive user input in searching for a background image. Indeed, as shown in FIG. 7A, in response to receiving user input via the search field 706 (e.g., a text query), the object recommendation system 106 retrieves and provides a plurality of digital images for display within a search results area 708 the graphical user interface 702 as candidate background images.

In one or more embodiments, the object recommendation system 106 searches for and retrieves the plurality of digital images via a web search. In some cases, the object recommendation system 106 searches local storage of the client device 704 or a remote storage device. Further, in some embodiments, rather than presenting the search field 706, the object recommendation system 106 presents one or more folders or links to the plurality of digital images or provides interactive options for selecting various parameters for retrieving background images.

As shown in FIG. 7B, the object recommendation system 106 receives a background image 710 via the graphical user interface 702. In particular, the object recommendation system 106 receives an indication that the background image 710 has been selected for use in generating a composite image via a drag-and-drop of the background image 710 from the search results area 708 to a target drop area 712 of the graphical user interface 702. In some cases, the object recommendation system 106 receives the background image 710 via other selection methods, such as a click or tap of the background image 710 or a hovering of a cursor over the background image 710 within the graphical user interface 702.

As illustrated in FIG. 7C, the object recommendation system 106 also provides a selectable option 714 for providing an indication to search for a foreground object image for use in generating the composite image with the background image 710. Indeed, in one or more embodiments, in response to a user interaction with the selectable option 714, the object recommendation system 106 receives an indication to search for one or more foreground object images that are compatible with the background image 710. Accordingly, in some embodiments, in response to detecting a user interaction with the selectable option 714, the object recommendation system 106 identifies one or more foreground object images to recommend in response. In some cases, however, the object recommendation system 106 retrieves one or more foreground object images without a user interaction with the selectable option 714 (e.g., automatically in response to selection of the background image 710).

In some implementations, the object recommendation system 106 utilizes a neural network (e.g., a geometry-lighting-aware neural network) to identify the one or more foreground object images. For instance, in some cases, the object recommendation system 106 utilizes the neural network to generate an embedding for the background image 710 and embeddings for a plurality of foreground object images within an embedding space (e.g., a geometry-lighting-sensitive embedding space). Further, the object recommendation system 106 determines compatibility based on the embeddings, such as by determining similarity scores between the embeddings for the foreground object images and the embedding for the background image 710. In some cases, as shown in FIG. 7C, the object recommendation system 106 is not provided with a query bounding box for the background image 710. Accordingly, in some embodiments, the object recommendation system 106 determines a foreground object image to recommend as described above with reference to FIG. 6A.

As shown in FIG. 7D, in response to receiving an indication to search for one or more foreground object images via a selection of the selectable option 714, the object recommendation system 106 provides a recommendation for display within the graphical user interface 702. In particular, as shown, the object recommendation system 106 generates and provides a composite image 716 for display within the graphical user interface 702. Indeed, in one or more embodiments, the object recommendation system 106 selects a foreground object image 718 (e.g., the foreground object image associated with the highest similarity score based on the embeddings) and generates and provides the composite image 716 for display without additional user input.

As further shown in FIG. 7D, as no query bounding box was provided with the background image 710, the object recommendation system 106 further recommends a location and scale for the foreground object image 718 within the background image 710. In particular, as shown, the object recommendation system 106 generates the composite image 716 by positioning the foreground object image 718 at a recommended location and using a recommended scale. Further, as shown in FIG. 7D, the object recommendation system 106 generates and provides a location heatmap 720 for display within the graphical user interface 702 as part of the recommendation. Thus, as shown in FIG. 7D, in some cases, the object recommendation system 106 provides the background image 710, the composite image 716, and the location heatmap 720 for simultaneous display.

As shown in FIG. 7E, in some implementations, the object recommendation system 106 retrieves a plurality of foreground object images in response to detecting a selection of the selectable option 714. Indeed, as shown, the object recommendation system 106 provides the plurality of foreground object images for display within the search results area 708 of the graphical user interface 702. In one or more embodiments, the object recommendation system 106 arranges the plurality of foreground object images within the search results area 708 based on a ranking. For instance, as shown, the object recommendation system 106 provides the foreground object image 718 as a first foreground object image, indicating that the foreground object image 718 is most compatible with the background image 710 (e.g., is associated with the highest compatibility score). Further, the object recommendation system 106 provides another foreground object image 722 as a second foreground object image, indicating the foreground object image 722 is the second most compatible with the background image 710.

As further show in FIG. 7E, the object recommendation system 106 enables a change to the recommendation initially discussed with reference to FIG. 7D. For instance, as illustrated, upon a selection of the foreground object image 722, the object recommendation system 106 generates and provides a composite image 724 that combines the foreground object image 722 with the background image 710. As further shown, the object recommendation system 106 positions the foreground object image 722 at a recommended location using a recommended scale and generates and provides another location heatmap 726 based on the foreground object image 722. Thus, while the object recommendation system 106 generates and provides an initial recommendation without additional user input, the object recommendation system 106 allows for additional user input and modifies the initial recommendation accordingly.

As shown in FIG. 7F, the object recommendation system 106 further modifies the provided recommendation in response to further user input. Indeed, as shown in FIG. 7F, the object recommendation system 106 receives a query bounding box 728 via one or more user interactions with the graphical user interface 702. In response, the object recommendation system 106 retrieves and provides, for display within the search results area 708, a plurality of foreground object images that are compatible with the portion of the background image 710 that corresponds to the query bounding box 728. Further, the object recommendation system 106 generates a composite image 730 using a foreground object image 732 and the background image 710. In particular, the object recommendation system 106 generates the composite image 730 by positioning the foreground object image 732 at the location and using the scale indicated by the query bounding box 728.

As indicated by FIG. 7F, the object recommendation system 106 does not provide a location heatmap indicating a recommended location as the query bounding box 728 already indicates a desired location. In some instances, however, the object recommendation system 106 still generates and provides a location heatmap to indicate compatibilities of the retrieved foreground object images with different locations of the background image 710.

As shown by FIG. 7G, the object recommendation system 106 further modifies the recommendation in response to yet further user input. In particular, as shown, the object recommendation system 106 detects a selection of another foreground object image 734 and generates a composite image 736 using the background image 710 and the foreground object image 734. In particular, the object recommendation system 106 still positions the foreground object image 734 at a location and using a scale indicated by the query bounding box 728 to generate the composite image 736.

As shown by FIG. 7H, the object recommendation system 106 provides different recommendations based on the positioning of a query bounding box. Indeed, as illustrated, the object recommendation system 106 receives another query bounding box 738 at a different location of the background image 710. In response, the object recommendation system 106 retrieves foreground object images that are compatible with the portion of the background image 710 associated with the query bounding box 738 and generates a composite image 740 as part of the recommendation accordingly.

As shown by FIG. 7I, in some cases, the object recommendation system 106 provides recommendations based on other user-constraints (in addition to the constraints indicated by a query bounding box). For instance, as shown in FIG. 7I, the object recommendation system 106 receives user input via the search field 706 displayed within the graphical user interface 702. In particular, the user input indicates a category of foreground object images to retrieve. For instance, the object recommendation system 106 does a semantic search (e.g., utilizing a semantic neural network that compares semantic word embeddings to digital image embeddings) to identify a subset of digital images/objects that match the user input entered via the search field 706. The object recommendation system 106 then analyzes the subset of digital images (e.g., utilizing a geometry-lighting-aware neural network) to generate a recommendation. Accordingly, in some embodiments, the object recommendation system 106 generates a recommendation using a foreground object image from the category indicated by user input. As shown by FIG. 7J, as the user provides another query bounding box 742, the object recommendation system 106 changes the recommendation while still adhering to the provided category of foreground object images.

Thus, in one or more embodiments, the object recommendation system 106 utilizes a graphical user interface to implement a workflow that operates with more efficiency when compared to conventional systems. Indeed, the object recommendation system 106 can recommend foreground object images and corresponding composite images based on a low number of user interactions. For instance, as discussed above, based on as little as a selection of a background image, the object recommendation system 106 can retrieve a compatible foreground object image, determine a recommended location and scale for the foreground object image, generate a heatmap indicating the recommended location, and/or generate a composite image using the foreground object image at the recommended location and with the recommended scale.

Additionally, the object recommendation system 106 further maintains flexibility by changing the recommendation in response to additional user interaction. Again, the additional user interaction can be minimal, such as a mere selection of a different foreground object image provided within search results or an input indicating a category of foreground object images to target. Thus, in some implementations, the object recommendation system 106 provides a predicted optimal recommendation based on little input and gradually changes the recommendation to satisfy more specific needs are more input is received.

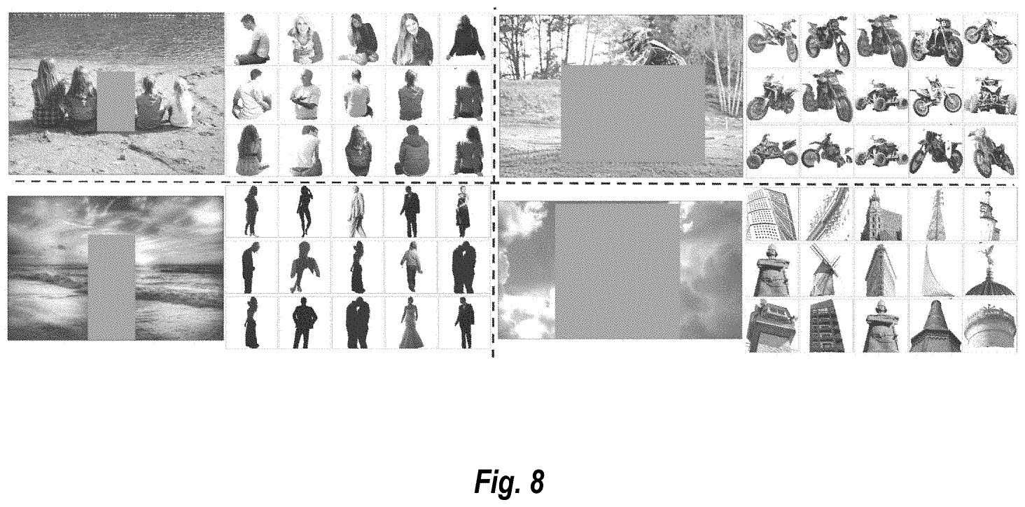

As previously mentioned, the object recommendation system 106 operates more accurately when compared to conventional systems. In particular, by utilizing a geometry-lighting-aware neural network to determine compatibility in terms of geometry and lighting as well as semantics, the object recommendation system 106 can retrieve foreground object images that are a better fit with a given background images. Researchers have conducted studies to determine the accuracy of one or more embodiments of the object recommendation system 106. FIGS. 8-11C provide qualitative and quantitative results regarding the effectiveness of the object recommendation system 106 in accordance with one or more embodiments.

In particular, FIG. 8 illustrates graphical representations reflecting experimental results regarding the effectiveness of the object recommendation system 106 in accordance with one or more embodiments. In particular, FIG. 8 shows the performance of a baseline foreground object retrieval model (first row of each example), which uses a fixed foreground network and mask augmentations. FIG. 8 further shows the performance of a model that is similar to the baseline model but utilizes an alternating training approach (second row of each example). FIG. 8 also shows the performance of an embodiment of the object recommendation system 106 that implements the full geometry-lighting-aware neural network described above where the network parameters are learned using contrastive learning via transformed foreground object images, mask augmentations, and alternating parameters updates (third row of each example).

FIG. 8 compares the performance of each tested model on the Pixabay and Open Images datasets respectively described in https://pixabay.com/ and Alina Kuznetsova et al., The Open Images Dataset V4, International Journal of Computer Vision, 128(7):1956-1981, 2020. These are large-scale, real-world datasets that includes images having a broad range of diversity and covering multiple image categories.

As shown in FIG. 8, the embodiment of the object recommendation system 106 represented in the third row recommends foreground object images that are more compatible with the corresponding background image in terms of geometry and lighting. Indeed, as can be seen, while the other tested models recommend foreground object images that are semantically compatible with the corresponding background image, many of the recommended foreground object images are facing the wrong direction or include drastically different lighting. Accordingly, FIG. 8 indicates that these models are less accurate in identifying foreground object images that are truly compatible with a background image.

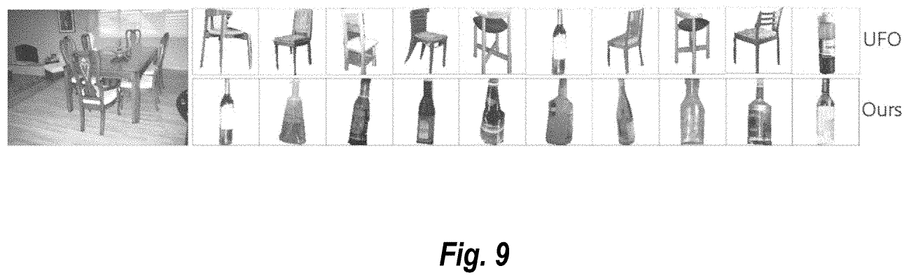

FIG. 9 illustrates graphical representations reflecting additional experimental results regarding the effectiveness of the object recommendation system 106 in accordance with one or more embodiments. In particular, FIG. 9 compares the performance of an embodiment of the object recommendation system 106 with the performance of the above-referenced UFO model described by Yinan Zhao et al. Further, FIG. 9 compares the performance of the tested models on the above-referenced CAIS dataset described by Hengshuang Zhao et al.

As shown by FIG. 9, the object recommendation system 106 achieves better results in terms of lighting and geometry when compared to the UFO model while maintaining semantic compatibility. For example, while both tested methods provide foreground object images that appear to be compatible with the scene in general, the foreground obj ect images provided by the object recommendation system 106 appear to be more compatible with the location on the table indicated by the bounding box.

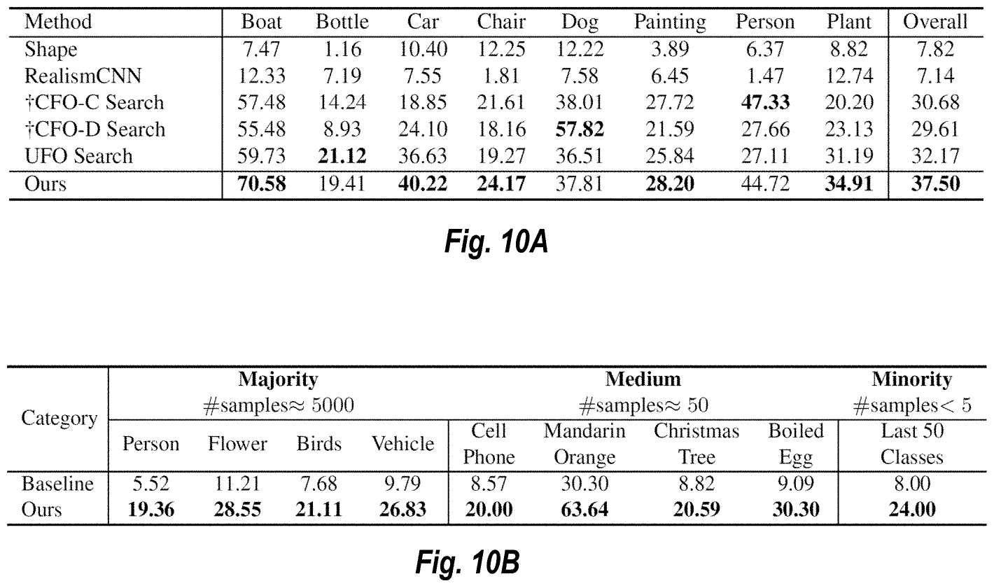

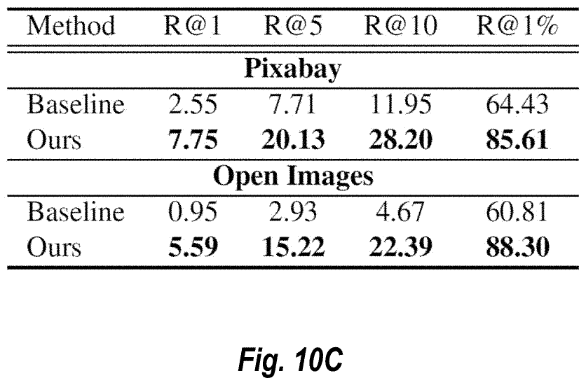

FIG. 10A illustrates a table reflecting further experimental results regarding the effectiveness of the object recommendation system 106 in accordance with one or more embodiments. The table of FIG. 10A compares the performance of the object recommendation system 106 with the Shape model described by Hengshuang Zhao et al. and the UFO model described by Yinan Zhao et al. The table of FIG. 10A also shows the performance of the convolutional neural network (labeled as “RealismCNN”) described by Jun-Yan et al., Learning a Discriminative Model for the Perception of Realism in Composite Images, Proceedings of the IEEE International Conference on Computer Vision, pages 3943-3951, 2015. Further, the table of FIG. 10A shows the performance of the constrained foreground object search methods (labeled “CFO-C Search” and “CFO-D Search”) described by Hengshuang Zhao et al. The CFO-C Search method trains a classifier to specify the category and then applies constrained retrieval from that category. The CFO-D Search method applies a constrained search to retrieve one hundred samples from each category and then adopts a discriminator to re-rank the retrievals by compositing with each background.

The table of FIG. 10A compares the performance of the tested models on the CATS dataset. The table further compares the performance using mAP-100, which is the mAP for the top one hundred retrievals. The table shows the mAP-100 value for several object classes. The table further compares the overall performance of each tested method.

As shown by FIG. 10A, the object recommendation system 106 outperforms the other methods in most of the object categories. Further, the object recommendation system 106 provides the best overall performance when compared to the other tested methods. While the CFO-C Search and CFO-D Search methods provide the best performance in some categories, these methods are not scalable in practice due to their use of multiple models and their constraint-based operation (denoted using †).

FIG. 10B illustrates a table comparing the performance of at least one embodiment of the object recommendation system 106 with a baseline model, such as the baseline model using the fixed foreground network and mask augmentations described above. The table of FIG. 10B compares the performance of the tested models on the Pixabay dataset. The table compares the performance using the Recall@10 metric, showing the measured percentages. Further, the table compares the performance across categories of different sizes (labeled “Majority,” “Medium,” and Minority”). As shown, the object recommendation system 106 significantly outperforms the baseline model for every category, reaffirming the improved performance discussed above with reference to FIG. 8.

FIG. 10C illustrates another table that compares the performance of an embodiment of the object recommendation system 106 with the baseline model on the Pixabay and Open Images datasets. The table compares the performances using several Recall@k metrics. The table of FIG. 10C shows, again, the improved performance of the object recommendation system 106 over the baseline model.

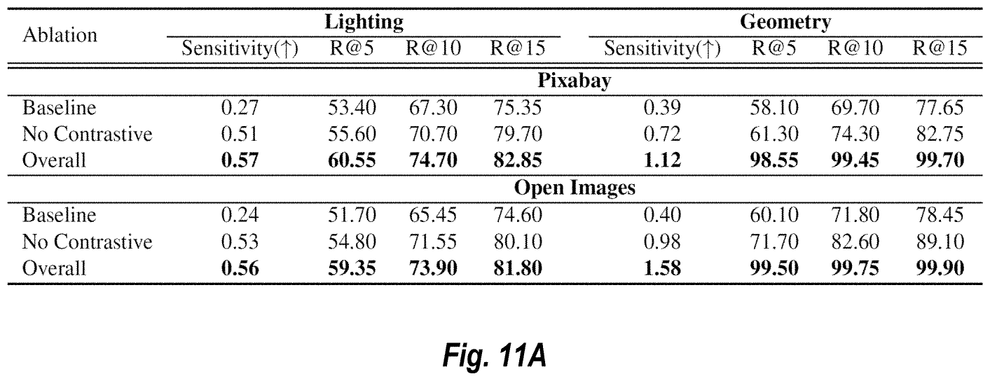

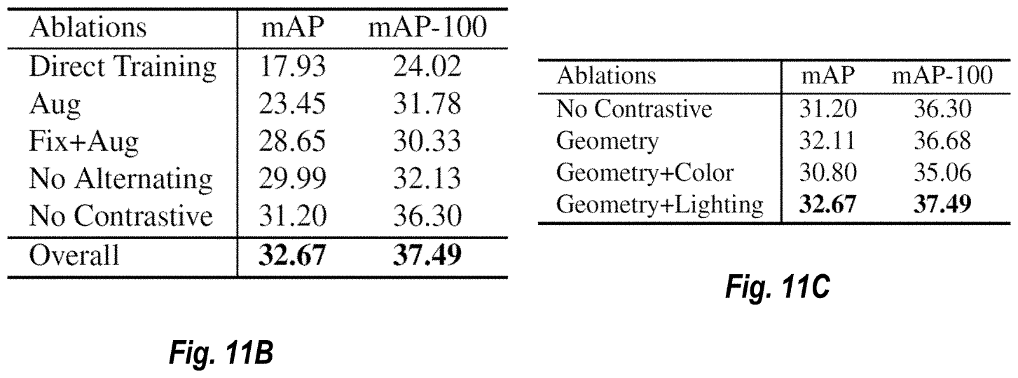

FIG. 11A illustrates a table comparing the performance of an embodiment of the object recommendation system 106 that implements the geometry-lighting-aware neural network described above (labeled “Overall”) with the baseline model as well as an embodiment of the object recommendation system 106 that learns network parameters without contrastive learning via transformed foreground object images (labeled “No Contrastive”). For measuring the performance, the researchers randomly selected two thousand foreground objects with their background images and, for each foreground object, generated fifty transformed objects using geometry transformations and fifty transformed objects using lighting transformations. The researchers then ranked the original foreground object with its corresponding transformed objects to determine the Recall@k value.

The researchers measured the discriminative ability of the models as the sensitivity to these transformations (e.g., the square Euclidean distance between normalized embedding features of the original and transformed foreground objects). With L2 normalization, the square Euclidean distance is d=2−2s where s is the cosine similarity. Accordingly, a higher sensitivity value corresponds to a larger distance between the features of original and transformed foreground objects.

As shown by the table of FIG. 11A, the embodiment of the object recommendation system 106 that implements the full geometry-lighting-aware neural network described above achieves better Recall@k and sensitivity values when compared to the other models. Indeed, when using the full geometry-lighting-aware neural network, the object recommendation system 106 shows much higher sensitivity to both geometry and lighting transformations. The results demonstrate the significance of using both alternating parameters updates and contrastive learning to improve discriminability.

FIG. 11B illustrates another table that compares the performance of various embodiments of the object recommendation system 106 using various methods to learn network parameters. The table of FIG. 11B compares the performances of these various methods with an embodiment of the object recommendation system 106 that implements the full geometry-lighting-aware neural network described above. As shown, the embodiment of the object recommendation system 106 that implements the full geometry-lighting-aware neural network described above outperforms all other methods of learning network parameters in both tested metrics.

FIG. 11C illustrates a table that compares performance of various embodiments of the object recommendation system 106 that learn network parameters via various contrastive learning approaches. As shown, the table compares the performance of an embodiment that does not implement contrastive learning, an embodiment that only implements geometry transformations, an embodiment that applies linear color-jittering on top of geometry transformations, and an embodiment that applies both geometry and lighting transformations to each foreground object. As shown by FIG. 11C, the embodiment of the object recommendation system 106 that implements both geometry and lighting transformations significantly outperforms the other embodiments.

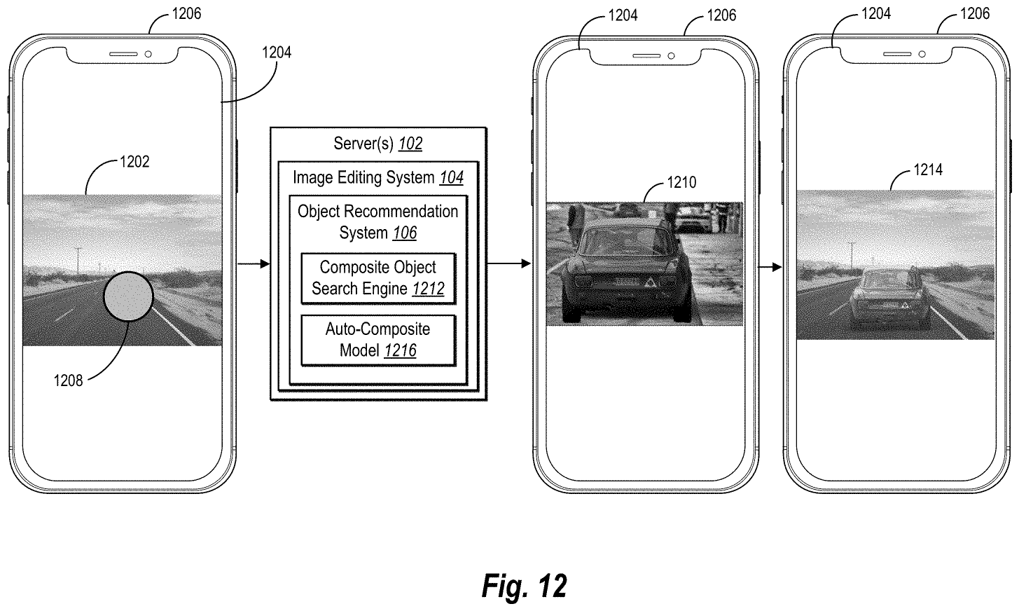

In one or more embodiments, the object recommendation system 106 implements a compositing pipeline for generating composite images. In particular, the object recommendation system 106 implements a pipeline of various processes. The object recommendation system 106 implements one or more of these processes to produce a compositing result. In some embodiments, the object recommendation system 106 implements components of the pipeline in response to one or more user interactions received via a graphical user interface. For instance, as previously discussed, the object recommendation system 106 provides recommendations for, and generates, composite images in response to selections of various selectable options displayed within a graphical user interface. FIGS. 12-20C illustrate diagrams that illustrate the various pipelines implemented by the object recommendation system 106 in response to user interactions with a graphical user interface in accordance with one or more embodiments.

FIG. 12 illustrates an overview diagram of the object recommendation system 106 implementing a pipeline for generating composite images in accordance with one or more embodiments. As shown in FIG. 12, the object recommendation system 106 provides a background image 1202 for display within a graphical user interface 1204 of a client device 1206. In some embodiments, the object recommendation system 106 provides the background image 1202 for display upon determining to use the background image 1202 in generating a composite image. In some cases, the object recommendation system 106 receives the background image 1202 from the client device 1206. In some cases, the object recommendation system 106 retrieves the background image 1202 from a database storing background images.

As further shown in FIG. 12, the object recommendation system 106 receives a user interaction via the graphical user interface 1204. In particular, FIG. 12 illustrates receiving a user interaction indicating a selected location 1208 of the background image 1202. Various additional or alternative user interactions will be discussed below as well as how the object recommendation system 106 responds to such user interactions.

As shown in FIG. 12, the object recommendation system 106 provides, to the client device 1206, a foreground object image 1210 in response to receiving the user interaction. In particular, the object recommendation system 106 provides the foreground object image 1210 as part of a recommendation for using the foreground object image 1210 with the background image 1202 to generate a composite image. For instance, in some embodiments, in response to receiving the user interaction via the graphical user interface 1204, the object recommendation system 106 searches for and retrieves at least one foreground object image (e.g., the foreground object image 1210) that is compatible with the background image 1202 for use in generating a composite image. As illustrated by FIG. 12, the object recommendation system 106 utilizes a composite object search engine 1212 to search for and retrieve the at least one foreground object image.

In one or more embodiments, a composite object search engine includes a search engine that searches for one or more foreground object images to use in generating a composite image. In particular, in some embodiments, a composite object search engine includes a search engine that searches for one or more foreground object images for use in combining with a background image to generate a composite image based on one or more search criteria indicated by search input. To illustrate, in some cases, a composite object search engine searches for one or more foreground object images based on search criteria indicated by text input, sketch input, and/or a portion (e.g., a selected portion) of the background image itself In some cases, a composite object search engine includes, but is not limited to, a compositing-aware search engine, a text search engine, or an image search engine.

In one or more embodiments, a compositing-aware search engine includes a search engine that searches for one or more foreground object images based on a compatibility with a background image in generating a composite image. For instance, in some cases, a compositing-aware search engine searches for one or more foreground object images based on compatibility in terms of semantics, lighting, geometry, tone, and/or scale. In one or more embodiments, a compositing-aware search engine includes a neural network or other machine learning model trained to determine compatibility based on one or more of the above-mentioned characteristics (or one or more additional or alternative characteristics). To illustrate, in some implementations, a compositing-aware search engine includes the geometry-lighting-aware neural network described above.

Additionally, as shown in FIG. 12, the object recommendation system 106 generates a composite image 1214 using the background image 1202 and the foreground object image 1210. Further, the object recommendation system 106 provides the composite image 1214 for display via the graphical user interface 1204. As illustrated, and as will be discussed in more detail below, the object recommendation system 106 generates the composite image 1214 utilizing an auto-composite model 1216.

In one or more embodiments, an auto-composite model includes a computer-implemented model that generates or modifies a composite image. In particular, in some embodiments, an auto-composite model includes a computer-implemented model that executes one or more processes for generating or modifying a composite image in response to a consolidated set of user interactions. In some cases, an auto-composite model includes, but is not limited to, a plurality of underlying models, such as a scale prediction model, a harmonization model, and a shadow generation model. Accordingly, the object recommendation system 106 implements one or more of the underlying models based on user selections made via a graphical user interface. For instance, in some cases, in response to receiving a selection of a particular feature to include within the composite image 1214, the object recommendation system 106 executes the corresponding model to provide this feature.

Indeed, as shown in FIG. 12, the object recommendation system 106 performs various processes in generating the composite image 1214 by executing the auto-composite model 1216. For instance, as shown, the object recommendation system 106 re-sizes the foreground object image 1210 within the composite image 1214 so the scale of the foreground object image 1210 matches of a scale of the background image 1202. Additionally, as shown, the object recommendation system 106 modifies a lighting of the foreground object image 1210 within the composite image 1214 based on a lighting of the background image 1202. Further, the object recommendation system 106 generates a shadow for the foreground object image 1210 within the composite image 1214. In particular, the object recommendation system 106 generates a shadow in accordance with the lighting conditions of the background image 1202. Thus, the object recommendation system 106 generates the composite image 1214 to provide a natural aesthetic for the combination of the foreground object image 1210 and the background image 1202.

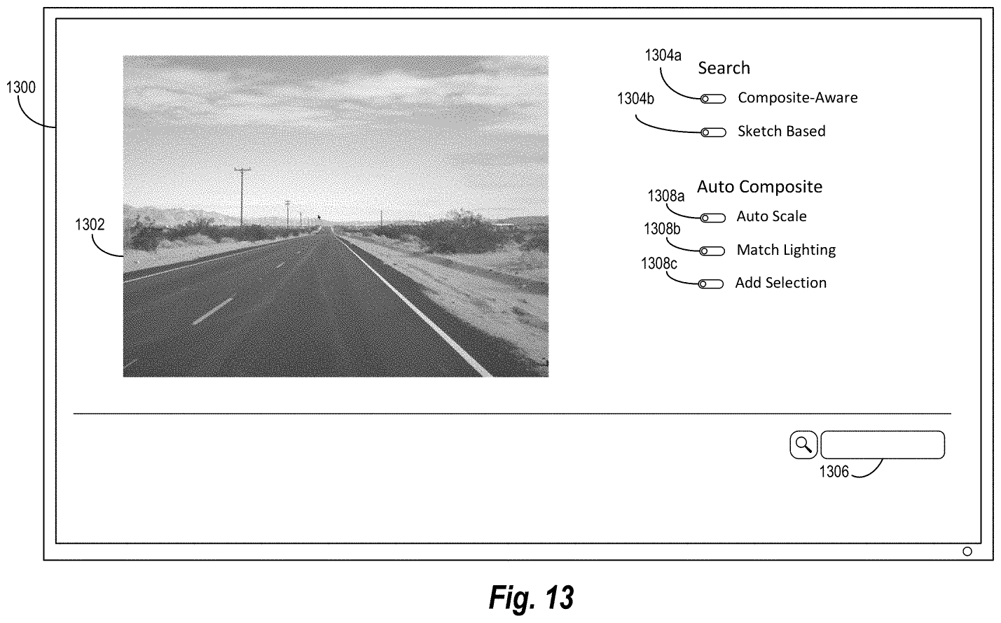

FIG. 13 illustrates a graphical user interface 1300 utilized by the object recommendation system 106 to facilitate the generation of composite images based on user interactions in accordance with one or more embodiments. As shown in FIG. 13, the object recommendation system 106 provides a plurality of interactive elements for display within the graphical user interface 1300. As will be discussed with respect to the figures that follow, the object recommendation system 106 utilizes the plurality of interactive elements to facilitate the flexible and efficient generation of composite images using foreground object images and background images (e.g., the background image 1302).

For instance, as shown in FIG. 13, the object recommendation system 106 provides selectable options 1304a-1304b for executing a search for one or more foreground object images via a composite object search engine. In particular, as shown, the object recommendation system 106 provides the selectable option 1304a for implementing a composite-aware search and the selectable option 1304b for implementing a sketch-based search. In other words, based on a user selection of the one of the selectable options 1304a-1304b, the object recommendation system 106 executes the corresponding search.

In one or more embodiments, a composite-aware search includes a search for one or more digital images for the purpose of creating a composite image. In particular, in some embodiments, a composite-aware search includes a search for one or more foreground object images for use in combining with a background image to generate a composite image. For instance, in some cases, a composite-aware search includes a search for one or more foreground object images based on a compatibility with a background image in generating a composite image. To illustrate, in some cases, the object recommendation system 106 executes a composite-aware search by searching for one or more foreground object images that are compatible with a background image in terms of semantics, lighting, geometry, tone, and/or scale. In some cases, the object recommendation system 106 executes a composite-aware search using a composite object search engine (e.g., a composite-aware search engine of the composite object search engine).

In one or more embodiments, a sketch-based search includes a search for one or more digital images based on a sketch input. In particular, in some embodiments, a sketch-based search includes a search for one or more foreground object images that match a sketch input. For instance, in some cases, the object recommendation system 106 executes a sketch-based search by searching for one or more foreground object images based on a size and object class indicated by a sketch input.

Additionally, as shown in FIG. 13, the object recommendation system 106 provides a text box 1306 for display within the graphical user interface 1300. In one or more embodiments, the object recommendation system 106 utilizes the text box 1306 for executing a search for one or more foreground object images. In particular, the object recommendation system 106 receives text input via the text box 1306 and retrieves one or more foreground object images based on the text input. In some cases, the object recommendation system 106 executes a search based on text input received via the text box 1306 alone or in combination with other search input (e.g., a user selection of the selectable option 1304a for a composite-aware search and/or a selection of a portion of the background image to be used).

Further, as shown in FIG. 13, the object recommendation system 106 provides additional selectable options 1308a-1308c for executing an auto-composite model to generate or modify a composite image. In particular, the object recommendation system 106 provides a selectable option 1308a for executing a scale prediction model, a selectable option 1308b for executing a harmonization model, or a selectable option 1308c for executing a shadow generation model. In other words, based on a user selection of the one of the selectable options 1308a-1308c, the object recommendation system 106 executes the corresponding model.

In one or more embodiments, a scale prediction model includes a computer-implemented model that determines a scale for a foreground object image within a composite image. In particular, in some embodiments, a scale prediction model includes a computer-implemented model (e.g., a machine learning model or other set of algorithms) that determines a scale for a foreground object image within a composite image based on a scale of the background image used for the composite image. In some cases, a scale prediction model further modifies the foreground object image based on the determined scale (e.g., resizes the foreground object image).

In one or more embodiments, a harmonization model includes a computer-implemented model that determines a lighting or tone for a foreground object image within a composite image. In particular, in some embodiments, a harmonization model includes a computer-implemented model (e.g., a machine learning model or other set of algorithms) that determines a lighting or tone for a foreground object image within a composite image based on a lighting or tone, respectively, of the background image used for the composite image. In some cases, a harmonization model further modifies the foreground object image based on the determined lighting or tone.

In one or more embodiments, a shadow generation model includes a computer-implemented model that generates a shadow for a foreground object image within a composite image. In particular, in some embodiments, a shadow generation model includes a computer-implemented model (e.g., a machine learning model or other set of algorithms) that generates a shadow for a foreground object image based on a lighting of the composite image (e.g., a lighting provided by the background image used in generating the composite image).

Though not expressly shown in FIG. 13, the object recommendation system 106 further enables user interactions with the background image 1302 in generating a composite image. In particular, as will be discussed in more detail below, the object recommendation system 106 enables user interactions that indicate scale and/or location of foreground object images within a resulting composition.

Thus, as indicated by FIG. 13, the object recommendation system 106 provides a small set of interactive elements for use in generating or modifying a composite image. In particular, in some embodiments, the object recommendation system 106 associates one or more backend actions with each of the interactive elements. Accordingly, in response to detecting a selection of an interactive element, the object recommendation system 106 executes a series of actions in some instances. When compared to conventional systems that typically require multiple user interactions to perform a series of actions, the object recommendation system 106 operates more efficiently as it reduces the number of user interactions required.

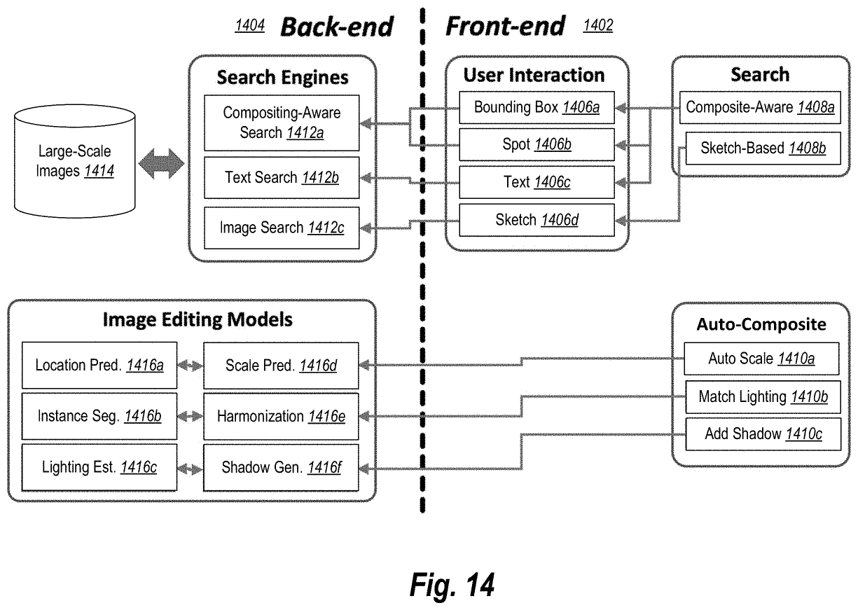

FIG. 14 illustrates a block diagram of architectural components of the object recommendation system 106 in accordance with one or more embodiments. In particular, FIG. 14 illustrates front-end components 1402 and back-end components 1404. FIG. 14 further illustrates the object recommendation system 106 utilizing these components to receive search input, provide search results, receive editing input, and provide editing results in accordance with one or more embodiments.

As shown in FIG. 14, the front-end components 1402 include user interaction components 1406a-1406d. In particular, the front-end components 1402 include components (e.g., interactive elements displayed on a graphical user interface of a client device) for receiving user interactions. For instance, in some cases, the object recommendation system 106 utilizes a background image displayed within a graphical user interface to receive bounding box input or spot input to indicate a location and/or scale for a foreground object image within a corresponding composite image. In some implementations, the object recommendation system 106 utilizes the bounding box input or spot input to determine a portion of the background with which retrieved foreground object images are to be compatible. In some embodiments, the object recommendation system 106 utilizes the background image to receive sketch input indicating a location, scale, and/or object class for a foreground object image. Further, in some instances, the object recommendation system 106 utilizes a text box displayed within the graphical user interface to receive text input providing text-based search parameters.

Additionally, as shown in FIG. 14, the front-end components 1402 include search components 1408a-1408b. In one or more embodiments, the object recommendation system 106 implements the search components 1408a-1408b via selectable options displayed within the graphical user interface of the client device. In some embodiments, the object recommendation system 106 utilizes the search components 1408a-1408b to indicate a type of search to execute in searching for and retrieving foreground object images. For instance, as indicated by FIG. 14, the object recommendation system 106 utilizes the search component 1408a to indicate a composite-aware search and the search component 1408b to indicate a sketch-based search. In other words, in response to receiving a user selection of one of the search components 1408a-1408b, the object recommendation system 106 executes the corresponding search in some cases.

As indicated in FIG. 14, the object recommendation system 106 associates each of the search components 1408a-1408b with one or more of the user interactions components 1406a-1406d. In other words, the object recommendation system 106 associates the type of search of each of the search components 1408a-1408b with one or more of the user interaction components 1406a-1406d. In particular, the object recommendation system 106 associates the search component 1408a with the user interaction components 1406a-1406c and associates the search component 1408b with the user interaction component 1406d. In some cases, the object recommendation system 106 utilizes the search components 1408a-1408b to enable one or more of the user interaction components 1406a-1406d. For instance, in some implementations, upon detecting a selection of the search component 1408b for a sketch-based search, the object recommendation system 106 enables sketch input to be received via the background image displayed within the graphical user interface. In some cases, the object recommendation system 106 provides further interactive elements (e.g., brush color options) for the sketch input in response to detecting the selection of the search component 1408b.

As further shown in FIG. 14, the front-end components 1402 include auto-composite components 1410a-1410c. In some cases, the object recommendation system 106 implements the auto-composite components 1410a-1410c via additional selectable options displayed within the graphical user interface of the client device. As will be discussed, in some embodiments, the object recommendation system 106 associates each of the auto-composite components 1410a-1410c with a different model of an auto-composite model.

As illustrated, the back-end components 1404 include a compositing-aware search engine 1412a, a text search engine 1412b, and an image search engine 1412c. The object recommendation system 106 utilizes each of the search engines to search through a digital image database 1414 for one or more foreground object images in accordance with received search input. In particular, in some cases, the object recommendation system 106 utilizes the search engines to conduct a search based on parameters provided by the search input (e.g., parameters indicated via interactions/selections received among the user interaction components 1406a-1406d and the search components 1408a-1408b).

As shown in FIG. 14, the object recommendation system 106 associates each of the search engines with one or more of the user interaction components 1406a-1406d (and at least one of the search components 1408a-1408b). Indeed, in some cases, the object recommendation system 106 executes a search via at least one of the search engines based on interactions with one or more associated user interaction components (and selections from among the respectively associated search component). In particular, the object recommendation system 106 executes a search via at least one search engine based on parameters provided by search input received via the one or more associated user interaction components (and the respectively associated search component).

For example, as shown in FIG. 14, the object recommendation system 106 associates the user interaction components 1406a-1406b with the compositing-aware search engine 1412a. Accordingly, the object recommendation system 106 utilizes the compositing-aware search engine 1412a to perform a search based on user interactions received via at least one of the user interaction components 1406a-1406b. To illustrate, in some cases, the object recommendation system 106 determines, based on a user interaction via one of the user interaction components 1406a-1406b, a portion of a background image for which retrieved foreground object images are to be compatible. Accordingly, the object recommendation system 106 utilizes the compositing-aware search engine 1412a to search for foreground object images based on the determined portion of the background image.

In some implementations, the object recommendation system 106 utilizes the compositing-aware search engine 1412a to conduct a search without receiving user interactions via one of the user interaction components 1406a-1406b. Accordingly, in some cases, the object recommendation system 106 utilizes the compositing-aware search engine 1412a to retrieve foreground object images based on the entirety of the background image or a prominent portion of the background image. In one or more embodiments, the object recommendation system 106 utilizes the geometry-lighting-aware neural network described above as the compositing-aware search engine 1412a.

In some cases, the object recommendation system 106 utilizes the text search engine 1412b in conjunction with another search engine. For instance, in some implementations, the object recommendation system 106 retrieves a set of foreground object images via the compositing-aware search engine 1412a and utilizes the text search engine 1412b as a filter in determining a subset of foreground object images from the retrieved set. To illustrate, in some embodiments, the object recommendation system 106 utilizes the text search engine 1412b as a filter to remove foreground object images that do not satisfy received text input. For instance, in some cases, the object recommendation system 106 determines that metadata or labels associated with a foreground object image does not satisfy the text input or that attributes determined for a foreground object image (e.g., determined via a classification neural network) does not satisfy the text input. In some implementations, the object recommendation system 106 utilizes the text search engine 1412b without using one of the other search engines. For example, in some cases, the object recommendation system 106 utilizes the text search engine 1412b to retrieve a plurality of foreground object images that satisfy received text input.

In some embodiments, the object recommendation system 106 utilizes, as the image search engine 1412c, the image search engine described in U.S. Pat. App. Ser. No. 17/809,494, filed on Jun. 28, 2022, entitled GENERATING UNIFIED EMBEDDINGS FROM MULTI-MODAL CANVAS INPUTS FOR IMAGE RETRIEVAL, which is incorporated herein by reference in its entirety. For instance, in some cases, the object recommendation system 106 utilizes one of the multi-modal embedding neural networks described therein as the image search engine 1412c.

To provide an example of searching for foreground object images, in some cases, the object recommendation system 106 receives a selection of one of the search components 1408a-1408b. Based on the selection, the object recommendation system 106 enables user input via one or more of the user interaction components 1406a-1406d (in some cases, the object recommendation system 106 always enables one or more of the user interaction components 1406a-1406d but uses the selection of one of the search components 1408a-1408b to indicate which user interaction components to use). The object recommendation system 106 further utilizes user input received via at least one of the user interaction components 1406a-1406d to execute a search for foreground object images using the appropriate search engine.

As further shown in FIG. 14, the back-end components 1404 include a plurality of image editing models. In particular, the back-end components 1404 includes a location prediction model 1416a, an instance segmentation model 1416b, a lighting estimation model 1416c, a scale prediction model 1416d, a harmonization model 1416e, and a shadow generation model 1416f The object recommendation system 106 utilizes one or more of the image editing models in generating a composite image or modifying a previously generated composite image. Indeed, in some cases, one or more of the image editing models shown in FIG. 14 are implemented separately from the auto-composite model implemented by the object recommendation system 106. In some implementations, however, one or more of the image editing models are included as part of the auto-composite model.

For example, as indicated in FIG. 14, the object recommendation system 106 associates the scale prediction model 1416d, the harmonization model 1416e, and the shadow generation model 1416f with one of the auto-composite components 1410a-1410c. In other words, upon detecting a selection of one of the auto-composite components 1410a-1410c, the object recommendation system 106 executes the auto-composite model (e.g., by executing the model associated with the selected auto-composite component) in generating (or modifying) a composite image.

In one or more embodiments, the object recommendation system 106 utilizes the location prediction model 1416a to determine a recommended location for a foreground object image as described above with reference to FIGS. 6A-6C. Likewise, in some embodiments, the object recommendation system 106 utilizes the scale prediction model 1416d to determine a recommended scale for a foreground object image as described above. In some cases, the object recommendation system 106 utilizes, as the instance segmentation model 1416b, the segmentation refinement neural network described in U.S. Pat. app. Ser. No. 17/200,525, filed on Mar. 21, 2021, entitled GENERATING REFINED SEGMENTATION MASKS VIA METICULOUS OBJECT SEGMENTATION, which is incorporated herein by reference in its entirety. In one or more embodiments, the object recommendation system 106 utilizes, as the harmonization model 1416e, the image harmonization neural network described in U.S. Pat. app. Ser. No. 17/809,494. In some cases, the object recommendation system 106 utilizes, as the shadow generation model 1416f, the height-based shadowing system described in U.S. Pat. app. Ser. No. 17/502,782, filed on Oct. 15, 2021, entitled GENERATING SHADOWS FOR DIGITAL OBJECTS WITHIN DIGITAL IMAGES UTILIZING A HEIGHT MAP, which is incorporated herein by reference in its entirety. In one or more embodiments, the object recommendation system 106 utilizes, as the lighting estimation model 1416c, the lighting estimation system described in U.S. Pat. No. 10,957,026, issued on Mar. 23, 2021, entitled LEARNING FROM ESTIMATED HIGH-DYNAMIC RANGE ALL WEATHER LIGHTING PARAMETERS, which is incorporated herein by reference in its entirety.

Thus, in one or more embodiments, the object recommendation system 106 receives one or more user interactions via the front-end components 1402 and performs corresponding actions via the back-end components 1404. For instance, in some cases, the object recommendation system 106 executes a search for foreground object images utilizing one of the search engines based on user interactions with the user interaction components 1406a-1406d and the search components 1408a-1408b. Further, in some instances, the object recommendation system 106 generates or modifies a composite image utilizing the auto-composite model (e.g., one or more of the scale prediction model 1416d, the harmonization model 1416e, or the shadow generation model 1416f) based on user interactions with the auto-composite components 1410a-1410c and/or other user input.

In some cases, the object recommendation system 106 executes one or more of the other models shown in FIG. 14 (e.g., the location prediction model 1416a, the instance segmentation model 1416b, or the lighting estimation model 1416c) in response to received user input (or a lack of received user input) as will be discussed more below. In some cases, the object recommendation system 106 executes one of the other models automatically in generating a composite image. In some instance, the object recommendation system 106 executes one of the other models in support of a model executed in response to a selection of an auto-composite component. For example, in some cases, the object recommendation system 106 utilizes the shadow generation model 1416f to estimate the light source and/or other lighting characteristics of a background image for shadow generation via the shadow generation model 1416f

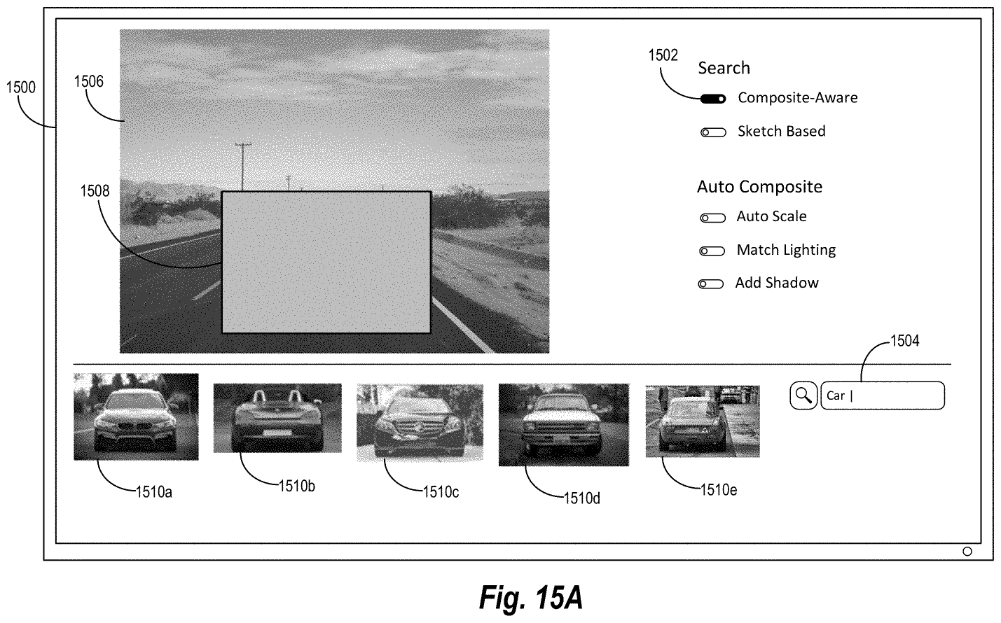

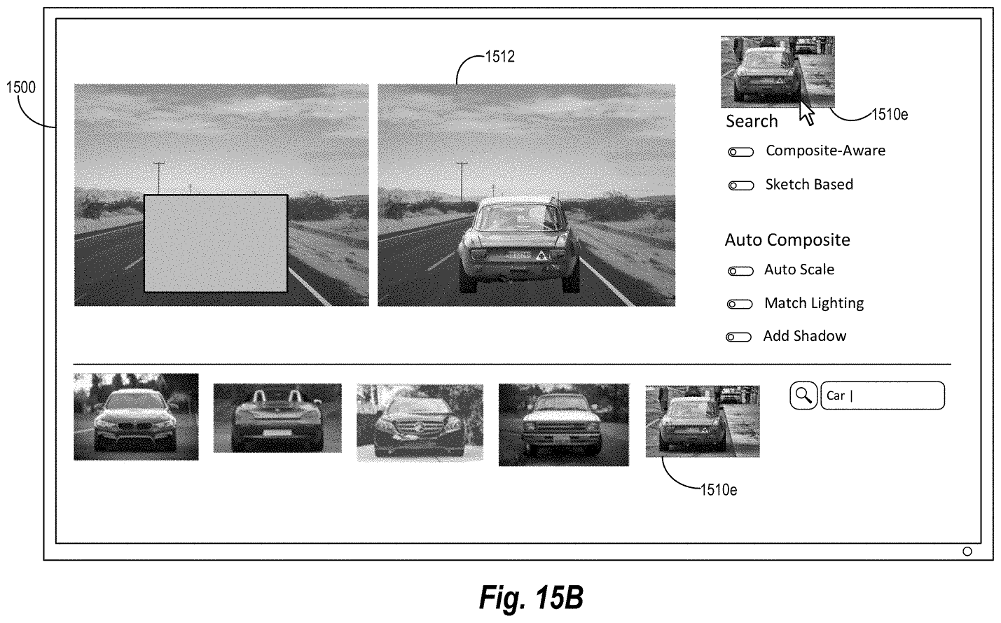

As previously suggested, the object recommendation system 106 implements a compositing pipeline based on various user interactions with a graphical user interface. For example, in some cases, the object recommendation system 106 executes a search based on various search input (e.g., search input indicating a type of search and/or parameters for the search). Further, in some embodiments, the object recommendation system 106 generates or modifies a composite image based on various editing input (e.g., input indicating how to execute an auto-composite model). FIGS. 15A-19 illustrate the object recommendation system 106 executing searches and generating/modifying composite images based on various user interactions with a graphical user interface in accordance with one or more embodiments.

For instance, FIGS. 15A-15B illustrate a graphical user interface 1500 used by the object recommendation system 106 to generate a composite image utilizing a foreground object image retrieved via a composite-aware search in accordance with one or more embodiments. As shown in FIG. 15A, the object recommendation system 106 receives, via the graphical user interface 1500, a user selection of a selectable option 1502 indicating that a composite-aware search is to be executed (e.g., using a compositing-aware search engine). Further, the object recommendation system 106 receives, via a text box 1504, text input to be used in the search (e.g., via a text search engine).

As further shown in FIG. 15A, the object recommendation system 106 also receives a user interaction with a background image 1506 displayed within the graphical user interface 1500. In particular, the object recommendation system 106 receives bounding box input 1508 via the user interaction with the background image 1506. In one or more embodiments, the object recommendation system 106 utilizes the bounding box input 1508 as an indication of location and scale for the foreground object image within the resulting composite image. In some embodiments, the object recommendation system 106 utilizes the bounding box input 1508 as an indication of scale for foreground object images to be retrieved via the search. In some implementations, the object recommendation system 106 utilizes the bounding box input 1508 as a designation of a portion of the background image 1506 for which retrieved foreground object images are to be compatible.

In response to receiving the search input, the object recommendation system 106 searches for and retrieves one or more foreground object images utilizing the corresponding search engine(s). Indeed, as shown in FIG. 15A, the object recommendation system 106 provides foreground object images 1510a-1510e for display within the graphical user interface 1500 as search results. As illustrated, each of the foreground object images 1510a-1510e are compatible for compositing with the background image 1506. For instance, the orientation of the car displayed in each of the foreground object images 1510a-1510e matches an orientation of the road displayed in the background image 1506. Thus, the geometries of the foreground object images 1510a-1510e and the background image 1506 are compatible.

As shown in FIG. 15B, the object recommendation system 106 responds to a selection of one of the search results. In particular, as shown, the object recommendation system 106 detects a selection of the foreground object image 1510e. As indicated, in response to detecting the selection, the object recommendation system 106 provides the foreground object image 1510e within a portion of the graphical user interface 1500 that is separate from the search results to indicate its selection (e.g., the upper right-hand corner of the graphical user interface 1500 as shown). Further, as indicated, in response to receiving a user interaction with the foreground object image 1510e within the separate portion, the object recommendation system 106 generates a composite image 1512 and provides the composite image 1512 for display within the graphical user interface 1500. Though FIG. 15B indicates generation of the composite image 1512 in response to multiple interactions with the foreground object image 1510e, the object recommendation system 106 generates the composite image 1512 upon selection of the foreground object image 1510e from the search results in some implementations.

As illustrated in FIG. 15B, the object recommendation system 106 generates the composite image 1512 by positioning the foreground object image 1510e (e.g., the foreground object portrayed within the foreground object image) at the location indicated by the bounding box input 1508. Further, the foreground object image 1510e (e.g., the portrayed foreground object) includes a scale within the composite image 1512 in accordance with the bounding box input 1508. In some embodiments, the foreground object image 1510e already includes this scale when retrieved. In other words, as previously suggested, the object recommendation system 106 executes the search to retrieve foreground object images based on a scale provided by the search input in some instances. Accordingly, the search results include foreground object images that are compatible with the scale. In some implementations, however, the object recommendation system 106 adjusts the scale of the foreground object image 1510e when generating the composite image 1512 to match the scale indicated by the bounding box input 1508.

As previously mentioned, in one or more embodiments, a foreground object image includes a digital image portraying a foreground object. Thus, it should be noted that description of positioning a foreground object image within a composite image, re-sizing a foreground object image within a composite image, or performing some other action with respect to a foreground object image within a composite image refers to performing that action with respect to the foreground object portrayed by the foreground object image in some implementations.

Indeed, in some embodiments, a foreground object image portrays a foreground object image against a background. Accordingly, the object recommendation system 106 separates the foreground object from the background via segmentation. In particular, as suggested above with reference to FIG. 14, the object recommendation system 106 utilizes an instance segmentation model in some embodiments to segment a foreground object portrayed in a foreground object image. Thus, the object recommendation system 106 utilizes the segmented foreground object in generating a composite image and modifies the foreground object and/or performs other actions with respect to the foreground object in generating the composite image.

Thus, as indicated by FIGS. 15A-15B, the object recommendation system 106 receives a small set of user interactions with the graphical user interface 1500 that indicate search input. The object recommendation system 106 responds to this set of user interactions by searching for foreground object images that are compatible with the background image 1506 for compositing. Accordingly, the object recommendation system 106 reduces the amount of user interactions typically needed under conventional systems to adjust various aspects (e.g., the orientation) of the foreground object image so that it appears natural within the result composite image.

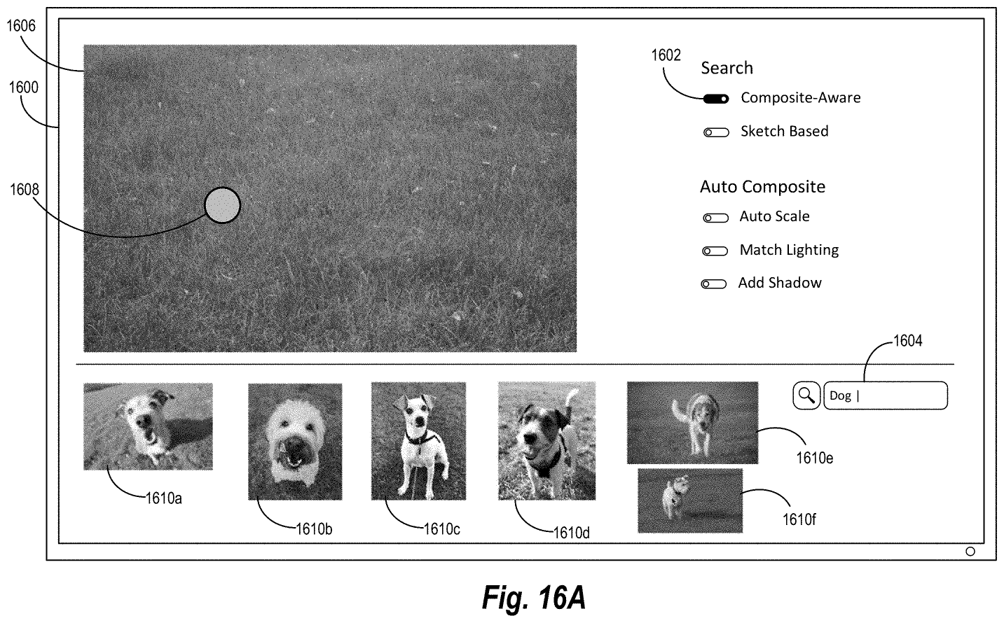

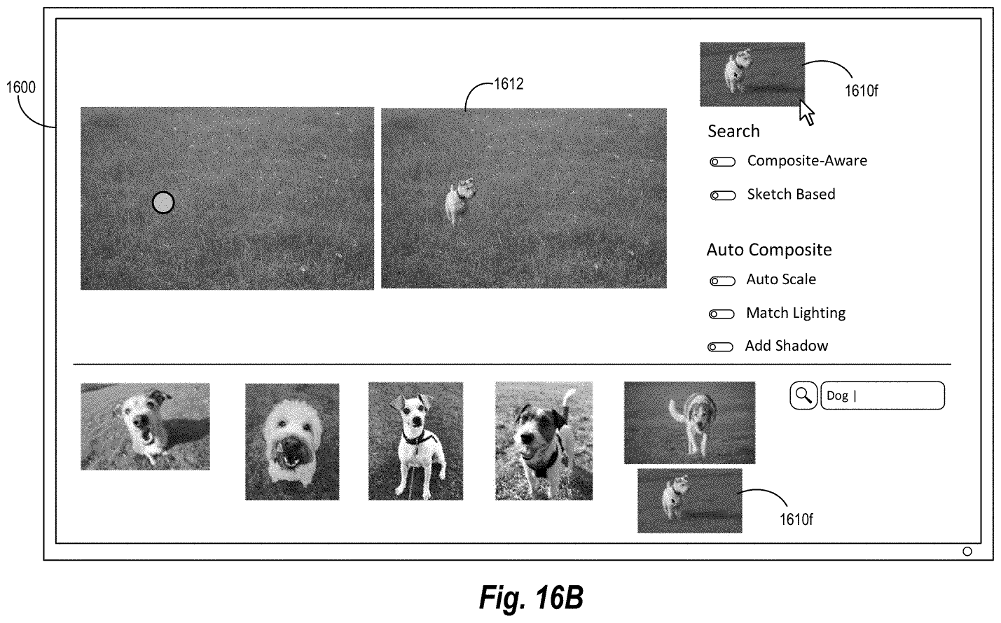

FIGS. 16A-16B illustrate another graphical user interface 1600 used by the object recommendation system 106 to generate a composite image utilizing a foreground object image retrieved via a composite-aware search in accordance with one or more embodiments. As shown in FIG. 16A, the object recommendation system 106 receives, via the graphical user interface 1600, a user selection of a selectable option 1602 indicating that a composite-aware search is to be executed. Further, the object recommendation system 106 receives, via a text box 1604, text input to be used in the search.

As further shown in FIG. 16A, the object recommendation system 106 also receives a user interaction with a background image 1606 displayed within the graphical user interface 1600. In particular, the object recommendation system 106 receives spot input 1608 via the user interaction with the background image 1606. In one or more embodiments, the object recommendation system 106 utilizes the spot input 1608 as an indication of location for the foreground object image within the resulting composite image. In some implementations, the object recommendation system 106 utilizes the spot input 1608 as a designation of a portion of the background image 1606 for which retrieved foreground object images are to be compatible.

In response to receiving the search input, the object recommendation system 106 searches for and retrieves one or more foreground object images utilizing the corresponding search engine(s). Indeed, as shown in FIG. 16A, the object recommendation system 106 provides foreground object images 1610a-1610f for display within the graphical user interface 1600 as search results. As illustrated, each of the foreground object images 1610a-1610f are compatible for compositing with the background image 1606.

As shown in FIG. 16B, the object recommendation system 106 responds to a selection of the foreground object image 1610f and generates a composite image 1612 accordingly. Further, the object recommendation system 106 provides the composite image 1612 for display in the graphical user interface 1600. As illustrated, the object recommendation system 106 positions the foreground object image 1610f (e.g., the portrayed foreground object) within the composite image 1612 at the location indicated by the spot input 1608. In some embodiments, as a scale for the foreground object image 1610f was not indicated, the object recommendation system 106 utilizes a default scale in generating the composite image 1612. In some instances, however, the object recommendation system 106 utilizes a recommended scale (e.g., determined via a scale prediction model).

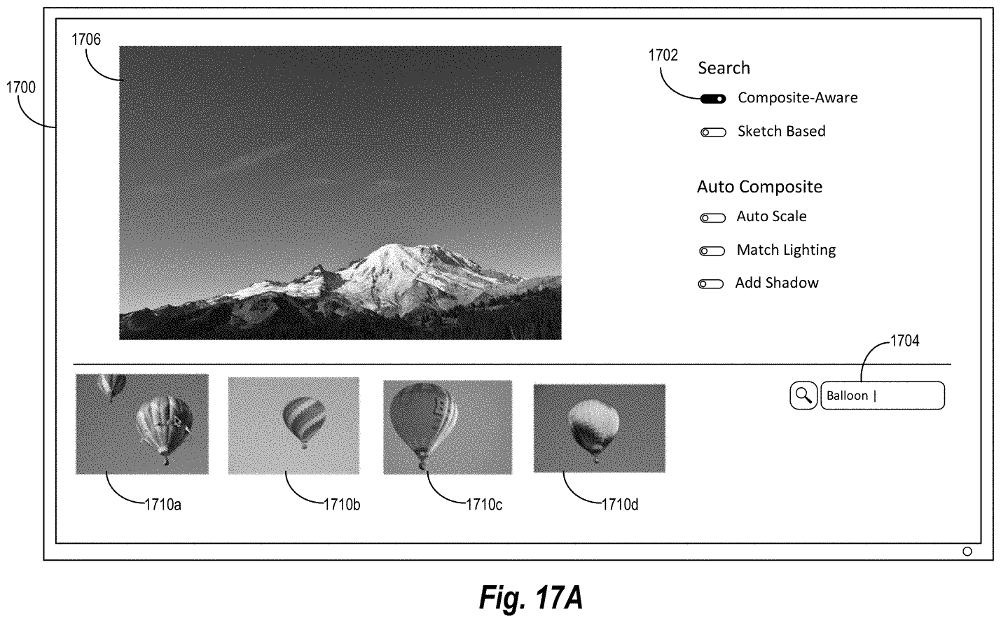

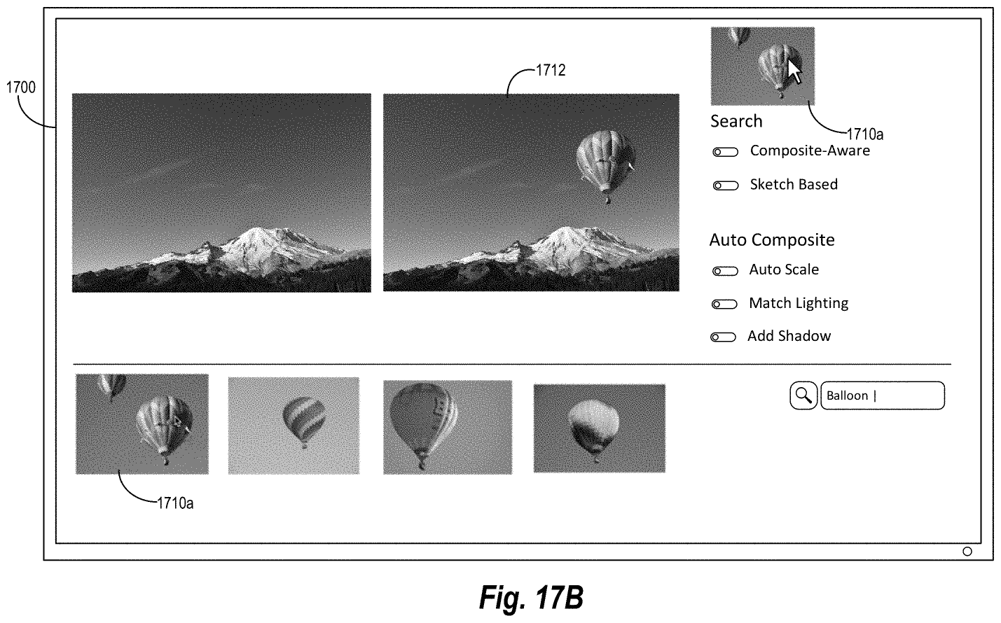

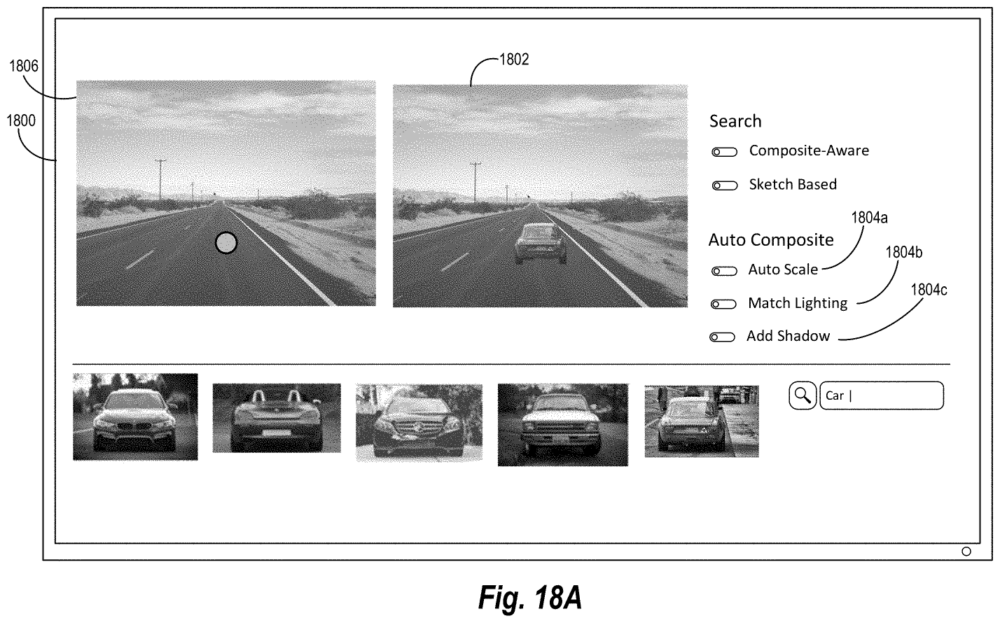

FIGS. 17A-17B illustrate yet another graphical user interface 1700 used by the object recommendation system 106 to generate a composite image utilizing a foreground object image retrieved via a composite-aware search in accordance with one or more embodiments. As shown in FIG. 17A, the object recommendation system 106 receives, via the graphical user interface 1700, a user selection of a selectable option 1702 indicating that a composite-aware search is to be executed. Further, the object recommendation system 106 receives, via a text box 1704, text input to be used in the search. In contrast with the discussion of FIGS. 15A-16B, the object recommendation system 106 does not receive a user interaction with the background image 1706 displayed in the graphical user interface 1700 indicating scale and/or location.

In response to receiving the search input, the object recommendation system 106 searches for and retrieves one or more foreground object images utilizing the corresponding search engine(s). Indeed, as shown in FIG. 17A, the object recommendation system 106 provides foreground object images 1710a-1710d for display within the graphical user interface 1700 as search results. As illustrated, each of the foreground object images 1710a-1710d are compatible for compositing with the background image 1706.

As shown in FIG. 17B, the object recommendation system 106 responds to a selection of the foreground object image 1710a and generates a composite image 1712 accordingly. Further, the object recommendation system 106 provides the composite image 1712 for display in the graphical user interface 1700. As illustrated, the object recommendation system 106 generates the composite image 1712 using a recommended location and a recommended scale for the foreground object image 1710a. Indeed, in one or more embodiments, where neither location nor scale is received, the object recommendation system 106 determines and recommends a location and/or a scale—e.g., using a location prediction model and/or a scale prediction model, respectively—for a selected foreground object image. For instance, in some cases, the object recommendation system 106 determines a recommended scale and/or a recommended location as described above with reference to FIGS. 6A-6C.

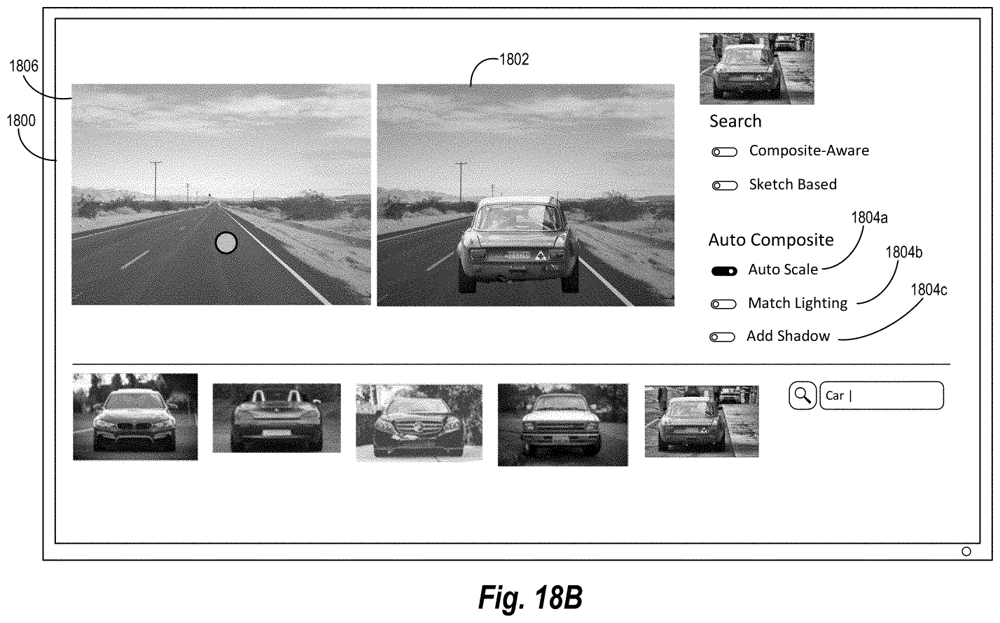

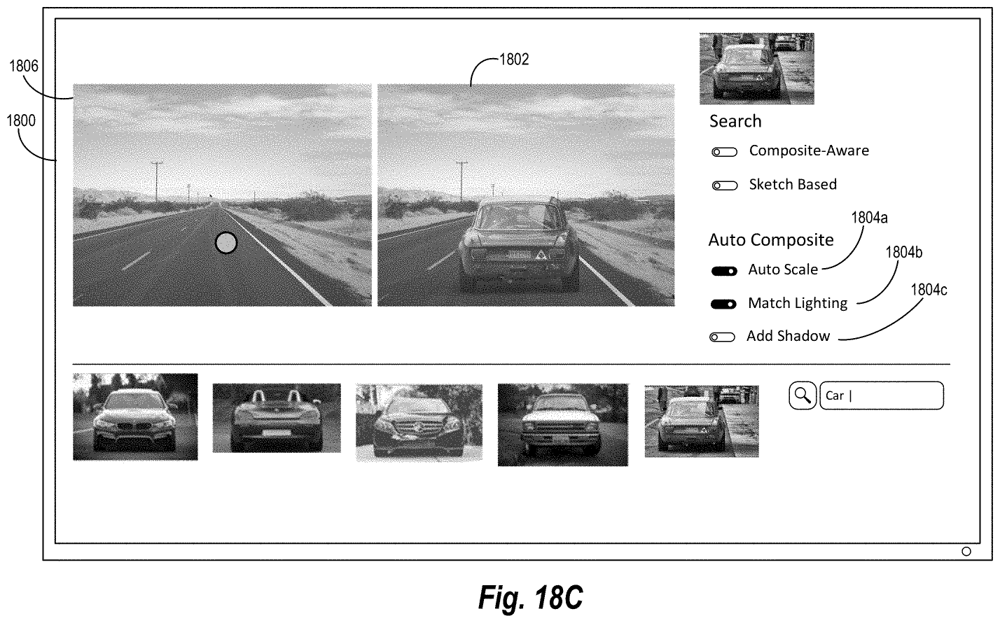

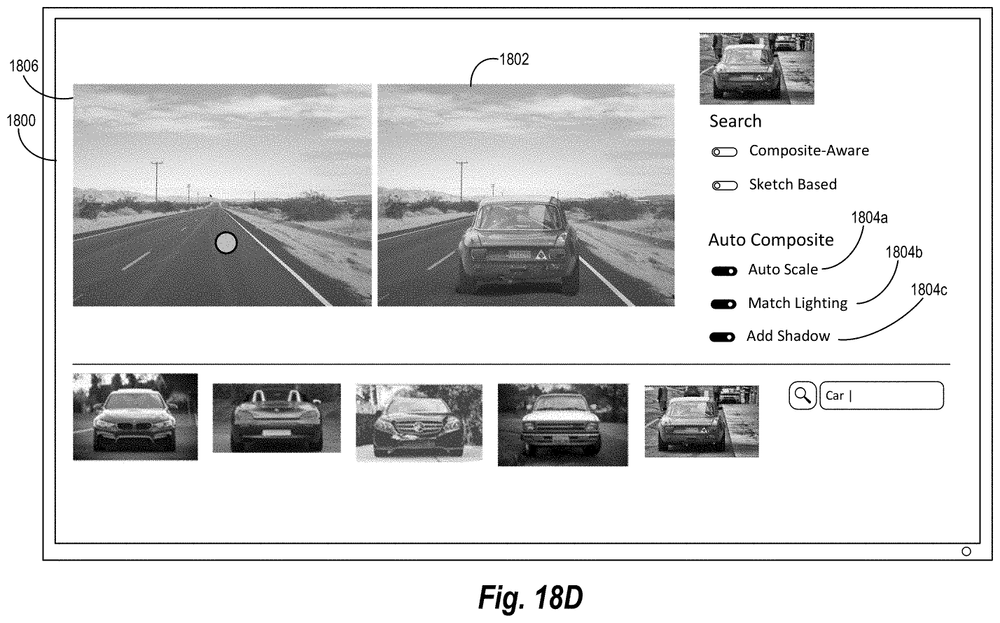

FIGS. 18A-18D illustrate a graphical user interface 1800 used by the object recommendation system 106 to generate a composite image by executing an auto-composite model in accordance with one or more embodiments. As shown in FIG. 18A, the object recommendation system 106 generates a composite image 1802 and provides the composite image 1802 for display within a graphical user interface 1800. Indeed, as previously suggested, in one or more embodiments, the object recommendation system 106 generates a composite image using an auto-composite model. In some implementations, however, the object recommendation system 106 modifies a previously generated composite image using the auto-composite model. To illustrate, in one or more embodiments, the object recommendation system 106 generates an initial composite image and modifies the initial composite image via the auto-composite model to provide a compositing result (e.g., a final composite image).

In some cases, the object recommendation system 106 generates or modifies a composite image using the auto-composite model based on the order of user interactions. For instance, in some embodiments, where options for the auto-composite model are selected before the composite image is generated, the object recommendation system 106 executes the auto-composite model in generating the composite image. In contrast, where options for the auto-composite model are selected after the composite image is generated, the object recommendation system 106 executes the auto-composite model in modifying the composite image.

As shown in FIG. 18A, the composite image 1802 has an unrealistic appearance. In particular, the foreground object image appears unnatural within the composite image 1802. Accordingly, in some cases, the object recommendation system 106 utilizes the auto-composite model to provide a more realistic appearance. Indeed, as shown in FIG. 18A, the object recommendation system 106 provides selectable options 1804a-1804c for utilizing the auto-composite model.

For instance, as shown in FIG. 18B, the object recommendation system 106 receives a selection of the selectable option 1804a via the graphical user interface 1800. In response to the selection, the object recommendation system 106 utilizes the auto-composite model to adjust the size of the foreground object image within the composite image 1802. In particular, the object recommendation system 106 executes a scale prediction model of the auto-composite model to modify the scale of the foreground object image within the composite image 1802 based on a scale of the background image 1806.

Additionally, as shown in FIG. 18C, the object recommendation system 106 receives a selection of the selectable option 1804b via the graphical user interface 1800. In response to the selection, the object recommendation system 106 utilizes the auto-composite model to adjust the lighting of the foreground object image within the composite image 1802. In particular, the object recommendation system 106 executes a harmonization model of the auto-composite model to modify the lighting of the foreground object image within the composite image 1802 based on a lighting of the background image 1806.

Further, as shown in FIG. 18D, the object recommendation system 106 receives a selection of the selectable option 1804c via the graphical user interface 1800. In response to the selection, the object recommendation system 106 utilizes the auto-composite model to generate a shadow for the foreground object image within the composite image 1802. In particular, the object recommendation system 106 executes a shadow generation model of the auto-composite model to generate the shadow for foreground object image. In some cases, the object recommendation system 106 further utilizes a lighting estimation model to determine a light source and/or other lighting characteristics of the background image 1806 for use in generating the shadow within the composite image 1802.

Though FIGS. 18A-18D illustrate a particular order of executing components of the auto-composite model, it should be understood that the object recommendation system 106 executes the components in various orders in various embodiments. Further, the object recommendation system 106 executes various combinations of components in various embodiments. Indeed, the object recommendation system 106 executes the components of the auto-composite model in response to user interactions received via the graphical user interface 1800.

Thus, with a simple user interaction received via the graphical user interface 1800, the object recommendation system 106 executes the auto-composite model in generating a composite result (e.g., either by generating a composite image or modifying a previously generated composite image). As such, the object recommendation system 106 operates more efficiently when compared to many conventional systems. Indeed, while conventional systems typically require a series of user interactions to perform a single action—such as adjusting the lighting or scale of a foreground object image—the object recommendation system 106 can consolidate these user interactions to a single click that triggers back-end processing. By responding to user interactions with computer-implemented models via the back-end processing, the object recommendation system 106 provides more realistic images when compared to conventional systems. Indeed, by using computer-implemented models in generating or modifying a composite image, the object recommendation system 106 avoids the user error that typically results from the manual processes required under many conventional systems.

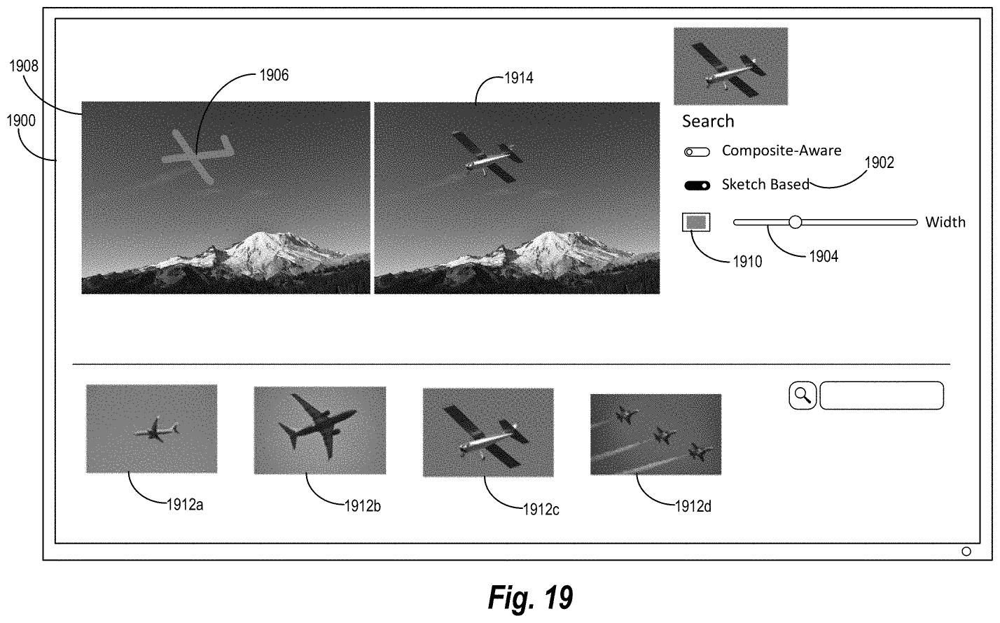

FIG. 19 illustrates a graphical user interface 1900 used by the object recommendation system 106 to generate a composite image utilizing a foreground object image retrieved via a sketch-based search in accordance with one or more embodiments. As shown in FIG. 19, the object recommendation system 106 receives, via the graphical user interface 1900, a user selection of a selectable option 1902 indicating that a sketch-based search is to be executed (e.g., using an image search engine). As further shown, the object recommendation system 106 receives sketch input 1906. In particular, the object recommendation system 106 receives the sketch input 1906 via one or more user interactions with the background image 1908 displayed within the graphical user interface 1900.

In one or more embodiments, sketch input includes drawing input. In particular, in some embodiments, sketch input includes input created via one or more user interactions with an interactive canvas using at least one drawing tool. Though FIG. 19 shows the sketch input 1906 received via user interactions with a background image, the object recommendation system 106 receives sketch input via user interactions with a different canvas, such as a blank canvas, in some embodiments. Further, the drawing tool(s) used to create the sketch input varies in different embodiments. In some embodiments, the drawing tool(s) is configurable. Indeed, as shown in FIG. 19, the object recommendation system 106 provides a configuration option 1910 for selecting a color for the drawing tool and a configuration option 1904 for selecting a width of the drawing tool (e.g., a width of the brush strokes or lines created by the drawing tool).

In response to receiving the search input, the object recommendation system 106 searches for and retrieves one or more foreground object images utilizing the corresponding search engine(s). In particular, as mentioned, the object recommendation system 106 executes a search via an image search engine using sketch input. In one or more embodiments, the object recommendation system 106 executes the search by managing the background image 1908 with the sketch input 1906 as an input digital image to the image engine. In other words, the object recommendation system 106 handles the background image 1908 with the sketch input 1906 as its own digital image. As shown in FIG. 19, the object recommendation system 106 provides foreground object images 1912a-1912d for display within the graphical user interface 1900 as search results.

In some cases, the object recommendation system 106 determines an object class of the sketch input 1906 and utilizes the object class in narrowing the search. For instance, in some cases, the object recommendation system 106 determines the object class via a classification neural network. In some implementations, however, the image search engine searches for results corresponding to the sketch input 1906 without explicitly determining the object class (e.g., using embeddings that implicitly encode the object class or object features such as shape, color, etc.).

As further shown in FIG. 19, based on a selection of the foreground object image 1912c from the search results, the object recommendation system 106 generates a composite image 1914. As indicated, the object recommendation system 106 generates the composite image 1914 using a position and scale for the foreground object image 1912c indicated by the sketch input 1906.

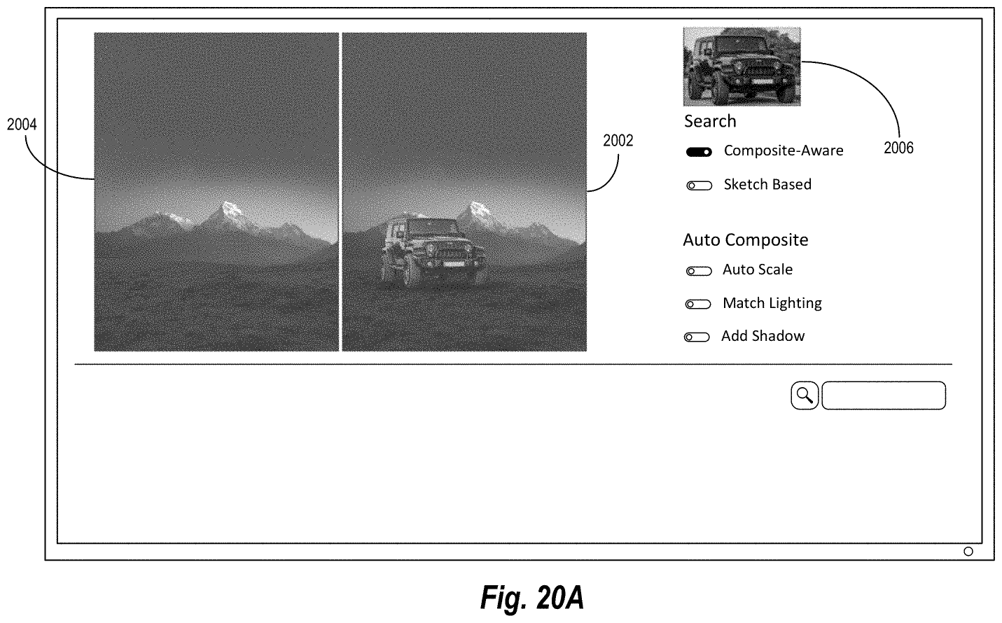

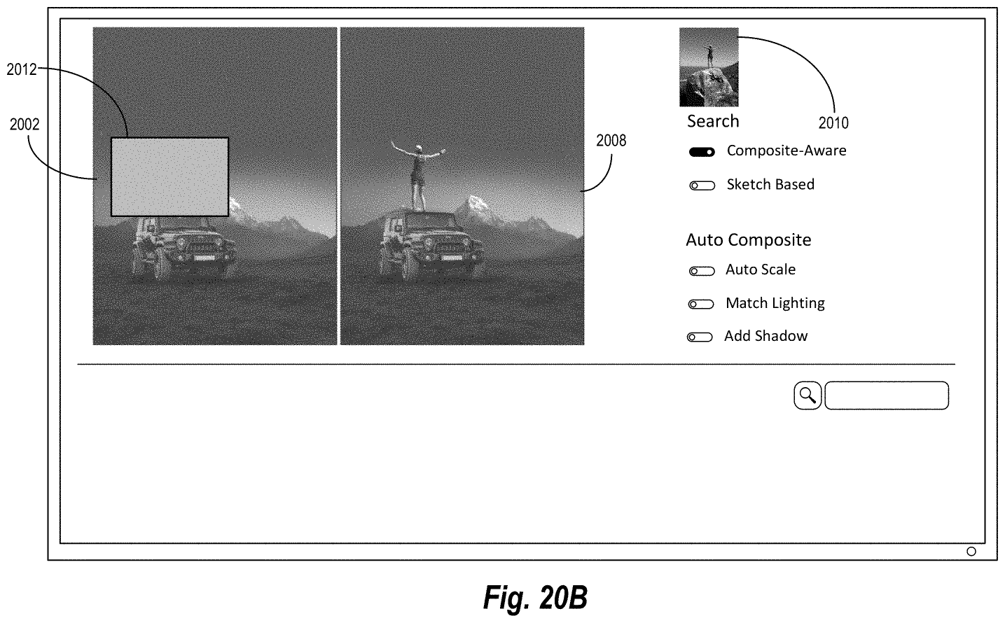

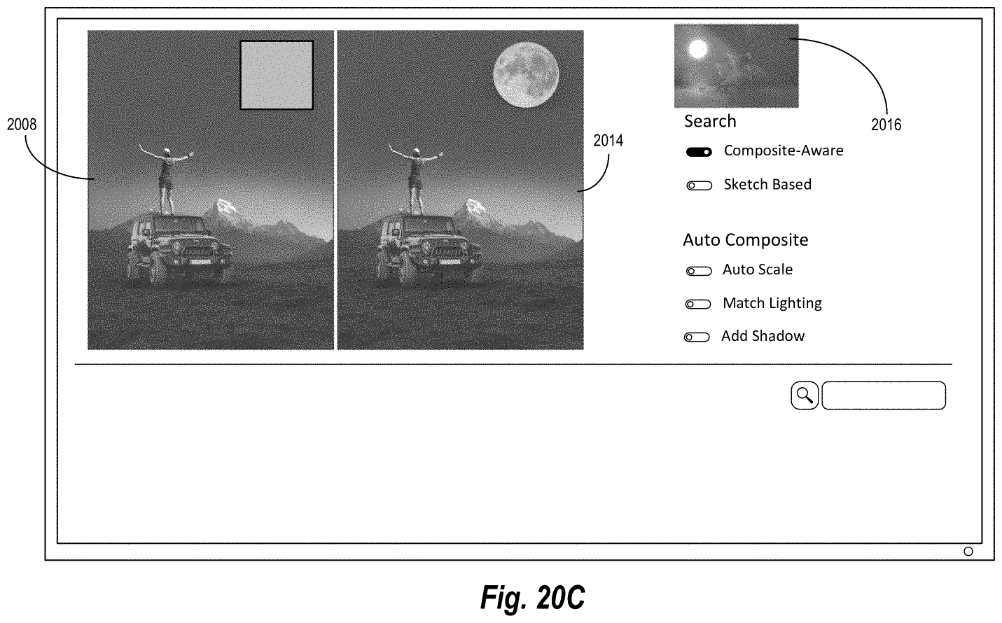

In some cases, the object recommendation system 106 utilizes a previously generated composite image to generate an additional composite image. FIGS. 20A-20C illustrate the object recommendation system 106 generating a composite image utilizing a previously generated composite image in accordance with one or more embodiments.

Indeed, as shown in FIG. 20A, the object recommendation system 106 generates a first composite image 2002 using a background image 2004 and a first foreground object image 2006. Further, as shown in FIG. 20B, the object recommendation system 106 generates a second composite image 2008 using the first composite image 2002 and a second foreground object image 2010. In particular, as shown, the object recommendation system 106 generates the second composite image 2008 in accordance with a bounding box input 2012 received within the first composite image 2002. In some implementations, however, the object recommendation system 106 generates the second composite image 2008 using a recommended location and/or a recommended scale for the second foreground object image 2010. As further shown in FIG. 20C, the object recommendation system 106 generates a third composite image 2014 using the second composite image 2008 and a third foreground object image 2016.

Thus, in one or more embodiments, the object recommendation system 106 manages a previously generated composite image as a background image when using the previously generated composite image to generate a subsequent composite image. Though not shown in FIGS. 20A-20C, in one or more embodiments, the object recommendation system 106 utilizes a previously generated composite image for conducting a composite-aware search for producing a subsequent composite image. Indeed, in some cases, the object recommendation system 106 utilizes a compositing-aware search engine to retrieve one or more foreground object images that are compatible with the previously generated composite image for use in subsequent image composition.

Turning now to FIG. 21, additional detail will now be provided regarding various components and capabilities of the object recommendation system 106. In particular, FIG. 21 illustrates the object recommendation system 106 implemented by the computing device 2100 (e.g., the server(s) 102 and/or one of the client devices 110a-110n discussed above with reference to FIG. 1). Additionally, the object recommendation system 106 is also part of the image editing system 104. As shown in FIG. 21, the object recommendation system 106 includes, but is not limited to, a graphical user interface manager 2102, a search manager 2104, a composite image generator 2106, an auto-composite model application manager 2108, and data storage 2110 (which includes an auto-composite model 2112, a composite object search engine 2114, and foreground object images 2116).

As just mentioned, and as illustrated in FIG. 21, the object recommendation system 106 includes the graphical user interface manager 2102. In one or more embodiments, the graphical user interface manager 2102 manages the graphical user interface of a client device implementing or communicating with the object recommendation system 106. For instance, in some embodiments, the graphical user interface manager 2102 provides a graphical user interface for display on the client device. In some cases, the graphical user interface manager 2102 further provides various graphical elements for display within the graphical user interface. In some implementations, one or more of the graphical elements include interactive elements, such as selectable options or a text box. In some instances, the graphical user interface manager 2102 further detects and interprets user interactions received via the graphical user interface.

Additionally, as shown in FIG. 21, the object recommendation system 106 includes the search manager 2104. In one or more embodiments, the search manager 2104 executes searches for foreground object images. In particular, in some embodiments, the search manager 2104 implements one or more search engines to search for foreground object images for use in generating a composite image. For example, in some cases, the search manager 2104 utilizes one or more search engines to conduct a composite-aware search. In some implementations, the search manager 2104 utilizes one or more search engines to conduct a sketch-based search. Accordingly, in some instances, the search manager 2104 provides one or more foreground object images as search results.

Further, as shown in FIG. 21, the object recommendation system 106 also includes the composite image generator 2106. In one or more embodiments, the composite image generator 2106 generates a composite image from a background image and a foreground object image. For instance, in some embodiments, the composite image generator 2106 generates a composite image using a foreground object image selected from search results retrieved via one or more search engines. In some cases, the composite image generator 2106 generates the composite image using a recommended location and/or a recommended scale for the foreground object image.

As shown in FIG. 21, the object recommendation system 106 also includes the auto-composite model application manager 2108. In one or more embodiments, the auto-composite model application manager 2108 executes an auto-composite model to generate or modify a composite image. For instance, in some cases, the auto-composite model application manager 2108 executes a scale prediction model, a harmonization model, and/or a shadow generation model. In some cases, the auto-composite model application manager 2108 executes additional or alternative models such as a lighting estimation model.

Additionally, as shown, the object recommendation system 106 includes data storage 2110. In particular, data storage 2110 (implemented by one or more memory devices) includes auto-composite model 2112, the composite object search engine 2114, and the foreground object images 2116. In one or more embodiments, the auto-composite model 2112 stores the auto-composite model using in generating or modifying composite images. In particular, in some cases, the auto-composite model 2112 stores various components of the auto-composite model, such as the scale prediction model, the harmonization model, and/or the shadow generation model. In some instances, the composite object search engine 2114 stores the composite object search engine used in retrieving foreground object images. In particular, in some implementations, the composite object search engine 2114 stores various component search engines, such as a compositing-aware search engine, a text search engine, and/or an image search engine. In some embodiments, the foreground object images 2116 stores foreground object images accessed via search for one or more foreground object images for image compositing.

Each of the components 2102-2116 of the object recommendation system 106 can include software, hardware, or both. For example, the components 2102-2116 can include one or more instructions stored on a computer-readable storage medium and executable by processors of one or more computing devices, such as a client device or server device. When executed by the one or more processors, the computer-executable instructions of the object recommendation system 106 can cause the computing device(s) to perform the methods described herein. Alternatively, the components 2102-2116 can include hardware, such as a special-purpose processing device to perform a certain function or group of functions. Alternatively, the components 2102-2116 of the object recommendation system 106 can include a combination of computer-executable instructions and hardware.

Furthermore, the components 2102-2116 of the object recommendation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 2102-2116 of the object recommendation system 106 may be implemented as a stand-alone application, such as a desktop or mobile application. Furthermore, the components 2102-2116 of the object recommendation system 106 may be implemented as one or more web-based applications hosted on a remote server. Alternatively, or additionally, the components 2102-2116 of the object recommendation system 106 may be implemented in a suite of mobile device applications or “apps.” For example, in one or more embodiments, the object recommendation system 106 can comprise or operate in connection with digital software applications such as ADOBE® PHOTOSHOP® or ADOBE® CAPTURE. The foregoing are either registered trademarks or trademarks of Adobe Inc. in the United States and/or other countries.

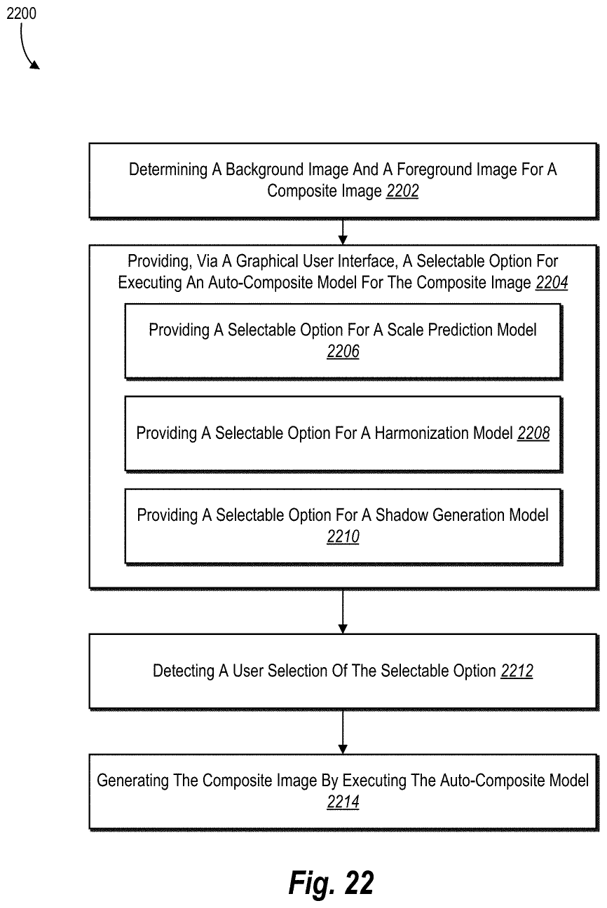

FIGS. 1-21, the corresponding text, and the examples provide a number of different methods, systems, devices, and non-transitory computer-readable media of the object recommendation system 106. In addition to the foregoing, one or more embodiments can also be in FIG. 22. FIG. 22 may be performed with more or fewer acts. Further, the acts may be performed in different orders. Additionally, the acts described herein may be repeated or performed in parallel with one another or in parallel with different instances of the same or similar acts.

FIG. 22 illustrates a flowchart of a series of acts 2200 for generating a composite image using an auto-composite model selected via a graphical user interface in accordance with one or more embodiments. FIG. 22 illustrates acts according to one embodiment, alternative embodiments may omit, add to, reorder, and/or modify any of the acts shown in FIG. 22. In some implementations, the acts of FIG. 22 are performed as part of a computer-implemented method. Alternatively, a non-transitory computer-readable medium can store instructions thereon that, when executed by at least one processor, cause the at least one processor to perform operations comprising the acts of FIG. 22. In some embodiments, a system performs the acts of FIG. 22. For example, in one or more embodiments, a system includes one or more memory devices comprising a background image, a composite object search engine, and an auto-composite model comprising at least one of a scale prediction model, a harmonization model, or a shadow generation model. The system further includes one or more processors configured to cause the system to perform the acts of FIG. 22.

The series of acts 2200 includes an act 2202 for determining a background image and a foreground object image for a composite image. For example, in one or more embodiments, the act 2202 involves determining a background image and a foreground object image for use in generating a composite image.

In one or more embodiments, determining the foreground object image for use in generating a composite image comprises: receiving, via the graphical user interface, search input for performing a composite-aware search to retrieve one or more foreground object images based on a compatibility with the background image; and performing the composite-aware search to determine the foreground object image utilizing a composite object search engine. In some embodiments, the object recommendation system 106 provides the background image for display via the graphical user interface. Accordingly, in some instances, receiving, via the graphical user interface, the search input comprises receiving, via the graphical user interface, an additional user selection of a location within the background image for positioning the foreground object image. In some implementations, receiving, via the graphical user interface, the search input comprises receiving, via the graphical user interface, user input within the background image indicating a scale for the foreground object image. In some cases, the user selection of the location and the user input indicating the scale correspond to a query bounding box received within the background image via one or more user interactions

The series of acts 2200 also includes an act 2204 for providing, via a graphical user interface, a selectable option for executing an auto-composite model for the composite image. In particular, in one or more embodiments, the act 2204 involves providing, for display within a graphical user interface of a client device, at least one selectable option for executing an auto-composite model for the composite image.

In one or more embodiments, the auto-composite model comprising at least one of a scale prediction model, a harmonization model, or a shadow generation model. Indeed, as shown in FIG. 22, the act 2204 includes a sub-act 2206 for providing a selectable option for a scale prediction model. The act 2204 also includes a sub-act 2208 for providing a selectable option for a harmonization model. Further, the act 2204 includes a sub-act 2210 for providing a selectable option for a shadow generation model.

Additionally, the series of acts 2200 includes an act 2212 for detecting a user selection of the selectable option. For instance, in some cases, the act 2212 involves detecting, via the graphical user interface, a user selection of the at least one selectable option.

In one or more embodiments, detecting the user selection of the at least one selectable option comprises detecting a user selection of a selectable option for executing the scale prediction model. In some embodiments, detecting the user selection of the at least one selectable option comprises detecting a user selection a selectable option for executing the harmonization model. In some cases, detecting the user selection of the at least one selectable option comprises detecting a user selection of a selectable option for executing the shadow generation model.

Further, the series of acts 2200 includes an act 2214 for generating the composite image by executing the auto-composite model. To illustrate, in some implementations, the act 2214 involves generating, in response to detecting the user selection, the composite image by executing the auto-composite model using the background image and the foreground object image.

In one or more embodiments, executing the auto-composite model using the background image and the foreground object image comprises modifying, utilizing the scale prediction model, a scale of the foreground object image within the composite image based on a scale of the background image. In some embodiments, executing the auto-composite model using the background image and the foreground object image comprises modifying, utilizing the harmonization model, a lighting of the foreground object image within the composite image based on a lighting of the background image. In some implementations, executing the auto-composite model using the background image and the foreground object image comprises generating, utilizing the shadow generation model, a shadow associated with the foreground object image within the composite image.

In one or more embodiments, the object recommendation system 106 generates an initial composite image utilizing the background image and the foreground object image; and provides the initial composite image for display within the graphical user interface. Accordingly, in some instances, generating the composite image by executing the auto-composite model comprises generating the composite image by modifying the initial composite image within the graphical user interface via the auto-composite model.

In some instances, the object recommendation system 106 determines a recommended location or a recommended scale for the foreground object image within the composite image. Accordingly, in some embodiments, generating the composite image comprises generating the composite image utilizing the recommended location or the recommended scale for the foreground object image.

To provide an illustration, in one or more embodiments, the object recommendation system 106 provides, for display within a graphical user interface of a client device, at least one interactive element for providing search input and at least one additional interactive element for executing an auto-composite model comprising at least one of a scale prediction model, a harmonization model, or a shadow generation model; receives, via the graphical user interface, a user interaction with the at least one interactive element and an additional user interaction with the at least one additional interactive element; retrieves a foreground object image for use in generating a composite image with a background image in accordance with the user interaction with the at least one interactive element; generates the composite image utilizing the foreground object image and the background image by executing the auto-composite model in accordance with the additional user interaction with the at least one additional interactive element; and provides the composite image for display within the graphical user interface.

In some embodiments, providing, for display within the graphical user interface, the at least one interactive element for providing the search input comprises providing the background image for display within the graphical user interface; and receiving, via the graphical user interface, the user interaction with the at least one interactive element comprises receiving, within the background image displayed on the graphical user interface, a sketch input indicating a category of foreground object images to be retrieved. In some instances, providing, for display within the graphical user interface, the at least one interactive element for providing the search input comprises providing the background image for display within the graphical user interface; and receiving, via the graphical user interface, the user interaction with the at least one interactive element comprises receiving, within the background image displayed on the graphical user interface, a bounding box indicating a scale of foreground object images to be retrieved and a portion of the background image for which the foreground object images are to be compatible. In some cases, retrieving the foreground object image for use in generating the composite image comprises retrieving the foreground object image utilizing a composite object search engine that includes one or more of a compositing-aware search engine, a text search engine, or an image search engine.

In one or more embodiments, the object recommendation system 106 further performs a composite-aware search to retrieve an additional foreground object image based on a compatibility of the additional foreground object image with the composite image; and modifies the composite image to include the additional foreground object image.

In one or more embodiments, receiving the additional user interaction with the at least one additional interactive element for executing the auto-composite model comprises receiving a plurality of user interactions for executing the scale prediction model, the harmonization model, and the shadow generation model; and generating the composite image utilizing the foreground object image and the background image by executing the auto-composite model in accordance with the additional user interaction with the at least one additional interactive element comprises generating the composite image by executing the scale prediction model, the harmonization model, and the shadow generation model utilizing the foreground object image and the background image.

In some cases, the object recommendation system 106 further determines a recommended location and a recommended scale for the foreground object image within the composite image. Thus, in some embodiments, generating the composite image utilizing the foreground object image and the background image comprises inserting the foreground object image into the background image at the recommended location using the recommended scale.

To provide another illustration, in one or more embodiments, the object recommendation system 106 provides, for display within a graphical user interface of a client device, the background image for use in generating a composite image; receives, via the graphical user interface, user input selecting a location within the background image to position a foreground object image for the composite image; determines, utilizing the composite object search engine, the foreground object image for use in generating the composite image based on the location within the background image selected via the user input; receives, via the graphical user interface, additional user input for executing the auto-composite model for the composite image based on the background image and the foreground object image; and generates the composite image using the background image and the foreground object image in accordance with the user input and the additional user input.

In one or more embodiments, the object recommendation system 106 further determines a recommended scale for the foreground object image within the composite image based on the location selected by the user input; and generates the composite image using the background image and the foreground object image by positioning the foreground object image within the composite image at the location selected by the user input and using the recommended scale. In some embodiments, the object recommendation system 106 further receives, via the graphical user interface, further user input selecting an additional location within the composite image to position an additional foreground object image; determines, utilizing the composite object search engine, the additional foreground object image for use in modifying the composite image based on the additional location; and modifies the composite image utilizing the additional foreground object image based on the additional location.

In some implementations, the object recommendation system 106 receives the additional user input for executing the auto-composite model by receiving user selections for executing the scale prediction model, the harmonization model, and the shadow generation model. Further, in some instances, the object recommendation system 106 generates the composite image using the background image and the foreground object image in accordance with the additional user input by: modifying, utilizing the scale prediction model, a scale of the foreground object image within the composite image based on a scale of the background image; modifying, utilizing the harmonization model, a lighting of the foreground object image within the composite image based on a lighting of the background image; and generating, utilizing the shadow generation model, a shadow associated with the foreground object image within the composite image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 23 illustrates a block diagram of an example computing device 2300 that may be configured to perform one or more of the processes described above. One will appreciate that one or more computing devices, such as the computing device 2300 may represent the computing devices described above (e.g., the server(s) 102 and/or the client devices 110a-110n). In one or more embodiments, the computing device 2300 may be a mobile device (e.g., a mobile telephone, a smartphone, a PDA, a tablet, a laptop, a camera, a tracker, a watch, a wearable device). In some embodiments, the computing device 2300 may be a non-mobile device (e.g., a desktop computer or another type of client device). Further, the computing device 2300 may be a server device that includes cloud-based processing and storage capabilities.

As shown in FIG. 23, the computing device 2300 can include one or more processor(s) 2302, memory 2304, a storage device 2306, input/output interfaces 2308 (or “I/O interfaces 2308”), and a communication interface 2310, which may be communicatively coupled by way of a communication infrastructure (e.g., bus 2312). While the computing device 2300 is shown in FIG. 23, the components illustrated in FIG. 23 are not intended to be limiting. Additional or alternative components may be used in other embodiments. Furthermore, in certain embodiments, the computing device 2300 includes fewer components than those shown in FIG. 23. Components of the computing device 2300 shown in FIG. 23 will now be described in additional detail.

In particular embodiments, the processor(s) 2302 includes hardware for executing instructions, such as those making up a computer program. As an example, and not by way of limitation, to execute instructions, the processor(s) 2302 may retrieve (or fetch) the instructions from an internal register, an internal cache, memory 2304, or a storage device 2306 and decode and execute them.

The computing device 2300 includes memory 2304, which is coupled to the processor(s) 2302. The memory 2304 may be used for storing data, metadata, and programs for execution by the processor(s). The memory 2304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 2304 may be internal or distributed memory.

The computing device 2300 includes a storage device 2306 including storage for storing data or instructions. As an example, and not by way of limitation, the storage device 2306 can include a non-transitory storage medium described above. The storage device 2306 may include a hard disk drive (HDD), flash memory, a Universal Serial Bus (USB) drive or a combination these or other storage devices.

As shown, the computing device 2300 includes one or more I/O interfaces 2308, which are provided to allow a user to provide input to (such as user strokes), receive output from, and otherwise transfer data to and from the computing device 2300. These I/O interfaces 2308 may include a mouse, keypad or a keyboard, a touch screen, camera, optical scanner, network interface, modem, other known I/O devices or a combination of such I/O interfaces 2308. The touch screen may be activated with a stylus or a finger.

The I/O interfaces 2308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 2308 are configured to provide graphical data to a display for presentation to a user. The graphical data may be representative of one or more graphical user interfaces and/or any other graphical content as may serve a particular implementation.

The computing device 2300 can further include a communication interface 2310. The communication interface 2310 can include hardware, software, or both. The communication interface 2310 provides one or more interfaces for communication (such as, for example, packet-based communication) between the computing device and one or more other computing devices or one or more networks. As an example, and not by way of limitation, communication interface 2310 may include a network interface controller (NIC) or network adapter for communicating with an Ethernet or other wire-based network or a wireless NIC (WNIC) or wireless adapter for communicating with a wireless network, such as a WI-FI. The computing device 2300 can further include a bus 2312. The bus 2312 can include hardware, software, or both that connects components of computing device 2300 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining a background image and a foreground object image for use in generating a composite image;
providing, for display within a graphical user interface of a client device, at least one selectable option for executing an auto-composite model for the composite image, the auto-composite model comprising at least one of a scale prediction model, a harmonization model, or a shadow generation model;
detecting, via the graphical user interface, a user selection of the at least one selectable option; and
generating, in response to detecting the user selection, the composite image by executing the auto-composite model using the background image and the foreground object image.

2. The computer-implemented method of claim 1, wherein determining the foreground object image for use in generating a composite image comprises:
receiving, via the graphical user interface, search input for performing a composite-aware search to retrieve one or more foreground object images based on a compatibility with the background image; and
performing the composite-aware search to determine the foreground object image utilizing a composite object search engine.

3. The computer-implemented method of claim 2,
further comprising providing the background image for display via the graphical user interface,
wherein receiving, via the graphical user interface, the search input comprises receiving, via the graphical user interface, an additional user selection of a location within the background image for positioning the foreground object image.

4. The computer-implemented method of claim 3, wherein receiving, via the graphical user interface, the search input comprises receiving, via the graphical user interface, user input within the background image indicating a scale for the foreground object image, the user selection of the location and the user input indicating the scale corresponding to a query bounding box received within the background image via one or more user interactions.

5. The computer-implemented method of claim 1, wherein:
detecting the user selection of the at least one selectable option comprises detecting a user selection of a selectable option for executing the scale prediction model; and
executing the auto-composite model using the background image and the foreground object image comprises modifying, utilizing the scale prediction model, a scale of the foreground object image within the composite image based on a scale of the background image.

6. The computer-implemented method of claim 1, wherein:
detecting the user selection of the at least one selectable option comprises detecting a user selection a selectable option for executing the harmonization model; and
executing the auto-composite model using the background image and the foreground object image comprises modifying, utilizing the harmonization model, a lighting of the foreground object image within the composite image based on a lighting of the background image.

7. The computer-implemented method of claim 1, wherein:
detecting the user selection of the at least one selectable option comprises detecting a user selection of a selectable option for executing the shadow generation model; and
executing the auto-composite model using the background image and the foreground object image comprises generating, utilizing the shadow generation model, a shadow associated with the foreground object image within the composite image.

8. The computer-implemented method of claim 1, further comprising:
generating an initial composite image utilizing the background image and the foreground object image; and
providing the initial composite image for display within the graphical user interface,
wherein generating the composite image by executing the auto-composite model comprises generating the composite image by modifying the initial composite image within the graphical user interface via the auto-composite model.

9. The computer-implemented method of claim 1,
further comprising determining at least one of a recommended location or a recommended scale for the foreground object image within the composite image,
wherein generating the composite image comprises generating the composite image utilizing the at least one of the recommended location or the recommended scale for the foreground object image.

10. A non-transitory computer-readable medium storing instructions that, when executed by at least one processor, cause the at least one processor to perform operations comprising:
providing, for display within a graphical user interface of a client device, at least one interactive element for providing search input and at least one additional interactive element for executing an auto-composite model comprising at least one of a scale prediction model, a harmonization model, or a shadow generation model;
receiving, via the graphical user interface, a user interaction with the at least one interactive element and an additional user interaction with the at least one additional interactive element;
retrieving a foreground object image for use in generating a composite image with a background image in accordance with the user interaction with the at least one interactive element;
generating the composite image utilizing the foreground object image and the background image by executing the auto-composite model in accordance with the additional user interaction with the at least one additional interactive element; and
providing the composite image for display within the graphical user interface.

11. The non-transitory computer-readable medium of claim 10, wherein:
providing, for display within the graphical user interface, the at least one interactive element for providing the search input comprises providing the background image for display within the graphical user interface; and
receiving, via the graphical user interface, the user interaction with the at least one interactive element comprises receiving, within the background image displayed on the graphical user interface, a sketch input indicating a category of foreground object images to be retrieved.

12. The non-transitory computer-readable medium of claim 10, wherein:
providing, for display within the graphical user interface, the at least one interactive element for providing the search input comprises providing the background image for display within the graphical user interface; and
receiving, via the graphical user interface, the user interaction with the at least one interactive element comprises receiving, within the background image displayed on the graphical user interface, a bounding box indicating a scale of foreground object images to be retrieved and a portion of the background image for which the foreground object images are to be compatible.

13. The non-transitory computer-readable medium of claim 10, wherein retrieving the foreground object image for use in generating the composite image comprises retrieving the foreground object image utilizing a composite object search engine that includes one or more of a compositing-aware search engine, a text engine, or an image search engine.

14. The non-transitory computer-readable medium of claim 10, further comprising instructions that, when executed by the at least one processor, cause the at least one processor to perform operations comprising:
performing a composite-aware search to retrieve an additional foreground object image based on a compatibility of the additional foreground object image with the composite image; and
modifying the composite image to include the additional foreground object image.

15. The non-transitory computer-readable medium of claim 10, wherein:
receiving the additional user interaction with the at least one additional interactive element for executing the auto-composite model comprises receiving a plurality of user interactions for executing the scale prediction model, the harmonization model, and the shadow generation model; and
generating the composite image utilizing the foreground object image and the background image by executing the auto-composite model in accordance with the additional user interaction with the at least one additional interactive element comprises generating the composite image by executing the scale prediction model, the harmonization model, and the shadow generation model utilizing the foreground object image and the background image.

16. The non-transitory computer-readable medium of claim 10,
further comprising instructions that, when executed by the at least one processor, cause the at least one processor to perform operations comprising determining a recommended location and a recommended scale for the foreground object image within the composite image,
wherein generating the composite image utilizing the foreground object image and the background image comprises inserting the foreground object image into the background image at the recommended location using the recommended scale.

17. A system comprising:
one or more memory devices comprising a background image, a composite object search engine, and an auto-composite model comprising at least one of a scale prediction model, a harmonization model, or a shadow generation model; and
one or more processors configured to cause the system to:
provide, for display within a graphical user interface of a client device, the background image for use in generating a composite image;
receive, via the graphical user interface, user input selecting a location within the background image to position a foreground object image for the composite image;
determine, utilizing the composite object search engine, the foreground object image for use in generating the composite image based on the location within the background image selected via the user input;
receive, via the graphical user interface, additional user input for executing the auto-composite model for the composite image based on the background image and the foreground object image; and
generate the composite image using the background image and the foreground object image in accordance with the user input and the additional user input.

18. The system of claim 17, wherein the one or more processors are further configured to cause the system to:
determine a recommended scale for the foreground object image within the composite image based on the location selected by the user input; and
generate the composite image using the background image and the foreground object image by positioning the foreground object image within the composite image at the location selected by the user input and using the recommended scale.

19. The system of claim 17, wherein the one or more processors are further configured to cause the system to:
receive, via the graphical user interface, further user input selecting an additional location within the composite image to position an additional foreground object image;
determine, utilizing the composite object search engine, the additional foreground object image for use in modifying the composite image based on the additional location; and
modify the composite image utilizing the additional foreground object image based on the additional location.

20. The system of claim 17, wherein the one or more processors are configured to cause the system to:
receive the additional user input for executing the auto-composite model by receiving user selections for executing the scale prediction model, the harmonization model, and the shadow generation model; and
generate the composite image using the background image and the foreground object image in accordance with the additional user input by:
modifying, utilizing the scale prediction model, a scale of the foreground object image within the composite image based on a scale of the background image;
modifying, utilizing the harmonization model, a lighting of the foreground object image within the composite image based on a lighting of the background image; and
generating, utilizing the shadow generation model, a shadow associated with the foreground object image within the composite image.
